(19) United States
(12) Patent Application Publication
(10) Pub. No.: US 2018/0252534 A1
(43) Pub. Date: Sep. 6, 2018

(54) CLEANING SUPPORT METHOD, CLEANING SUPPORT DEVICE, AND NON-TRANSITORY COMPUTER-READABLE RECORDING MEDIUM STORING A CLEANING SUPPORT PROGRAM

(71) Applicant: Panasonic Intellectual Property Corporation of America, Torrance, CA (US)

(72) Inventor: SHUNSUKE KUHARA, Osaka (JP)

(21) Appl. No.: 15/897,433

(22) Filed: Feb. 15, 2018

(30) Foreign Application Priority Data
Mar. 1, 2017 (JP) 2017-038428

(51) Int. Cl. G01C 21/20; A47L 9/28; G05D 1/00

(52) U.S. Cl. CPC G01C 21/206; G05D 2201/0215; G05D 1/0088; A47L 9/2805

(57) ABSTRACT

A terminal device includes a processor that obtains person-present position information indicating a position of a person in a predetermined space cleanable by an autonomous cleaner. The terminal device divides the predetermined space into a multiple cleaning target areas to be individually cleaned by the autonomous cleaner, and determines, based on the person-present position information and among the cleaning target areas, a person-present cleaning target area where the person is present. The terminal device also determines surrounding cleaning target areas that surround the person-present cleaning target area. The terminal device further includes, a display that displays, non-cleanable areas and cleanable areas of the cleaning target areas, using different forms.

### BACKGROUND

### 1. Technical Field

The present disclosure relates to a cleaning support method, a cleaning support device, and a non-transitory computer-readable recording medium storing a cleaning support program.

### 2. Description of the Related Art

There is known an autonomous cleaner in the related art that determines whether or not a person is present in a cleaning area, and in a case of determining that there is no person present in the cleaning area, starts automated cleaning from a point that has been set beforehand, but in a case of determining that there is a person present in the cleaning area, stops automated cleaning and travels to a point that has been set beforehand (e.g., see Japanese Unexamined Patent Application Publication No. 2007-34561). The above related art also discloses stopping automated cleaning in a case where a person enters the cleaning area during automated cleaning by the autonomous cleaner, and performing automated cleaning only in a case where there is no person present in the cleaning area.

### SUMMARY

However, while the related art discloses that determination is made regarding whether or not a person is present in the cleaning area, and that automated cleaning is performed only in a case where there is no person present in the cleaning area, there is no disclosure or suggestion of a method of determining whether or not a person is present in each of multiple cleaning areas, and presenting a cleaning area regarding which an autonomous cleaning can clean, based on the relationship between the judgment results and the multiple cleaning target areas, based on the relationship between the judgement determination results and the multiple cleaning areas. Accordingly, further improvement has been needed.

One non-limiting and exemplary embodiment provides a cleaning support method, a cleaning support device, and a non-transitory computer-readable recording medium storing a cleaning support program, by which a cleanable area, which an autonomous cleaner can clean without making nearby people in the vicinity feel uncomfortable, can be presented to a user.

In one general aspect, the techniques disclosed here feature a cleaning support method for a cleaning support device that supports cleaning by an autonomous cleaner in a predetermined space. The method includes obtaining person-present position information indicating a position in the predetermined space where a person is present; obtaining, with regard to each of multiple cleaning target areas obtained by dividing the predetermined space into areas individually cleaned by the autonomous cleaner, a person-present cleaning target area where a person is present, and a surrounding cleaning target area around the person-present cleaning target area, based on the obtained person-present position information; and displaying, of the multiple cleaning target areas, non-cleanable areas including the person-present cleaning target area and the surrounding cleaning target area, and cleanable areas including the cleaning target areas other than the non-cleanable areas, using different forms.

According to the present disclosure, a cleanable area, which an autonomous cleaner can clean without making people in the vicinity feel uncomfortable, can be presented to a user.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a diagram conceptually illustrating an overall image of a cleaning system according to an embodiment;

FIG. 2 is a block diagram illustrating the functional configuration of a terminal device in the embodiment;

FIG. 3 is a diagram illustrating an example of information stored in a cleaning target area storage unit in the embodiment;

FIG. 4 is a diagram illustrating an example of surrounding area information stored in a surrounding area information storage unit in the embodiment;

FIG. 5 is a diagram for describing a method of identifying a surrounding cleaning target area in a modification of the embodiment;

FIG. 6 is a diagram illustrating an example of surrounding area information stored in the surrounding area information storage unit in a modification of the embodiment;

FIG. 7 is a block diagram illustrating the functional configuration of a management device in the embodiment;

FIG. 8 is an external transparent view of an autonomous cleaner according to the embodiment as viewed from above;

FIG. 9 is a block diagram illustrating the functional configuration of the autonomous cleaner according to the embodiment;

FIG. 10 is a diagram illustrating a state where people have been mapped in one cleaning target area out of multiple cleaning target area in the embodiment;

FIG. 11 is a flowchart for describing processing at a terminal device according to the embodiment;

FIG. 12 is a diagram illustrating an example of a display screen, including an input button to prompt display of a cleanable area, in the embodiment;

FIG. 13 is a diagram for describing a person-present cleaning target area and surrounding cleaning target areas in the embodiment;

FIG. 14 is a diagram illustrating an example of a display screen that displays non-cleanable areas and cleanable areas in the embodiment;

FIG. 15 is a diagram illustrating an example of a display screen displayed in a case where a non-cleanable area has been selected by a user in the embodiment;

FIG. 16 is a flowchart for describing processing of the management device according to the embodiment;

FIG. 17 is a flowchart for describing processing of the autonomous cleaner according to the embodiment;

FIG. 18 is a diagram illustrating an example of a display screen that displays non-cleanable areas and cleanable areas in a first modification of the embodiment;

FIG. 19 is a diagram illustrating an example of a display screen that displays non-cleanable areas and cleanable areas in a second modification of the embodiment;

FIG. 20 is a diagram illustrating an example of a display screen that displays non-cleanable areas and cleanable areas in a third modification of the embodiment;

FIG. 21 is a diagram illustrating an example of a display screen that displays non-cleanable areas and cleanable areas in a fourth modification of the embodiment;

FIG. 22 is a diagram illustrating an example of a display screen that displays non-cleanable areas and cleanable areas in a fifth modification of the embodiment;

FIG. 23 is a diagram illustrating an example of a display screen that displays non-cleanable areas and cleanable areas in a sixth modification of the embodiment;

FIG. 24 is a diagram illustrating an example of surrounding area number-of-times information, where a cleaning target area, and the number of times that this cleaning target area is a surrounding cleaning target area of another cleaning target area, have been correlated in the sixth modification of the embodiment;

FIG. 25 is a diagram illustrating an example of a display screen that displays non-cleanable areas and cleanable areas in a seventh modification of the embodiment;

FIG. 26 is a diagram illustrating an example of a display screen that displays non-cleanable areas and cleanable areas in an eighth modification of the embodiment;

FIG. 27 is a diagram illustrating an example of a display screen that displays non-cleanable areas and cleanable areas in a ninth modification of the embodiment;

FIG. 28 is a diagram illustrating an example of a display screen that displays non-cleanable areas and cleanable areas in a tenth modification of the embodiment;

FIG. 29 is a diagram illustrating an example of a display screen that displays non-cleanable areas and cleanable areas in an eleventh modification of the embodiment;

FIG. 30 is a diagram illustrating an example of a display screen that displays non-cleanable areas and cleanable areas in a twelfth modification of the embodiment;

FIG. 31 is a diagram illustrating an example of a display screen that displays non-cleanable areas and cleanable areas in a thirteenth modification of the embodiment;

FIG. 32 is a diagram illustrating an example of a display screen that displays non-cleanable areas and cleanable areas in a fourteenth modification of the embodiment;

FIG. 33 is a diagram illustrating an example of a display screen that accepts settings for conditions to change a surrounding cleaning target area in the fourteenth modification of the embodiment;

FIG. 34 is a diagram illustrating an example of a display screen that accepts settings for conditions to end cleaning at an end point-in-time of a cleaning time period in a fifteenth modification of the embodiment; and

FIG. 35 is a diagram illustrating an example of a display screen that displays non-cleanable areas and cleanable areas in a sixteenth modification of the embodiment.

### DETAILED DESCRIPTION

### Underlying Knowledge Forming Basis of the Present Disclosure

As described above, while the related art discloses that determination is made regarding whether or not a person is present in the cleaning area, and that automated cleaning is performed only in a case where there is no person present in the cleaning area, there is no disclosure or suggestion of a method of determining whether or not a person is present in each of multiple cleaning areas, and presenting a cleaning area regarding which an autonomous cleaner can clean, based on the relationship between the judgment results and the multiple cleaning target areas, based on the relationship between the determination results and the multiple autonomous cleaners.

For example, a case of a restaurant that is open 24 hours will be considered. The restaurant has tables, and around these tables are cleaning areas. An autonomous cleaner is to be used to clean multiple cleaning areas. If a restaurant is open 24 hours, this means that cleaning will take place while the restaurant is open. Accordingly, there is a need to have the autonomous cleaner to clean during a time period when there are few guests in the restaurant and customer traffic is light. Regardless of cleaning during a time period when there are few guests in the restaurant and customer traffic is light, if there are any guests in the restaurant, the related art has to determine whether there are people at each table, and have the autonomous cleaner only clean around table sets regarding which determination has been made that nobody is present.

However, there is a possibility of making guests who are eating uncomfortable by having the autonomous cleaner clean using the related art. For example, in a case where determination is made that there are no guests at a table next to a table where a guest is eating, and the autonomous cleaner starts cleaning the floor of the table next to the table where the guest is eating, this may stir up dust, and this dust may in some cases reach the table where the guest is eating. In such a case, the guest may feel uncomfortable.

Further, if the autonomous cleaner starts cleaning the floor of the table next to the table where the guest is eating, the cleaning will create noise, so the guest will have to eat while hearing the noise nearby. In this way, the method of simply determining whether or not a person is present in a cleaning area, and starting cleaning by the autonomous cleaner based on the determination results as in the related art could create inconveniences depending on the situation.

A cleaning support method according to a first aspect of the present disclosure is a cleaning support method for a cleaning support device that supports cleaning by an autonomous cleaner in a predetermined space. The method includes obtaining person-present position information indicating a position in the predetermined space where a person is present; obtaining, with regard to each of a multiple cleaning target areas obtained by dividing the predetermined space into areas individually cleaned by the autonomous cleaner, a person-present cleaning target area where a person is present, and a surrounding cleaning target area around the person-present cleaning target area, based on the obtained person-present position information; and displaying, of the multiple cleaning target areas, non-cleanable areas including the person-present cleaning target area and the surrounding cleaning target area, and cleanable areas including the cleaning target areas other than the non-cleanable areas, using different forms.

According to this configuration, person-present position information indicating a position in the predetermined space where a person is present is obtained. A person-present cleaning target area where a person is present and a surrounding cleaning target area around the person-present cleaning target area are obtained with regard to each of multiple of cleaning target areas obtained by dividing the predetermined space into areas individually cleaned by the autonomous cleaner, based on the obtained person-present position information. Of the multiple cleaning target areas, non-cleanable areas including the person-present cleaning target area and the surrounding cleaning target area and cleanable areas including the cleaning target areas other than the non-cleanable areas are displayed using different forms.

Accordingly, of the multiple cleaning target areas, the non-cleanable areas including the person-present cleaning target area where a person is present and the surrounding cleaning target area around the person-present cleaning area, and cleanable areas including the cleaning target areas other than the non-cleanable areas, are displayed using different forms, so the user can be presented with cleanable areas that are cleanable by the autonomous cleaner without making people in the vicinity uncomfortable.

The cleaning support method may further include accepting, of the displayed cleanable areas, user selection of the cleanable area to be cleaned by the autonomous cleaner, and outputting area selection information indicating the selected cleanable area.

According to this configuration, of the displayed cleanable areas, user selection of the cleanable area to be cleaned by the autonomous cleaner is accepted. Area selection information indicating the selected cleanable area is output.

Accordingly, a cleanable area that the user has selected can be cleaned by the autonomous cleaner without making people in the predetermined space uncomfortable.

The cleaning support method may further include presenting to the user, in a case where user selection of the non-cleanable area has been accepted, information to the effect that the autonomous cleaner cannot clean the selected non-cleanable area.

According to this configuration, in a case where user selection of the non-cleanable area has been accepted, the user is presented with information to the effect that the autonomous cleaner cannot clean the selected non-cleanable area.

Accordingly, the user can recognize that the area that he/she has selected cannot be cleaned by the autonomous cleaner.

The cleaning support method may further include obtaining stay time information indicating stay time of the person in the person-present cleaning target area, and displaying the stay time in the person-present cleaning target area based on the obtained stay time information.

According to this configuration, stay time information indicating stay time of the person in the person-present cleaning target area is obtained. The stay time in the person-present cleaning target area is displayed based on the obtained stay time information. Accordingly, the user can select a cleanable area taking the stay time of people into consideration.

The cleaning support method may further include obtaining stay time information indicating stay time of the person in the person-present cleaning target area, and displaying the person-present cleaning target area using a form corresponding to the obtained stay time information.

According to this configuration, stay time information indicating stay time of the person in the person-present cleaning target area is obtained. The person-present cleaning target area is displayed using a form corresponding to the obtained stay time information.

Accordingly, the person-present cleaning target area is displayed using a form corresponding to the stay time information of the person in the person-present cleaning target area, so the stay time of the person in the person-present cleaning target area can be easily recognized by the user.

In the cleaning support method, the person-present cleaning target area may include a first person-present cleaning target area and a second person-present cleaning target area that is different from the first person-present cleaning target area. The surrounding cleaning target area may include a first surrounding cleaning target area around the first person-present cleaning target area, and a second surrounding cleaning target area around the second person-present cleaning target area. In a case where the first surrounding cleaning target area and the second surrounding cleaning target area overlap, the first surrounding cleaning target area and the second surrounding cleaning target area that overlap, and the first surrounding cleaning target area and the second surrounding cleaning target area that do not overlap, may be displayed using different forms.

According to this configuration, the person-present cleaning target area includes a first person-present cleaning target area and a second person-present cleaning target area that is different from the first person-present cleaning target area. The surrounding cleaning target area includes a first surrounding cleaning target area around the first person-present cleaning target area, and a second surrounding cleaning target area around the second person-present cleaning target area. In a case where the first surrounding cleaning target area and the second surrounding cleaning target area overlap, the first surrounding cleaning target area and the second surrounding cleaning target area that overlap, and the first surrounding cleaning target area and the second surrounding cleaning target area that do not overlap, are displayed using different forms.

Accordingly, a cleaning target area where the first surrounding cleaning target area and the second surrounding cleaning target area overlap is not selectable as a cleanable area until people are gone from the first person-present cleaning target area and the second person-present cleaning target area. On the other hand, a cleaning target area where the first surrounding cleaning target area and the second surrounding cleaning target area do not overlap is not selectable as a cleanable area as soon as people are gone from either one of the first person-present cleaning target area and the second person-present cleaning target area. Accordingly, the user can perform planned cleaning where the cleaning target area where the first surrounding cleaning target area and the second surrounding cleaning target area overlap is cleaned after the cleaning target area where the first surrounding cleaning target area and the second surrounding cleaning target area do not overlap.

In the cleaning support method, the person-present cleaning target area may include a first person-present cleaning target area, a second person-present cleaning target area that is different from the first person-present cleaning target area, and a third person-present cleaning target area that is different from the first person-present cleaning target area and the second person-present cleaning target area. The surrounding cleaning target area may include a first surrounding cleaning target area around the first person-present cleaning target area, a second surrounding cleaning target area around the second person-present cleaning target area, and a third surrounding cleaning target area around the third person-present cleaning target area. In a case where the first surrounding cleaning target area and the second surrounding cleaning target area overlap and the third surrounding cleaning target area overlap, the first surrounding cleaning target areas and the second surrounding cleaning target areas and the third surrounding cleaning target areas that overlap, and the second surrounding cleaning target areas and the third surrounding cleaning target area that overlap but do not overlap the first surrounding cleaning target areas, may be displayed using different forms.

According to this configuration, the person-present cleaning target area includes a first person-present cleaning target area, a second person-present cleaning target area that is different from the first person-present cleaning target area, and a third person-present cleaning target area that is different from the first person-present cleaning target area and the second person-present cleaning target area. The surrounding cleaning target area includes a first surrounding cleaning target area around the first person-present cleaning target area, a second surrounding cleaning target area around the second person-present cleaning target area, and a third surrounding cleaning target area around the third person-present cleaning target area. In a case where the first surrounding cleaning target area and the second surrounding cleaning target area overlap and the third surrounding cleaning target area overlap, the first surrounding cleaning target areas and the second surrounding cleaning target areas and the third surrounding cleaning target areas that overlap, and the second surrounding cleaning target areas and the third surrounding cleaning target area that overlap but do not overlap the first surrounding cleaning target areas, are displayed using different forms.

Accordingly, the form of display is changed in accordance with the degree of overlapping of surrounding cleaning target areas, so the user can perform cleaning in a more planned manner.

The cleaning support method may further include obtaining position information indicating a current position of the autonomous cleaner in the predetermined space, generating routes for the autonomous cleaner to travel from the current position to each of the multiple cleaning target areas, based on the obtained position information, and changing, in a case where the person-present cleaning target area or the surrounding cleaning target area is included on a route from the current position of the autonomous cleaner to a particular cleaning target area corresponding to the cleanable area, the cleanable area corresponding to the particular cleaning target area to a non-cleanable area.

According to this configuration, position information indicating a current position of the autonomous cleaner in the predetermined space is obtained. Routes for the autonomous cleaner to travel from the current position to each of the multiple cleaning target areas are generated, based on the obtained position information. In a case where the person-present cleaning target area or the surrounding cleaning target area is included on a route from the current position of the autonomous cleaner to a particular cleaning target area corresponding to the cleanable area, the cleanable area corresponding to the particular cleaning target area is changed to a non-cleanable area.

Accordingly, in a case where a route from the current position of the autonomous cleaner to a particular cleaning target area corresponding to the cleanable area includes the person-present cleaning target area or the surrounding cleaning target area, the cleanable area corresponding to the particular cleaning target area is changed to a non-cleanable area. Thus, the user can select a cleanable area that will not bother people present in the person-present cleaning target area.

The cleaning support method may further include managing cleaning history information of the autonomous cleaner regarding each of the multiple cleaning target areas, and displaying, in a case where multiple cleaning target areas are displayed as the cleanable area, the multiple cleanable areas using different forms in accordance with elapsed time from the time of day of ending cleaning a last time included in the cleaning history until a current time of day, based on the cleaning history information regarding each of the multiple cleanable areas.

According to this configuration, cleaning history information of the autonomous cleaner is managed regarding each of the multiple cleaning target areas. In a case where multiple cleaning target areas are displayed as the cleanable area, the multiple cleanable areas are displayed using different forms in accordance with elapsed time from the time of day of ending cleaning a last time included in the cleaning history until a current time of day, based on the cleaning history information regarding each of the multiple cleanable areas.

Accordingly, the multiple cleanable areas are displayed using different forms in accordance with elapsed time from the time of day of ending cleaning the last time to the current time of day, so the user can easily recognize cleanable areas where more dust can be expected to be accumulated.

The cleaning support method may further include obtaining position information indicating a current position of the autonomous cleaner in the predetermined space, generating routes for the autonomous cleaner to travel from the current position to each of the multiple cleaning target areas, based on the obtained position information, and displaying, in a case where multiple cleanable areas are displayed as the cleanable area, the multiple cleanable areas using different forms in accordance with distance of the routes.

According to this configuration, position information indicating a current position of the autonomous cleaner in the predetermined space is obtained. Routes are generated for the autonomous cleaner to travel from the current position to each of the multiple cleaning target areas, based on the obtained position information. In a case where multiple cleanable areas are displayed as the cleanable area, the multiple cleanable areas are displayed using different forms in accordance with distance of the routes.

Accordingly, the multiple cleanable areas are displayed using different forms in accordance with distance of the routes from the current position of the autonomous cleaner to each of the multiple cleanable areas, so the user can easily confirm the distance of the routes from the current position of the autonomous cleaner to each of the multiple cleanable areas. Also, in a case where the autonomous cleaner is to be quickly operated, the user can easily select a cleanable area close to the autonomous cleaner.

The cleaning support method may further include identifying surrounding areas for each of the multiple cleaning target areas, calculating a count of times of each of the multiple cleaning target areas being identified as the surrounding area from another cleaning target area, and displaying, in a case where the multiple cleanable areas are displayed, the multiple cleanable areas using forms in accordance with the calculated count.

According to this configuration, surrounding areas for each of the multiple cleaning target areas are identified. A count of times of each of the multiple cleaning target areas being identified as the surrounding area from another cleaning target area is calculated. In a case where the multiple cleanable areas are displayed, the multiple cleanable areas are displayed using forms in accordance with the calculated count.

According to this configuration, the multiple cleanable areas are each displayed using different forms in accordance with the count of each of the multiple cleaning target areas having been identified as a surrounding cleaning target area of another cleaning target area, so the user can select a cleanable area taking into consideration the count of having been identified as a surrounding cleaning target area from another cleaning target area.

A cleaning support device according to another aspect of the present disclosure is a cleaning support device that supports cleaning by an autonomous cleaner in a predetermined space. The device includes processing circuitry; and storage including at least one set of instructions that, when executed by the processing circuitry, cause the processing circuitry to perform operations including obtaining person-present position information indicating a position in the predetermined space where a person is present, obtaining, with regard to each of multiple cleaning target areas obtained by dividing the predetermined space into areas individually cleaned by the autonomous cleaner, a person-present cleaning target area, and a surrounding cleaning target area around the person-present cleaning target area, based on the obtained person-present position information, and displaying, of the multiple cleaning target areas, non-cleanable areas including the person-present cleaning target area and the surrounding cleaning target area, and cleanable areas including the cleaning target areas other than the non-cleanable areas, using different forms.

According to this configuration, person-present position information indicating a position in the predetermined space where a person is present is obtained. A person-present cleaning target area and a surrounding cleaning target area around the person-present cleaning target area are obtained with regard to each of multiple cleaning target areas obtained by dividing the predetermined space into areas individually cleaned by the autonomous cleaner, based on the obtained person-present position information. Of the multiple cleaning target areas, non-cleanable areas including the person-present cleaning target area and the surrounding cleaning target area and cleanable areas including the cleaning target areas other than the non-cleanable areas are displayed using different forms.

Accordingly, of the multiple cleaning target areas, the non-cleanable areas including the person-present cleaning target area and the surrounding cleaning target area around the person-present cleaning target area, and cleanable areas including the cleaning target areas other than the non-cleanable areas, are displayed using different forms, so the user can be presented with cleanable areas that are cleanable by the autonomous cleaner without making people in the vicinity uncomfortable.

A non-transitory computer-readable recording medium according to another aspect of the present disclosure is a non-transitory computer-readable recording medium storing a cleaning support program that supports cleaning by an autonomous cleaner in a predetermined space, which when executed by a computer, causes the computer to execute a method including obtaining person-present position information indicating a position in the predetermined space where a person is present, obtaining, with regard to each of multiple cleaning target areas obtained by dividing the predetermined space into areas individually cleaned by the autonomous cleaner, a person-present cleaning target area where a person is present, and a surrounding cleaning target area around the person-present cleaning target area, based on the obtained person-present position information, and displaying, of the multiple cleaning target areas, non-cleanable areas including the person-present cleaning target area and the surrounding cleaning target area, and cleanable areas including the cleaning target areas other than the non-cleanable areas, using different forms.

According to this configuration, person-present position information indicating a position in the predetermined space where a person is present is obtained. A person-present cleaning target area and a surrounding cleaning target area around the person-present cleaning target area are obtained with regard to each of multiple cleaning target areas obtained by dividing the predetermined space into areas individually cleaned by the autonomous cleaner, based on the obtained person-present position information. Of the multiple cleaning target areas, non-cleanable areas including the person-present cleaning target area and the surrounding cleaning target area and cleanable areas including the cleaning target areas other than the non-cleanable areas are displayed using different forms.

Accordingly, of the multiple cleaning target areas, the non-cleanable areas including the person-present cleaning target area where a person is present and the surrounding cleaning target area around the person-present cleaning target area, and cleanable areas including the cleaning target areas other than the non-cleanable areas, are displayed using different forms, so the user can be presented with cleanable areas that are cleanable by the autonomous cleaner without making people in the vicinity uncomfortable.

An embodiment of the present disclosure will be described below with reference to the drawings. Note that the embodiment below is an exemplary specific form of the present disclosure, and does not restrict the technical scope of the present disclosure.

### Embodiment

In the present embodiment, description will be made regarding a method where, in a situation where there are multiple cleaning target areas in an eatery, cleaning target areas where guests are present and cleaning target areas around that cleaning target area are decided to be non-cleanable areas, and cleaning target areas excluding the non-cleanable areas are decided to be cleanable areas. The decided non-cleanable areas and cleanable areas are displayed using different forms.

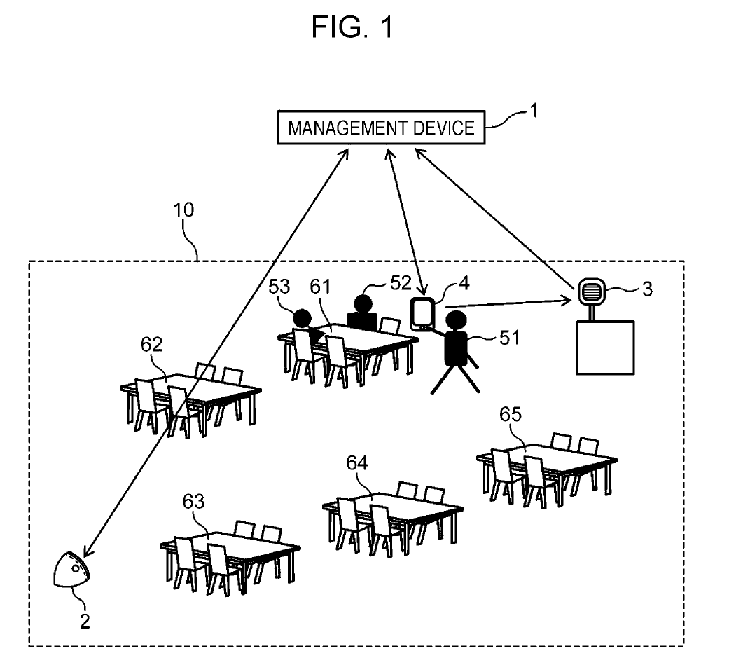

FIG. 1 is a diagram conceptually illustrating an overall image of a cleaning system according to the present embodiment. The cleaning system illustrated in FIG. 1 includes a point-of-sales (POS) cash register 3 within the eatery 10, a terminal device 4 that an employee 51 carries, an autonomous cleaner 2, and a management device 1 that is outside of the eatery 10.

Multiple tables 61 through 65 are arrayed within the eatery 10, and there is the employee 51 carrying the terminal device 4 and guests 52 and 53 at table 61. The autonomous cleaner 2 is cleaning the floor at table 63, which is other than the table 61 where a person is present and tables 62, 64, and 65 nearby the table 61. A cleaning target area is set beforehand in the present embodiment, correlated with each table. That is to say, each of the multiple cleaning target areas, where the two-dimensional space inside the eatery 10 has been divided into individual areas to be cleaned by the autonomous cleaner 2, are formed for each of the multiple tables.

The terminal device 4 is, for example, a personal digital assistant (PDA) that has been integrated with a portable data terminal, a smartphone, a tablet computer, or the like. Although the terminal device 4 is described as a terminal that the employee 51 carries in the present embodiment, this does not necessarily have to be a terminal that the employee 51 carries. The terminal device 4 may be a terminal installed in the eatery 10 for example, such as a personal computer or the like, for example.

The terminal device 4 first requests the management device 1 for person-present position information indicating a position within a predetermined space where a person is present, and receives the person-present position information from the management device 1. The person-present position information is a cleaning target area where a person is present, out of multiple cleaning target areas. Based on the obtained person-present position information, the terminal device 4 identifies person-present cleaning target areas where there is a person present, and surrounding cleaning target areas around the person-present cleaning target areas, for each of the multiple cleaning target areas obtained by dividing the predetermined space into areas to be individually cleaned by the autonomous cleaner 2. The terminal device 4 then displays, of the multiple cleaning target areas, the person-present cleaning target areas and surrounding cleaning target areas in one form as non-cleanable areas, and cleaning target areas other than the non-cleanable areas as cleanable areas in a different form, on a display unit. The terminal device 4 then accepts user selection of a cleanable area out of the displayed cleanable areas for the autonomous cleaner 2 to clean, and transmits area selection information indicating the selected cleanable area to the management device 1.

The management device 1 is a server, for example, and is installed inside or outside of the eatery. The management device 1 receives payment information transmitted from the POS cash register 3, and also receives order information transmitted from the terminal device 4, and the received payment information and order information are stored in a storage unit. In a case of being requested for person-present position information by the terminal device 4, the management device 1 first judges at which tables (cleaning target areas) there are guests, based on the payment information received from the POS cash register 3 and the order information received from the terminal device 4.

The management device 1 then transmits person-present position information indicating cleaning target areas where people are present, out of the multiple cleaning target areas stored beforehand, to the terminal device 4. Upon receiving the area selection information from the terminal device 4, the management device 1 outputs cleaning instruction information to the autonomous cleaner 2, to clean the cleanable area selected by the user. The autonomous cleaner 2 travels to the cleanable area specified in the cleaning instruction information, and cleans the cleanable area, based on the cleaning instruction information received from the management device 1.

In payment processing for a meal or the like, the POS cash register 3 transfers payment information such as monetary amount registration results input by the employee 51 and so forth to the management device 1 via a local area network (LAN) that is omitted from illustration, for example. Payment information includes, for example, information such as the sales amount input by the employee 51, table identification information for identifying the table of the guest paying, order identification information for identifying order information the number of guests at that table, the time of day of payment processing, and so forth.

The terminal device 4 transfers the order information input by the employee 51 to the POS cash register 3 and management device 1 via the unshown LAN, for example. The order information includes, for example, information such as the content of guest orders input by the employee 51, table identification information for identifying the table at which the order was taken, order identification information for identifying the order information, the number of guests, the time of day that the order was input, and so forth.

Although the terminal device 4 transmits the order information to the management device 1 in the present embodiment, this is not restricted in particular in the present disclosure. The POS cash register 3 may transmit order information received from the terminal device 4 to the management device 1.

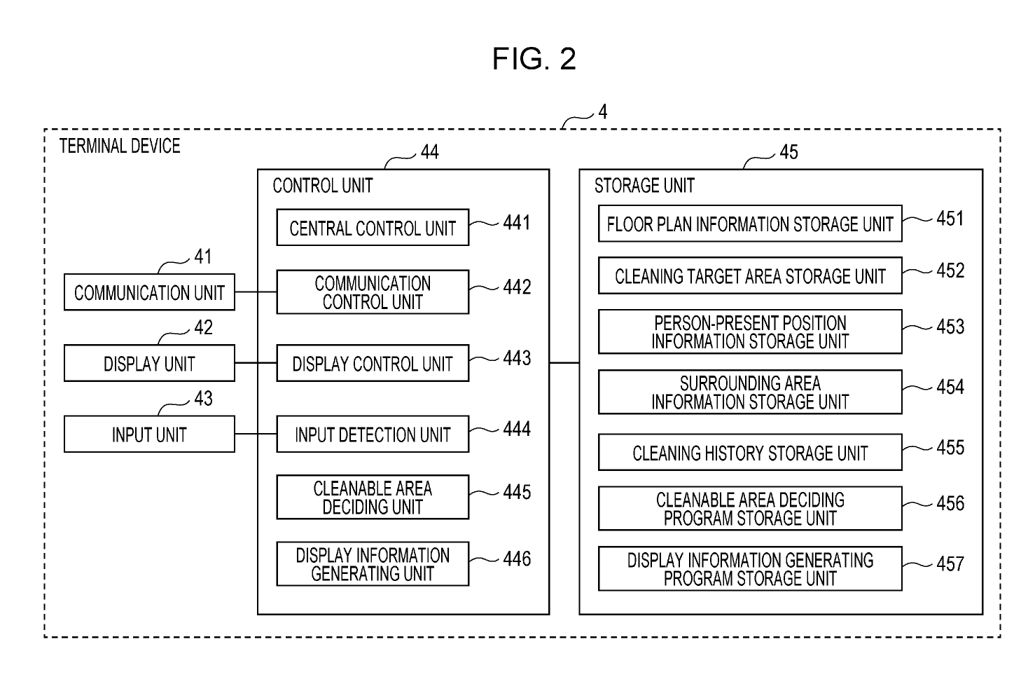

The configurations of the terminal device 4, management device 1, and autonomous cleaner 2 will be described in detail below. FIG. 2 is a block diagram illustrating the functional configuration of the terminal device 4 according to the present embodiment. The terminal device 4 includes a communication unit 41, a display unit 42, an input unit 43, a control unit 44, and a storage unit 45.

The communication unit 41 performs communication with an external device such as the management device 1, and exchanges information. The communication unit 41 exchanges information over a LAN or wide area network (WAN), for example. The communication unit 41 transmits a request for person-present position information to the management device 1, and receives person-present position information from the management device 1, for example.

The display unit 42 displays information for a user, such as the employee 51. The display unit 42 is configured of a liquid crystal display, for example. The display unit 42 displays, of the multiple cleaning target areas, non-cleanable areas including cleaning target areas where guests are present and cleaning target areas around that cleaning target area, and cleanable areas including cleaning target areas excluding the non-cleanable areas, using different forms.

The input unit 43 accepts input from a user, such as the employee 51. The input unit 43 is configured of a touch panel integrated with the display unit 42, an operating panel, or the like, for example. The input unit 43 accepts user selection of a cleanable area for the autonomous cleaner 2 to clean, out of the displayed cleanable areas.

The control unit 44 is a central processing unit (CPU) for example, and includes a central control unit 441, a communication control unit 442, a display control unit 443, an input detection unit 444, a cleanable area deciding unit 445, and a display information generating unit 446.

The central control unit 441 performs control of storing information in the storage unit 45, control among control components of the control unit 44, and so forth. The communication control unit 442 controls the communication unit 41 when transmitting person-present position information requests and area selection information, receiving person-present position information from the management device 1, and so forth. The communication control unit 442 obtains person-present position information indicating that a person is present in a predetermined space. Note that the communication control unit 442 corresponds to an example of an obtaining unit.

The cleanable area deciding unit 445 identifies person-present cleaning target areas where there is a person present regarding each of the multiple cleaning target areas obtained by dividing the predetermined space into areas to be individually cleaned by the autonomous cleaner 2, based on positions where people are present. The cleanable area deciding unit 445 also identifies cleaning target areas around person-present cleaning target areas as surrounding cleaning target areas. The cleanable area deciding unit 445 further decides person-present cleaning target areas and surrounding cleaning target areas to be non-cleanable areas, and decides cleaning target areas other than the person-present cleaning target areas and surrounding cleaning target areas to be cleanable areas.

The display information generating unit 446 generates information to display on the display unit 42. For example, the display information generating unit 446 generates display information to display the non-cleanable areas and cleanable areas decided by the cleanable area deciding unit 445 using different forms.

The display control unit 443 controls the display unit 42 when displaying display information generated by the display information generating unit 446 on the display unit 42. The display control unit 443 displays information of non-cleanable areas and cleanable areas on the display unit 42 when suggesting the cleanable area to the employee 51, for example. The display control unit 443 effects control so to display, of the multiple cleaning target areas, the non-cleanable areas including person-present cleaning target areas and surrounding cleaning target areas, and cleanable areas including cleaning target areas other than the non-cleanable areas, on the display unit 42 using different forms.

The input detection unit 444 detects user input to the input unit 43. For example, in a case where the employee 51 has pressed a button to prompt display of non-cleanable areas and cleanable areas, the input detection unit 444 detects the button input by the employee 51. The input detection unit 444 also accepts user selection of cleanable areas to be cleaned by the autonomous cleaner 2, out of the displayed cleanable areas.

The storage unit 45 is semiconductor memory for example, and includes a floor plan information storage unit 451, a cleaning target area storage unit 452, a person-present position information storage unit 453, a surrounding area information storage unit 454, a cleaning history storage unit 455, a cleanable area deciding program storage unit 456, and a display information generating program storage unit 457.

The floor plan information storage unit 451 stores floor plan information, which is map information indicating the entire predetermined space that is the object of cleaning. The floor plan information in the present embodiment is information indicating the floor plan of the eatery 10. The communication control unit 442 obtains floor plan information created at the time of designing the eatery 10 for example, from an external server or the like, and stores in the floor plan information storage unit 451. Any method of obtaining floor plan information may be used. For example, an autonomous cleaner 2 having a map creating function may create map information of the inside of the eatery while traveling through the eatery, and the terminal device 4 may obtain created map information from the autonomous cleaner 2 and store in the floor plan information storage unit 451.

The cleaning target area storage unit 452 stores information indicating cleaning target areas set in the floor plan information. Setting of the cleaning target area may be automatically set based on the positions of tables in the floor plan information or on table sizes, or may be set by a user such as the owner or staff of the eatery or the like. In a case of performing settings by a user, the input unit 43 may, for example, be able to accept user input of cleaning target areas based on the floor plan information stored in the floor plan information storage unit 451, and store the information relating to the cleaning target areas that has been accepted in the cleaning target area storage unit 452, thereby setting cleaning target areas. The cleaning target areas in the present embodiment are set beforehand, corresponding to each table within the eatery.

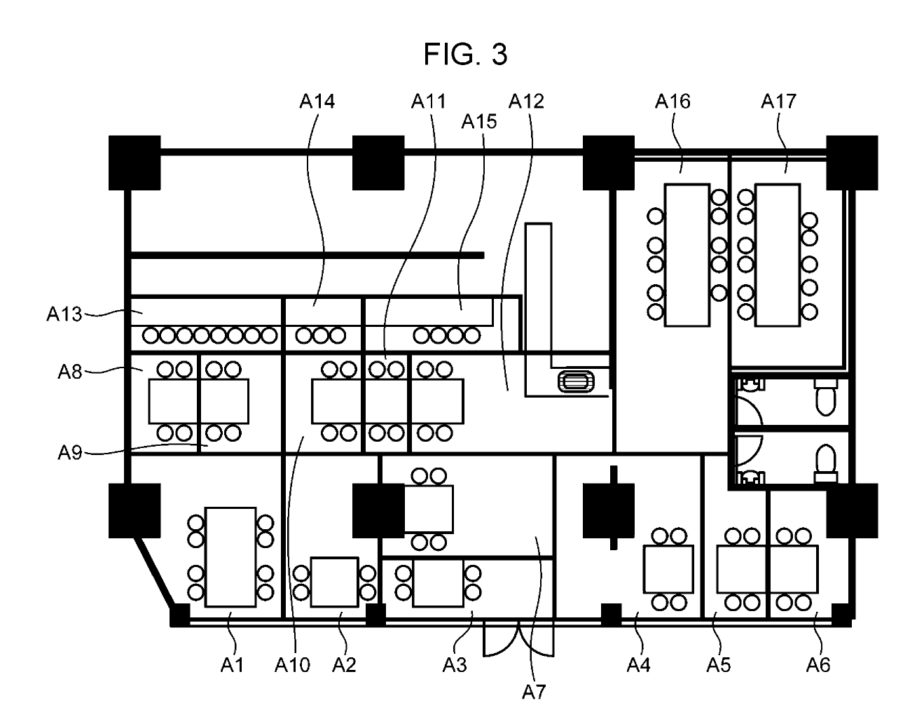

FIG. 3 is a diagram illustrating an example of information stored in the cleaning target area storage unit 452 in the present embodiment. Seventeen cleaning target areas A1 through A17 are set in the floor plan of the eatery in FIG. 3. The cleaning target areas A1 through A17 are set for each of tables in the eatery.

The person-present position information storage unit 453 stores person-present position information received by the communication unit 41. This person-present position information is information indicating whether a person is present or not in each of the multiple cleaning target areas.

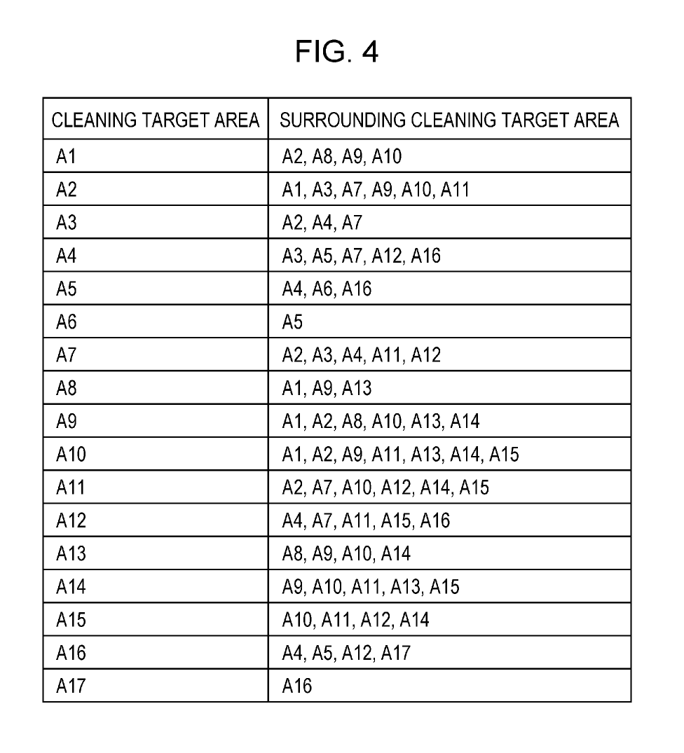

The surrounding area information storage unit 454 stores surrounding area information that indicates surrounding cleaning target areas around each cleaning target area. The surrounding area information that indicates surrounding cleaning target areas around each cleaning target area may be generated based on predetermined rules, or may be generated by accepting user input. Surrounding cleaning target areas generated based on different rules will be described with reference to FIG. 4.

FIG. 4 is a diagram illustrating an example of surrounding area information stored in the surrounding area information storage unit 454 in the present embodiment. The surrounding area information illustrated in FIG. 4 is generated based on a rule that cleaning target areas adjacent to a cleaning target area are surrounding cleaning target areas. The surrounding area information storage unit 454 stores surrounding area information correlating multiple cleaning target areas and surrounding cleaning target areas. In FIG. 4, cleaning target areas adjacent to each cleaning target area are set as surrounding cleaning target areas. For example, correlated with cleaning target area A1 are cleaning target areas A2, A8, A9, and A10, as surrounding cleaning target areas. The cleanable area deciding unit 445 identifies surrounding cleaning target areas corresponding to an identified person-present cleaning target area, based on surrounding area information correlating each of the multiple cleaning target areas and the surrounding cleaning target areas beforehand.

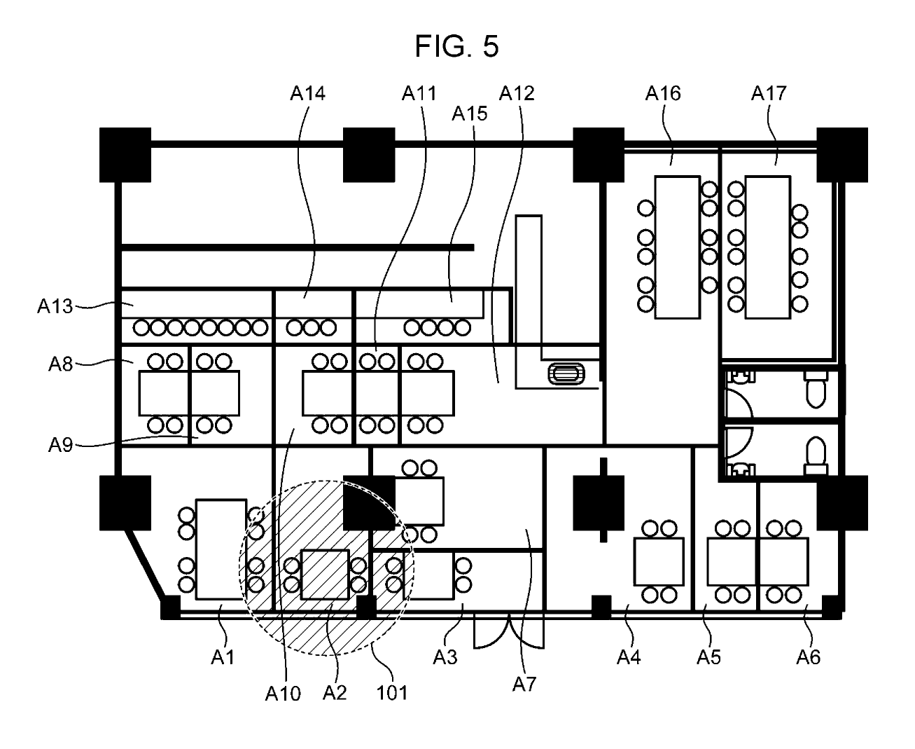

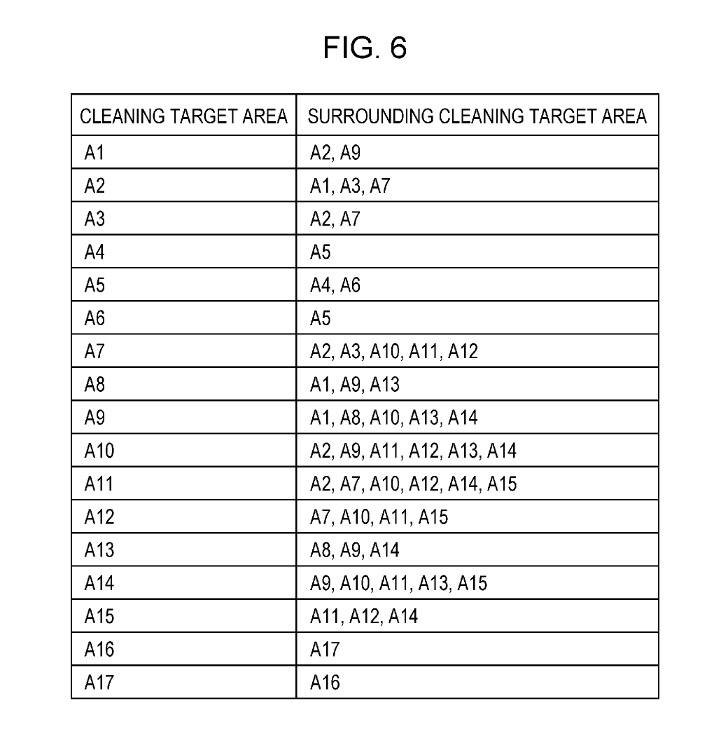

Next, a method of identifying surrounding cleaning target areas in a modification of the present embodiment will be described. FIG. 5 is a diagram for describing a method for identifying surrounding cleaning target areas in a modification of the present embodiment, and FIG. 6 is a diagram illustrating an example of surrounding area information stored in the surrounding area information storage unit 454 in a modification of the present embodiment. In the modification of the present embodiment illustrated in FIG. 5, cleaning target areas overlapping a circular area 101 covering a predetermined distance from a center point of a table in a cleaning target area are set as surrounding cleaning target areas.

Looking at cleaning target area A2 in FIG. 5 as one example, a circular area 101 is illustrated covering a predetermined distance from a center point of the table in cleaning target area A2. In this example, the cleaning target areas A1, A3, and A7, which overlap the circular area 101, are correlated with the cleaning target area A2 as surrounding cleaning target areas.

The surrounding area information storage unit 454 stores surrounding area information correlating each of the multiple cleaning target areas and the surrounding cleaning target areas beforehand, as illustrated in FIG. 6. For example, correlated with cleaning target area A1 are cleaning target areas A2 and A9, as surrounding cleaning target areas. The cleanable area deciding unit 445 identifies cleaning target areas within a predetermined range from a position where a person is estimated to be, as surrounding cleaning target areas.

While the center of a table in a cleaning target area is set as the center point of the circular area 101 in FIG. 5, the present disclosure is not restricted in particular to this arrangement. The center point of the circular area 101 may be set to any point within the cleaning target area, in accordance with user selection. A center point of the cleaning target area (center of gravity) may serve as the center point of the circular area 101. Although surrounding cleaning target areas are identified in FIG. 5 using the circular area 101, surrounding cleaning target areas may be identified using areas of other shapes, such as rectangles or the like.

FIGS. 4 and 6 illustrate surrounding area information generated based on predetermined rules, but corrections to surrounding area information generated based on predetermined rules may be accepted from the user. According to this configuration, the surrounding area information may be corrected in accordance with user preferences. For example, in a case where a cleaning target area has been set as a surrounding cleaning target area of a certain cleaning target area, but there is a partition between the two cleaning target areas and the user does not want to set the cleaning target area on the other side of the partition as a surrounding cleaning target area, correction can be performed so that the cleaning target areas on each side of the partition are not set to surrounding cleaning target areas of each other.

The cleaning history storage unit 455 stores cleaning history information for each cleaning target area. This cleaning history information includes, for example, the time of day at which cleaning instruction information was transmitted to the autonomous cleaner 2, and cleaning history information transmitted from the autonomous cleaner 2. The cleaning history information transmitted from the autonomous cleaner 2 includes, for example, the time of day at which the autonomous cleaner 2 started cleaning, the time of day which the autonomous cleaner 2 completed cleaning, information indicating the state of progress of cleaning by the autonomous cleaner 2, and so forth. The information indicating the state of progress of cleaning by the autonomous cleaner 2 is, for example, information where the path of travel of the autonomous cleaner 2 is superimposed on the map information of instructed cleanable areas. In a case where the autonomous cleaner 2 has discontinued cleaning due to a low battery or the like, the time of day of discontinuation and other such information may be included in the cleaning history information.

The cleaning history information stored in the cleaning history storage unit 455 includes past cleaning history information, which includes at least cleaning history information of cleaning from the last time. Accordingly, past cleaning history can be used in cleaning the next time. For example, the display information generating unit 446 can differentiate the display form of multiple cleanable areas in accordance with the time elapsed from the time of day of ending cleaning the last time until the current time of day, based on the cleaning history of each of the cleanable areas. The cleaning history storage unit 455 also manages cleaning history of the autonomous cleaner 2 with regard to each of the multiple cleaning target areas.

The cleanable area deciding program storage unit 456 stores a cleanable area deciding program that identifies person-present cleaning target areas where people are present, and surrounding cleaning target areas around the person-present cleaning target areas, based on the surrounding area information stored beforehand, decides that the identified person-present cleaning target areas and surrounding cleaning target areas are non-cleanable areas, and decides cleaning target areas other than the non-cleanable areas to be cleanable areas. The cleanable area deciding program is executed by the cleanable area deciding unit 445. The cleanable area deciding program may be stored in the cleanable area deciding program storage unit 456 by being installed by the user beforehand, or may be stored in the cleanable area deciding program storage unit 456 by being downloaded from the management device 1.

The display information generating program storage unit 457 stores a display information generating program that generates information to be displayed on the display unit 42. The display information generating program is executed by the display information generating unit 446. The display information generating program may be stored in the display information generating program storage unit 457 by being installed by the user beforehand, or may be stored in the display information generating program storage unit 457 by being downloaded from the management device 1.

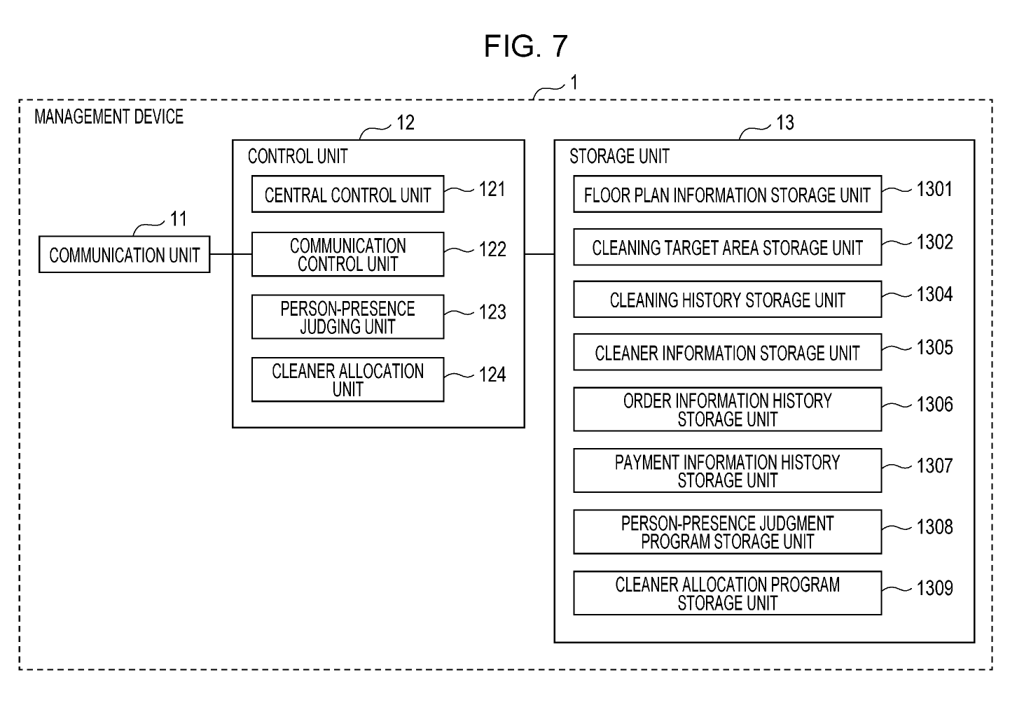

FIG. 7 is a block diagram illustrating the functional configuration of the management device 1 according to the present embodiment. The management device 1 includes a communication unit 11, a control unit 12, and a storage unit 13.

The communication unit 11 exchanges information with external devices, such as transmitting person-present position information to the terminal device 4, receiving area selection information from the terminal device 4, transmitting cleaning instruction information to the autonomous cleaner 2, receiving position information and history information from the autonomous cleaner 2, and so forth. The communication unit 11 exchanges information over a LAN or WAN, for example.

The control unit 12 is a CPU for example, and includes a central control unit 121, a communication control unit 122, a person-presence judging unit 123, and a cleaner allocation unit 124. The central control unit 121 performs control of storage of information to the storage unit 13, control among control components of the control unit 12, and so forth.

The communication control unit 122 controls communication of the communication unit 11, such as transmitting person-present position information to the terminal device 4, receiving area selection information from the terminal device 4, transmitting cleaning instruction information to the autonomous cleaner 2, receiving position information and history information from the autonomous cleaner 2, and so forth.

The person-presence judging unit 123 estimates the position of a person present in a predetermined space. The person-presence judging unit 123 judges whether or not there is a person present in each of the multiple cleaning target areas. The cleaning target areas are set corresponding to individual tables beforehand in the present embodiment, so the person-presence judging unit 123 judges whether or not there is a person at a table, i.e., in a cleaning target area, by judging whether or not the table is unoccupied. Given the nature of eateries that guests will spend the greater part of their time at their table, judging whether or not a table is unoccupied enables determination of whether or not a person is present in the cleaning target area.

Specifically, the person-presence judging unit 123 extracts the newest order information from order information received from the terminal device 4. The person-presence judging unit 123 then judges whether or not order identification information that is the same as the order identification information in the extracted order information exists in payment information received from the POS cash register 3. In a case of judging that the same order identification information exists in the payment information, this means that the guest has already paid, so the person-presence judging unit 123 judges that the table is unoccupied. In a case of judging that the same order identification information does not exist in the payment information, this means that the guest has not paid yet, so the person-presence judging unit 123 judges that the table is not unoccupied. The person-presence judging unit 123 thus judges whether or not people are present in cleaning target areas, based on judgment results regarding whether tables are unoccupied or not.

The cleaner allocation unit 124 allocates the autonomous cleaner 2 to cleanable areas indicated by the area selection information received from the terminal device 4 by the communication unit 11. The cleaner allocation unit 124 outputs cleaning instruction information to cause the autonomous cleaner 2 to clean the selected cleanable areas.

The storage unit 13 is semiconductor memory for example, and includes a floor plan information storage unit 1301, a cleaning target area storage unit 1302, a cleaning history storage unit 1304, a cleaner information storage unit 1305, an order information history storage unit 1306, a payment information history storage unit 1307, a person-presence judgment program storage unit 1308, and a cleaner allocation program storage unit 1309.

The floor plan information storage unit 1301 stores floor plan information that is map information of the entire predetermined space that is the object of cleaning. The floor plan information in the present embodiment is information indicating the floor plan of the eatery 10. The communication control unit 122 obtains the floor plan information created at the time of designing the eatery 10 for example, from an external server or the like, and stores in the floor plan information storage unit 1301. Any method of obtaining floor plan information may be used at this time. For example, an autonomous cleaner 2 having a map creating function may create map information of the inside of the eatery while traveling through the eatery, and the management device 1 may obtain created map information from the autonomous cleaner 2 and store in the floor plan information storage unit 1301. Note that the floor plan information stored in the floor plan information storage unit 1301 of the management device 1 is the same as the floor plan information stored in the floor plan information storage unit 451 of the terminal device 4.

The cleaning target area storage unit 1302 stores information indicating cleaning target areas set in the floor plan information. Setting of the cleaning target area may be automatically set based on the positions of tables in the floor plan information or on table sizes, or may be set by a user such as the owner or staff of the eatery or the like. In a case of performing settings by a user, cleaning target areas can be set by a user terminal such as a personal computer, tablet computer, smartphone (none illustrated), or the like, of the user obtaining floor plan information from the management device 1, accepting user input regarding cleaning target areas based on the floor plan information, and transmitting the accepted information regarding cleaning target areas to the management device 1. The cleaning target areas in the present embodiment are set beforehand, corresponding to each table within the eatery. Note that the information indicating cleaning target areas stored in the cleaning target area storage unit 1302 of the management device 1 is the same as the information indicating cleaning target areas stored in the cleaning target area storage unit 452 of the terminal device 4.

The cleaning history storage unit 1304 stores cleaning history information of each cleaning target area. This cleaning history information includes, for example, the time of day at which cleaning instruction information was transmitted to the autonomous cleaner 2, and cleaning history information transmitted from the autonomous cleaner 2. The cleaning history information transmitted from the autonomous cleaner 2 includes, for example, the time of day at which the autonomous cleaner 2 started cleaning, the time of day which the autonomous cleaner 2 completed cleaning, information indicating the state of progress of cleaning by the autonomous cleaner 2, and so forth. The information indicating the state of progress of cleaning by the autonomous cleaner 2 is, for example, information where the path of travel of the autonomous cleaner 2 is superimposed on the map information of instructed cleanable areas. In a case where the autonomous cleaner 2 has discontinued cleaning due to a low battery or the like, the time of day of discontinuation and other such information may be included in the cleaning history information.

The cleaning history information stored in the cleaning history storage unit 1304 includes past cleaning history information, which includes at least cleaning history information of cleaning from the last time. The cleaning history storage unit 1304 manages cleaning history of the autonomous cleaner 2 regarding each of the multiple cleaning target areas.

The cleaner information storage unit 1305 stores information relating to the autonomous cleaner 2 which the cleaner allocation unit 124 allocates to cleanable areas. Information relating to the autonomous cleaner 2 includes, for example, identification information of the autonomous cleaner 2 for identifying the autonomous cleaner 2, and address information of the autonomous cleaner 2 for establishing communication with the autonomous cleaner 2. Information relating to the autonomous cleaner 2 may be obtained by user input from a management terminal or the like of the user, or may be obtained by setting an address of the management device 1 to the autonomous cleaner 2, so that the autonomous cleaner 2 communicates with the management device 1 and transmits information relating to the autonomous cleaner 2 thereto.

The order information history storage unit 1306 stores order information received from the terminal device 4. The terminal device 4 may transmit order information to the management device 1 each time an order is placed. Alternatively, the terminal device 4 may temporarily store order information in a storage unit in the terminal device 4, and transmit the stored order information to the management device 1 when the management device 1 inquires of the terminal device 4. The terminal device 4 may further transmit order information to the POS cash register 3. In this case, the POS cash register 3 may temporarily store the received order information, and transmit the stored order information to the management device 1 when the management device 1 inquires of the POS cash register 3.

The payment information history storage unit 1307 stores payment information received from the POS cash register 3. The communication control unit 122 receives payment information from the POS cash register 3, and stores this in the payment information history storage unit 1307.

The person-presence judgment program storage unit 1308 stores a person-presence judgment program for judging whether or not a person is present in a cleaning target area. The person-presence judgment program is executed by the person-presence judging unit 123.

The cleaner allocation program storage unit 1309 stores a cleaner allocation program for allocating the autonomous cleaner 2 to cleanable areas selected by the terminal device 4. The cleaner allocation program is executed by the cleaner allocation unit 124.

Note that in the present embodiment, all or part of the components of the person-presence judging unit 123, cleaner allocation unit 124, cleaner information storage unit 1305, order information history storage unit 1306, payment information history storage unit 1307, person-presence judgment program storage unit 1308, and cleaner allocation program storage unit 1309 of the management device 1, may be in the terminal device 4.

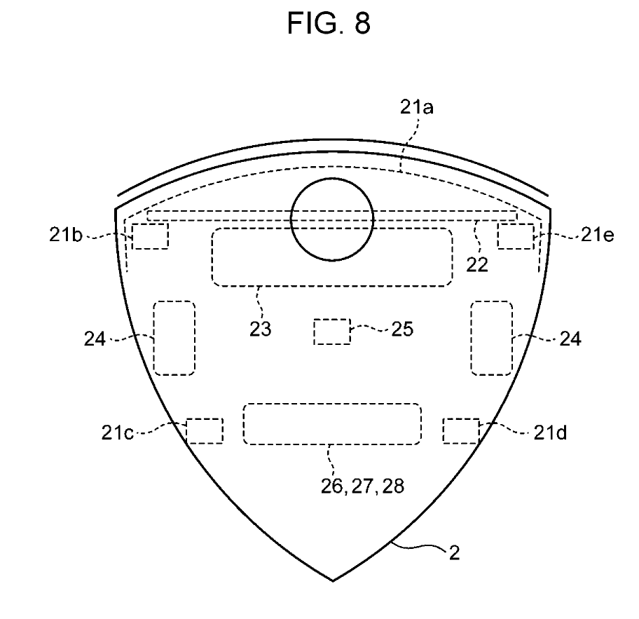

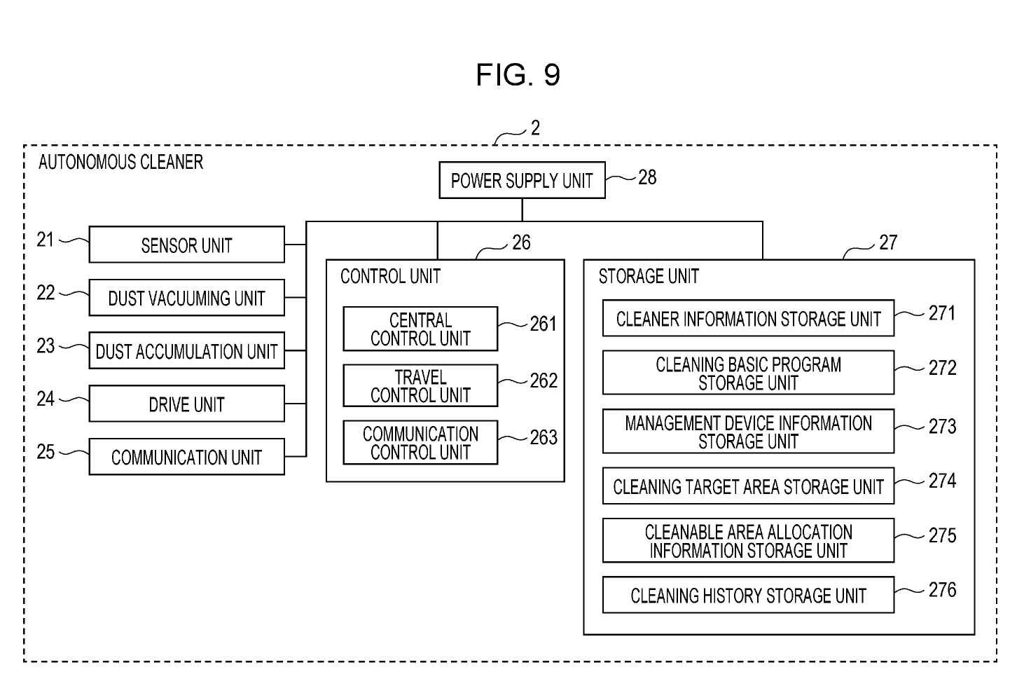

FIG. 8 is an external transparent view of the autonomous cleaner 2 according to the present embodiment as viewed from above. FIG. 9 is a block diagram illustrating the functional configuration of the autonomous cleaner 2 according to the present embodiment. The autonomous cleaner 2 includes a sensor unit 21, a dust vacuuming unit 22, a dust accumulation unit 23, a drive unit 24, a communication unit 25, a control unit 26, a storage unit 27, and a power supply unit 28.

The sensor unit 21 is a sensor to sense the situation around the autonomous cleaner 2 and/or the state of the autonomous cleaner 2. The sensor unit 21 includes an obstacle sensor that emits infrared rays or ultrasonic waves for example, and measures the infrared rays or ultrasonic waves reflected back from obstacles, thereby detecting distances to obstacles and thus detecting the obstacles, a contact sensor that detects obstacles by coming into contact with objects in a case where the obstacle sensor is not able to judge obstacles, a gyro sensor that measures the angle of the body of the autonomous cleaner 2, a travel sensor that measures the distance that the autonomous cleaner 2 has traveled, and so forth. FIG. 8 illustrates an example where the sensor unit 21 has a contact sensor 21a that is one type of sensor, and obstacle sensors 21b through 21e.

The dust vacuuming unit 22 is configured including a motor, fan, filter, and exhaust vent, for example (all omitted from illustration). When the motor rotates the fan, dust is suctioned along with air, just the air passes through the filter, and the air alone that has passed through is blown out from the exhaust vent. Dust that has been suctioned by the dust vacuuming unit 22 is accumulated in the dust accumulation unit 23.

The drive unit 24 moves the autonomous cleaner 2. The drive unit 24 is configured of a motor and wheels, for example (all omitted from illustration), and causes the autonomous cleaner 2 to travel by controlling the rotation of the motor and rotating the wheels.

The communication unit 25 transmits and receives information to and from external devices such as the management device 1, via a LAN or WAN. The communication unit 25 receives cleaning instruction information instructing cleaning of cleanable areas, and transmits cleaning history information to the management device 1, for example.

The control unit 26 is a CPU for example, and controls the operations of the autonomous cleaner 2. The control unit 26 includes a central control unit 261, a travel control unit 262, and a communication control unit 263.

The storage unit 27 is semiconductor memory for example, and includes a cleaner information storage unit 271, a cleaning basic program storage unit 272, a management device information storage unit 273, a cleaning target area storage unit 274, a cleanable area allocation information storage unit 275, and a cleaning history storage unit 276.

The central control unit 261 controls the components of the autonomous cleaner 2. The communication control unit 263 controls the communication unit 25, and transmits and receives various types of information via the communication unit 25.

The cleaner information storage unit 271 stores information relating to the autonomous cleaner 2. Examples of information relating to the autonomous cleaner 2 include identification information for identifying the autonomous cleaner 2 and communication address information of the autonomous cleaner 2.

The cleaning basic program storage unit 272 stores a cleaning basic program to cause the autonomous cleaner 2 to travel, based on predetermined movement patterns. The cleaning basic program is stored beforehand, at the time of manufacturing. When cleaning a cleanable area instructed by the management device 1, the travel control unit 262 selects one of predetermined movement patterns based on the cleaning basic program stored in the cleaning basic program storage unit 272, and controls the drive unit 24 to cause the autonomous cleaner 2 to travel and perform cleaning, based on the selected pattern. Examples of movement patterns include wall-following traveling where the autonomous cleaner 2 travels following an obstacle such as a wall or the like, zig-zag travelling where the autonomous cleaner 2 travels in a zig-zag pattern, random travelling where the autonomous cleaner 2 travels randomly, spiral traveling where the autonomous cleaner 2 travels in a spiral, for example. The travel control unit 262 performs cleaning by traveling while changing movement patterns in accordance with the situation around the autonomous cleaner 2 and the state of the autonomous cleaner 2. The autonomous cleaner 2 may have a configuration to access a server or the like of the manufacturer of the autonomous cleaner 2 and acquire an update program for the cleaning basic program, thereby updating movement patterns.

The management device information storage unit 273 stores information relating to the management device 1. Information relating to the management device 1 includes identification information for identifying the management device 1 and communication address information of the management device 1, for example. Information relating to the management device 1 may be stored beforehand at the time of manufacturing, or may be set by the user.

The cleaning target area storage unit 274 acquires from the management device 1 and stores information indicating cleaning target areas set in the floor plan information. The autonomous cleaner 2 travels to a cleanable area specified by cleaning instruction information received from the management device 1, based on information indicating cleaning target areas.

The cleanable area allocation information storage unit 275 stores information indicating a cleanable area specified in cleaning instruction information received from the management device 1. The autonomous cleaner 2 travels to the cleanable area indicated in this information, and performs cleaning.

The cleaning history storage unit 276 stores cleaning history information of having cleaned the cleanable area specified by the cleaning instruction information which has been received from the management device 1. The cleaning history information includes information such as the time of day that the autonomous cleaner 2 started cleaning, the time of day that the autonomous cleaner 2 completed cleaning, process information indicating the state of process of cleaning by the autonomous cleaner 2. The cleaning history information is stored in the management device 1 in the same way, but also is stored in the autonomous cleaner 2. That is to say, if the autonomous cleaner 2 travels to a place where communication signals are not good while cleaning, the cleaning history information at that point cannot be transmitted to the management device 1, so the autonomous cleaner 2 stores the cleaning history information. Accordingly, when communication signals are stronger, the autonomous cleaner 2 can transmit the stored cleaning history information to the management device 1.

The power supply unit 28 is a battery that supplies electric power to the components of the autonomous cleaner 2.

Next, a method according to the present embodiment for displaying, of the multiple cleaning target areas, non-cleanable areas including person-present cleaning target areas where people are present and surrounding cleaning target areas around person-present cleaning target areas, and cleanable areas other than the non-cleanable areas, using different forms, will be described.

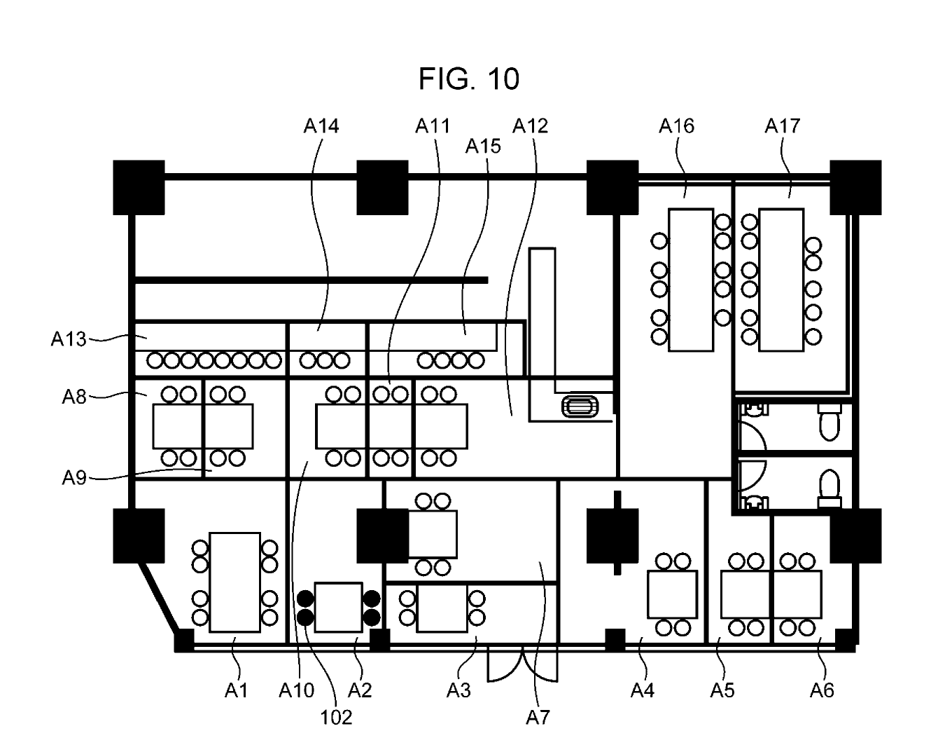

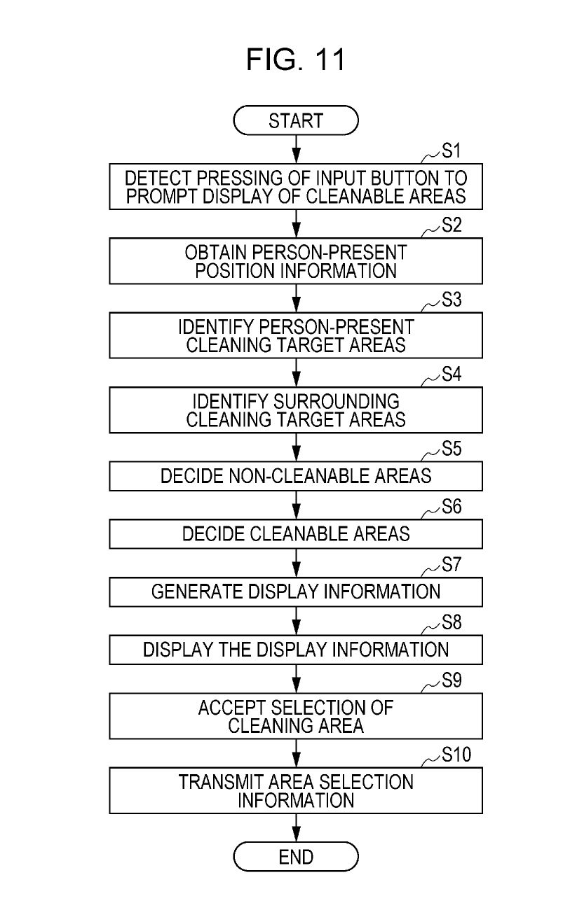

FIG. 10 is a diagram illustrating a state where people have been mapped into one cleaning target area out of the multiple cleaning target areas in the present embodiment. FIG. 11 is a flowchart for describing processing of the terminal device 4 in the present embodiment. Multiple cleaning target areas A1 through A17 are set on the floor plan in FIG. 10, indicating that there is a person 102 present in cleaning target area A2. FIG. 4 illustrates the surrounding cleaning target areas for each cleaning target area illustrated in FIG. 10.

The following processing is performed by a cleaning support application (omitted from illustration) that displays cleanable areas, assuming that the cleaning support application has been installed in the terminal device 4 beforehand. Description will be made hereinafter assuming that the cleaning support application has already been activated by the user in the terminal device. Note that when the cleaning support application is activated, the display unit 42 of the terminal device 4 displays an input button for prompting display of cleanable areas, and when the employee 51 presses the displayed input button, the processing for displaying cleanable areas is started. The input unit 43 is configured as a touch panel integrated with the display unit 42.

First, the input detection unit 444 detects that the employee 51 has pressed the input button for prompting display of cleanable areas, displayed on the display unit 42 (step S1).

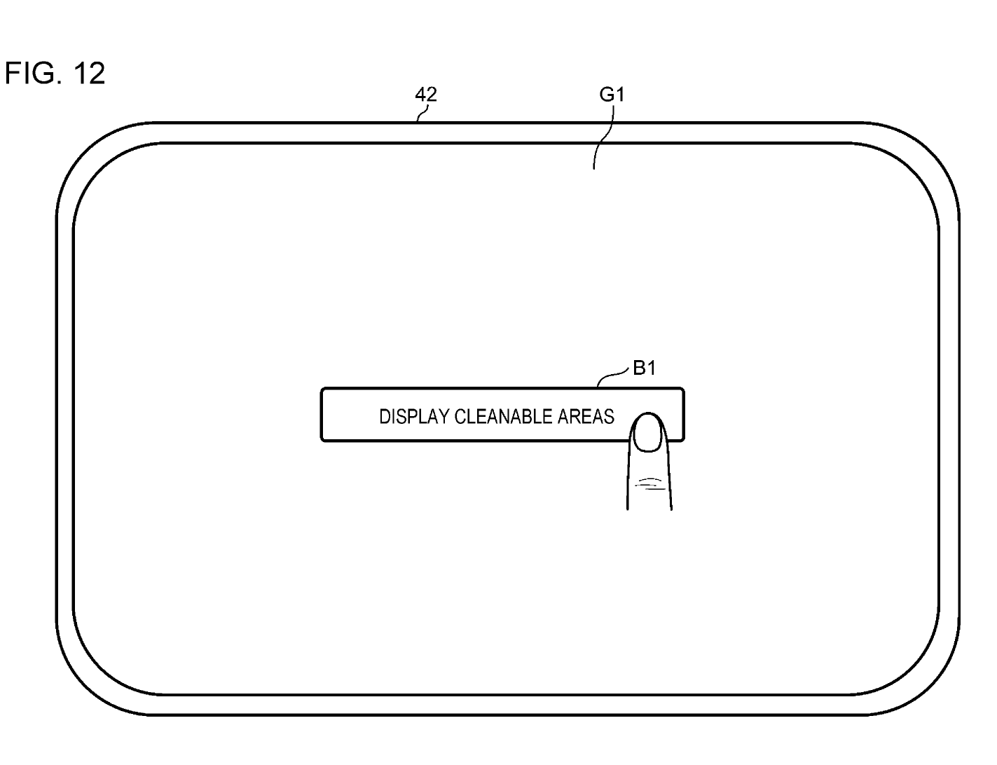

FIG. 12 is a diagram illustrating an example of a display screen including the input button for prompting display of cleanable areas in the present embodiment. The display unit 42 displays a display screen G1 that includes the input button Bl. The employee 51 prompts display of cleanable areas by pressing (touching) the input button B1 with a finger.

Next, the communication control unit 442 transmits request information requesting transmission of person-present position information to the management device 1, and acquires the person-present position information from the management device 1 (step S2). The communication control unit 442 stores the obtained person-present position information in the person-present position information storage unit 453 of the storage unit 45.

The cleanable area deciding unit 445 identifies person-present cleaning target areas where people are present, from the multiple cleaning target areas, based on the person-present position information (step S3). There are people present in the cleaning target area A2 in the example illustrated in FIG. 10, so identification is made that the cleaning target area A2 is a person-present cleaning target area.

Next, the cleanable area deciding unit 445 identifies surrounding cleaning target areas around the person-present cleaning target area, based on surrounding area information relating to the surrounding cleaning target areas of each cleaning target area stored in the surrounding area information storage unit 454 (step S4). The cleaning target area A2 is a person-present cleaning target area in the example illustrated in FIG. 10, so based on the surrounding area information in FIG. 4, the cleaning target areas A1, A3, A7, A9, A10, and A11 are identified as surrounding cleaning target areas of the cleaning target area A2.

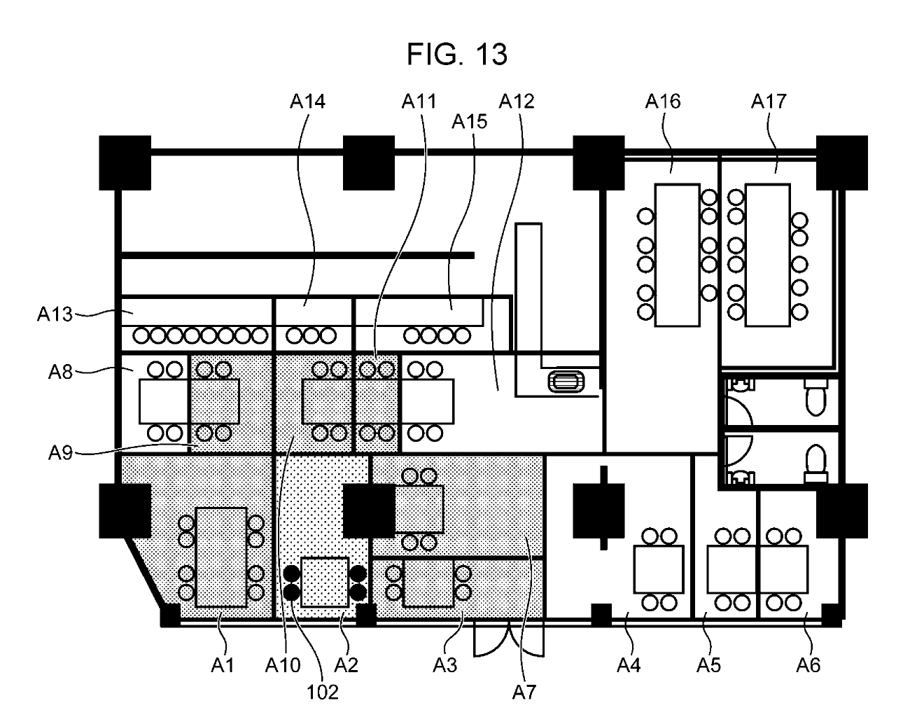

FIG. 13 is a diagram for describing a person-present cleaning target area and surrounding cleaning target areas in the embodiment. FIG. 13 illustrates that the cleaning target area A2 is a person-present cleaning target area, and the cleaning target areas A1, A2, A3, A7, A9, A10, and A11 are surrounding cleaning target areas around the cleaning target area A2.

Next, of all cleaning target areas, the cleanable area deciding unit 445 decides person-present cleaning target areas and surrounding cleaning target areas to be non-cleanable areas (step S5). Referencing FIG. 13, it can be seen that of the multiple cleaning target areas A1 through A17, the cleaning target areas A1, A2, A3, A7, A9, A10, and A11 are non-cleanable areas.

Next, of all cleaning target areas, the cleanable area deciding unit 445 decides cleaning target areas excluding person-present cleaning target areas and surrounding cleaning target areas to be cleanable areas (step S6). Referencing FIG. 13, it can be seen that by excluding the cleaning target areas A1, A2, A3, A7, A9, A10, and A11 from the multiple cleaning target areas A1 through A17 leaves the cleaning target areas A4, A5, A6, A8, A12, A13, A14, A15, A16, and A17 as cleanable areas.

Next, the display information generating unit 446 generates display information for displaying the non-cleanable areas and cleanable areas decided by the cleanable area deciding unit 445 on the display unit 42 (step S7). At this time, the display information generating unit 446 divides the floor plan indicated by the floor plan information into multiple cleaning target areas, and generated display information in which the multiple cleaning target areas are displayed such that the display form of the non-cleanable areas and the display form of the cleanable areas differ.

The display control unit 443 then displays the generated display information on the display unit 42 (step S8).

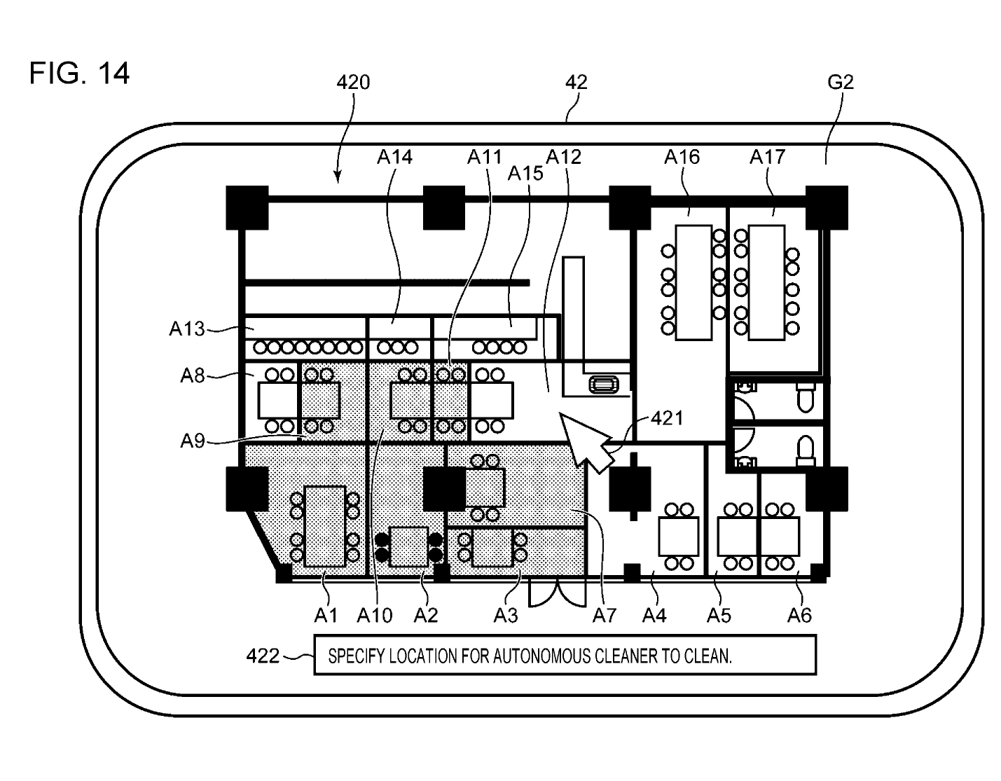

FIG. 14 is a diagram illustrating an example of a display screen that displays non-cleanable areas and cleanable areas in the present embodiment. The display screen G2 illustrated in FIG. 14 includes a floor plan 420 that has been divided into the multiple cleaning target areas, a selection cursor 421 for selecting cleanable areas to be cleaned by the autonomous cleaner 2, and a message 422 prompting selection of cleanable areas to be cleaned by the autonomous cleaner 2. The floor plan 420 includes cleanable areas and non-cleanable areas. The non-cleanable areas in FIG. 14 are cleaning target areas A1, A2, A3, A7, A9, A10, and A11, while the cleanable areas are cleaning target areas A4, A5, A6, A8, A12, A13, A14, A15, A16, and A17.

The cleanable areas and non-cleanable areas are displayed in different forms from each other. For example, the cleanable areas and non-cleanable areas are displayed using colors, contrasts, brightnesses, patterns, and so forth, that differ from each other. In the display screen G2 illustrated in FIG. 14, the non-cleanable areas are hatched, while the cleanable areas are not hatched.

A message 422 “SPECIFY LOCATION FOR AUTONOMOUS CLEANER TO CLEAN.” is displayed in the display screen G2, and the selection cursor 421 to be operated by the user is displayed. The selection cursor 421 is over the cleaning target area A12 in the example illustrated in FIG. 14. This indicates that out of the cleaning target areas A4, A5, A6, A8, A12, A13, A14, A15, A16, and A17 that are cleanable areas, the cleaning target area A12 is the cleanable area that the user has selected.

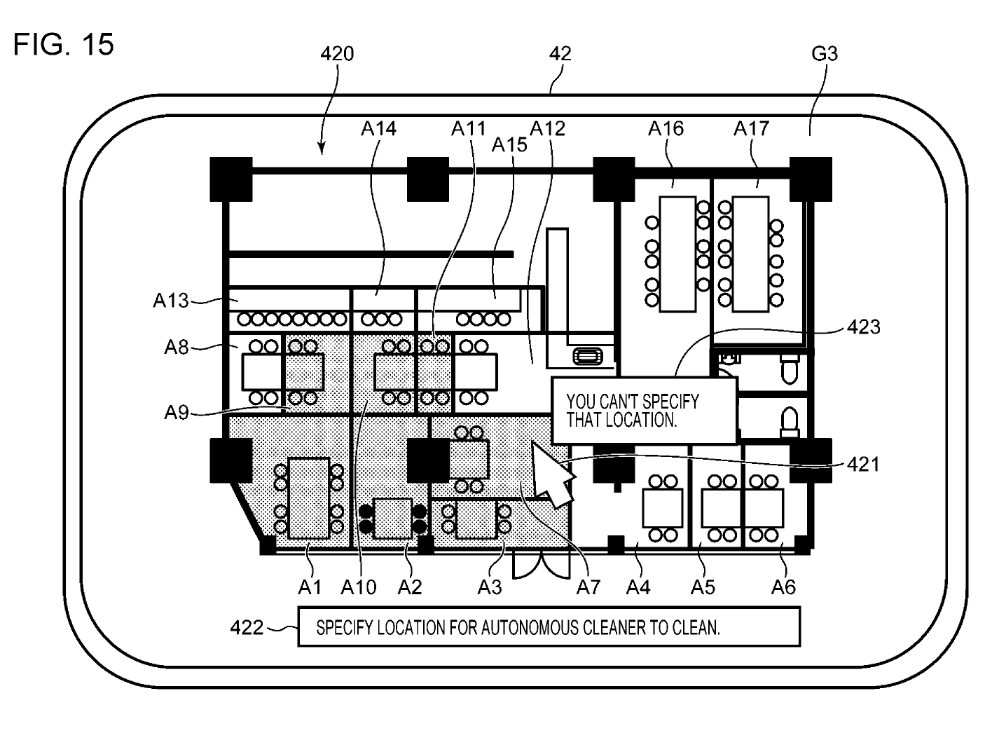

FIG. 15 is a diagram illustrating an example of a display screen displayed in a case where the user has selected a non-cleanable area in the present embodiment. Components in FIG. 15 that are the same as those in FIG. 14 are denoted with the same reference symbols, and detailed description will be omitted.

In the display screen G3 illustrated in FIG. 15, the selection cursor 421 has been moved to above the cleaning target area A7 that is a non-cleanable area, and the cleaning target area A7 is selected. In a case that selection of a non-cleanable area by the user has been accepted, the display control unit 443 presents to the user that the selected non-cleanable area cannot be cleaned by the autonomous cleaner 2. More specifically, in a case that selection of a non-cleanable area by the user has been accepted, the display control unit 443 displays a message 423 notifying the user that the selected non-cleanable area cannot be cleaned by the autonomous cleaner 2. The message 423 “YOU CAN′T SPECIFY THAT LOCATION.” is displayed on the display screen G3. Alternatively, the display control unit 443 may display non-cleanable areas so as to be unselectable by the user.

The terminal device 4 may have an audio output unit that outputs audio, and in a case that selection of a non-cleanable area has been accepted, audio may be output notifying the user that the selected non-cleanable area cannot be cleaned by the autonomous cleaner 2.

The input unit 43 then accepts user selection of the cleaning target area to be cleaned by the autonomous cleaner 2, out of the multiple cleanable areas displayed on the display unit 42 (step S9). The user touches the selection cursor 421 with a finger in the display screen G2 illustrated in FIG. 14, moves the selection cursor 421 over a cleanable area to be cleaned by the autonomous cleaner 2, and releases the finger above the cleanable area, thereby selecting the cleanable area to be cleaned by the autonomous cleaner 2.

The communication control unit 442 transmits area selection information indicating the cleanable areas selected by the user to the management device 1 next. In a case where the terminal device 4 has the cleaner allocation unit 124 of the management device 1, the input detection unit 444 may output the area selection information indicating the cleanable area selected by the user to the cleaner allocation unit 124 that the terminal device 4 has.

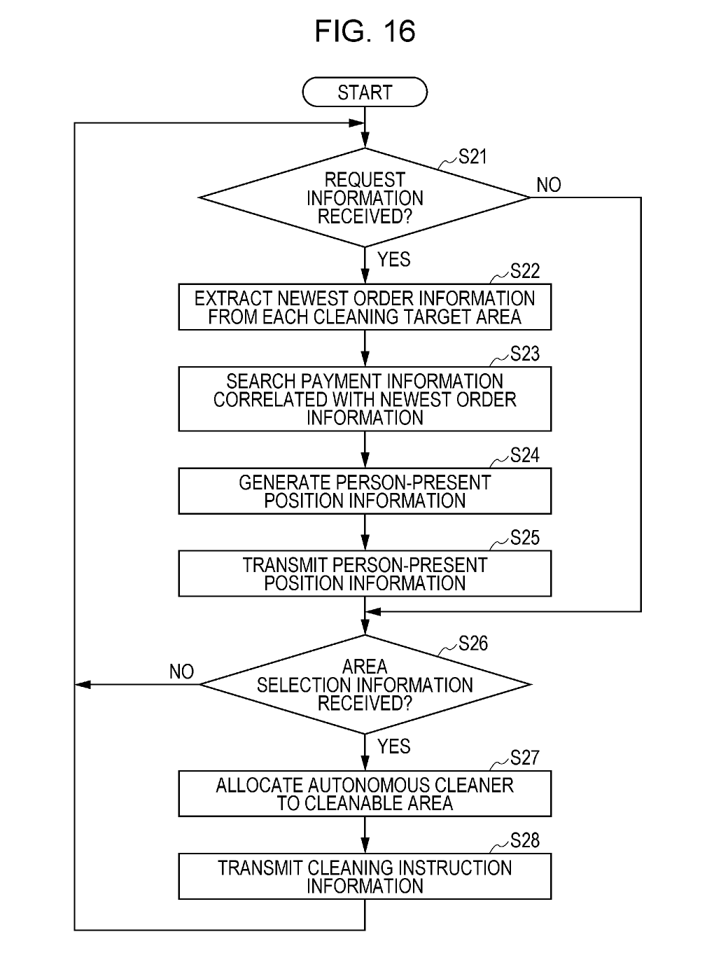

Next, the processing of the management device 1 will be described in detail with reference to the flowchart in FIG. 16. FIG. 16 is a flowchart for describing the processing of the management device 1 according to the present embodiment.

First, the communication control unit 122 judges whether or not request information requesting transmission of person-present position information has been received from the terminal device 4 (step S21). In a case where judgement is made here that no request information has been received (NO in step S21), the flow transitions to step S26.

On the other hand, in a case of having judged that request information has been received (YES in step S21), the person-presence judging unit 123 extracts the newest order information of the tables correlated with the cleaning target areas, from the order information stored in the order information history storage unit 1306 (step S22). In a case where the order information stored in the management device 1 is not the newest order information, the person-presence judging unit 123 obtains the newest order information from the terminal device 4, and thereafter performs the processing of step S22.

The person-presence judging unit 123 searches payment information correlated with the newest order information that has been extracted, from the payment information history storage unit 1307 (step S23). In a case where the payment information stored in the management device 1 is not the newest payment information, the person-presence judging unit 123 obtains the newest payment information from the POS cash register 3, and thereafter preforms the processing of step S23. The person-presence judging unit 123 searches for the payment information including the same order identification information as the order identification information included in the extracted order information, from the payment information existing in the payment information history storage unit 1307.

Next, the person-presence judging unit 123 generates person-present position information regarding whether or not there is a person present in each of the multiple cleaning target areas, based on search results (step S24). In a case where there is found to be payment information correlated with the order information as a result of the search, the person-presence judging unit 123 judges that payment of the table corresponding to this payment information has been completed, and that nobody is in the cleaning target area that includes this table. On the other hand, in a case where there is found no payment information correlated with the order information as a result of the search, the person-presence judging unit 123 judges that payment for the table corresponding to this payment information has not been completed, and that there is a person in the cleaning target area that includes this table.

In a case where the person-presence judging unit 123 judges that there is order identification information in the payment information that is the same as the order identification information in the order information, payment has already been completed, so the person-presence judging unit 123 judges that the table is unoccupied. In a case of judging that there is no order identification information in the payment information that is the same as the order identification information in the order information, payment has not been completed yet, so the person-presence judging unit 123 judges that the table is not unoccupied. The person-presence judging unit 123 judges whether or not there is a person in each cleaning target area, based on the judgment results of whether or not the tables are unoccupied. There are people only in the cleaning target area A2 in the example illustrated in FIG. 10, so the person-presence judging unit 123 generates person-present position information indicating that there is a person in the cleaning target area A2, and that there are no people in the cleaning target areas A1 and A3 through A17.

Next, the communication control unit 122 transmits the person-present position information generated by then person-presence judging unit 123 to the terminal device 4 (step S25).

The communication control unit 122 then judges whether or not area selection information indicating the cleanable area selected by the user has been received from the terminal device 4 (step S26). Now, in a case where judgment is made that no area selection information has been received (NO in step S26), the flow returns to the processing in step S21.

On the other hand, in a case where judgement is made that area selection information has been received (YES in step S26), the cleaner allocation unit 124 allocates the autonomous cleaner 2 to the cleanable area indicated by the area selection information, based on the information relating to the autonomous cleaner 2 stored in the cleaner information storage unit 1305 (step S27). The cleaning target areas A4, A5, A6, A8, A12, A13, A14, A15, A16, and A17 are cleanable areas in the example illustrated in FIG. 14, and the cleaning target area A12 is the cleanable area selected by the user. Accordingly, the cleaner allocation unit 124 allocates the autonomous cleaner 2 to the cleaning target area A12 that is the cleanable area selected by the user. Now, in a case where there are multiple autonomous cleaners 2, the cleaner allocation unit 124 can allocate all of the autonomous cleaners 2 or part of the autonomous cleaners 2 to the cleanable area selected by the user.

Next, the communication control unit 122 transmits cleaning instruction information to the autonomous cleaner 2, to clean the cleanable area (step S28). The flow thereafter returns to the processing in step S21.

According to the above-described configuration, non-cleanable areas including person-present cleaning target areas where people are present and surrounding cleaning target areas around person-present cleaning target areas, and cleanable areas other than the non-cleanable areas, are displayed using different forms. The autonomous cleaner 2 is allocated to the cleanable area selected by the user, so the autonomous cleaner 2 can be made to clean the cleanable area.

Although judgment regarding whether or not a person is present is performed based on the order information of the terminal device 4 and the payment information of the POS cash register 3 in the present embodiment, this configuration is not restrictive, as long as there is a configuration where judgment can be made whether or not there is a person. For example, a camera may shoot the cleaning target areas, and the person-presence judging unit 123 may judge whether or not there are people by performing pattern matching of people in images shot by the camera. Alternatively, human sensors such as infrared sensors may be installed in the cleaning target areas, with the person-presence judging unit 123 judging whether or not a person is present based on information from the human sensors. Further, pressure sensors may be installed in the seat faces of seats at the tables, and the person-presence judging unit 123 may judge whether or not a person is present based on information from the pressure sensors. Moreover, these technologies may be combined for the person-presence judging unit 123 to judge whether or not a person is present.

Note that description has been made in the present embodiment regarding a configuration where the management device 1 is outside of the eatery 10. However, the same advantages can be obtained by a configuration where the management device 1 is inside the eatery 10 as well.

The timing at which the terminal device 4 performs the above-described processing in the present embodiment preferably is in a time zone where customer traffic is light in a case of an eatery. In a case of performing the above-described processing in a time zone where customer traffic is heavy, a situation may occur where, for example, a cleanable area is temporarily decided and an autonomous cleaner 2 is allocated to the decided cleanable area, but guests arrive frequently while the autonomous cleaner 2 is cleaning the cleanable area that has been decided, so guests must be shown to a table where the autonomous cleaner 2 is cleaning. In this case, excess work of interrupting the cleaning by the autonomous cleaner 2, and retracting the autonomous cleaner 2 occurs, so the above-described processing preferably is performed in a time zone where customer traffic is light.

Although the management device 1 has the autonomous cleaner 2 to clean all of the multiple cleaning target areas in the present embodiment, cleanable areas may be decided by taking into consideration manual cleaning by people. For example, the terminal device 4 that the employee 51 carries in the eatery 10 may accept input of cleaning target areas cleaned by the employee 51 or cleaning target areas that are planned to be cleaned by the employee 51, and decide the input cleaning target areas to be non-cleanable areas for the autonomous cleaner 2. The terminal device 4 may also accept input of cleaning target areas that the employee 51 has completed cleaning of, and decide these cleaned cleaning target areas to be non-cleanable areas for the autonomous cleaner 2.

The cleaner allocation unit 124 may also allocate multiple autonomous cleaners 2 to one cleanable area selected by the user. In this case, there needs to be a standard regarding how many autonomous cleaners 2 are to be allocated to the cleanable area, and this standard preferably is settable by this user. As an example of a standard for allocation, for example, the number of autonomous cleaners 2 to be allocated to on cleanable area may be decided based on the area of the cleanable area and the area that an autonomous cleaner 2 can clean on one charge. In the case of this standard, the minimally necessary number of autonomous cleaners 2 to clean one cleanable area can be allocated to one cleanable area. As for another standard, the user may set the number of autonomous cleaners 2 that can be allocated to one cleanable area beforehand, with the cleaner allocation unit 124 deciding the number of autonomous cleaners 2 based on the contents set by the user. In this case, the user can decode the number of autonomous cleaners 2 necessary for each cleanable area beforehand, so the autonomous cleaners 2 can be made to clean in accordance with user preferences.

Note that in the present embodiment, in a case where a cleanable area that the autonomous cleaner 2 is currently cleaning transitions to either a person-present cleaning target area where a person is present, or a surrounding cleaning target area around a person-present cleaning target area, the management device 1 may interrupt the cleaning by the autonomous cleaner 2 and cause the autonomous cleaner 2 to return to its initial position. This configuration can prevent people from becoming uncomfortable.

Although the user selects one cleanable area in the present embodiment, multiple cleanable areas may be selected. In this case, the input unit 43 may accept user input of the order in which to clean the multiple cleanable areas by the autonomous cleaner 2. For example, the input detection unit 444 may decide the order selected by the user in which to clean the multiple cleanable areas as the order for the autonomous cleaner 2 to perform cleaning.

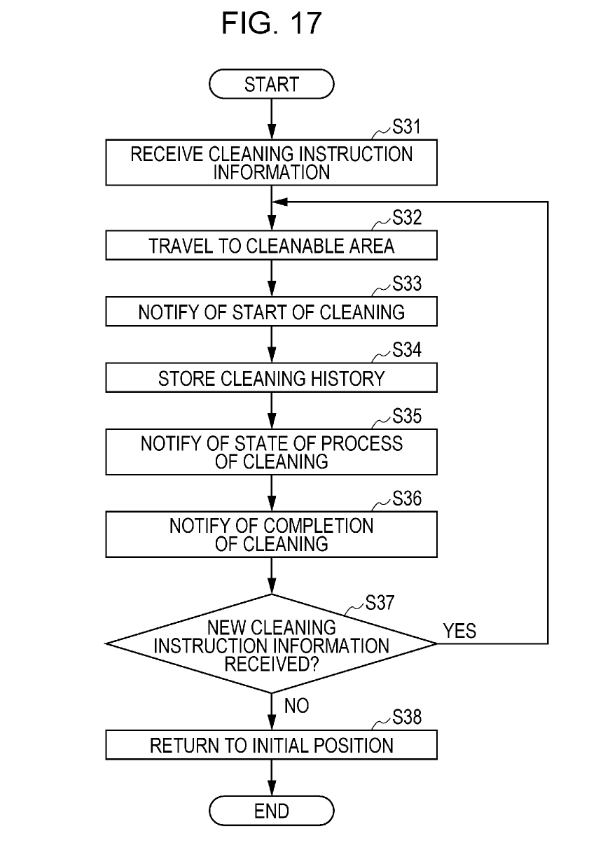

Next, processing of the autonomous cleaner 2 that has received cleaning instruction information from the management device 1 will be described with reference to the flowchart in FIG. 17. FIG. 17 is a flowchart for describing processing at the autonomous cleaner 2 according to the present embodiment.

First, the communication unit 25 of the autonomous cleaner 2 receives cleaning instruction information instructing cleaning of a cleanable area from the management device 1 (step S31). The communication control unit 263 stores information of cleanable areas included in the received cleaning instruction information in the cleanable area allocation information storage unit 275.

Next, the travel control unit 262 causes the autonomous cleaner 2 to travel to the cleanable area, based on the information stored in the cleanable area allocation information storage unit 275 and the information stored in the cleaning target area storage unit 274 (step S32).

The traveling method of the autonomous cleaner 2 traveling to the cleanable area instructed in the cleaning instruction information is for the autonomous cleaner 2 to, for example, store beforehand a travel route from the initial position of the autonomous cleaner 2, such as the position of a charging device or the like, to each cleaning target area, and the travel control unit 262 to cause the autonomous cleaner 2 to travel to the cleanable area based on the stored travel route. For example, the central control unit 261 sets the autonomous cleaner 2 to a remotely-operated mode, a manager performs remote operation of the autonomous cleaner 2 from a manager terminal that the manager or the like has, and the route from the initial position to each cleaning target area that the autonomous cleaner 2 has moved is stored in the storage unit 27 as travel path information.

As for another travel method, the travel control unit 262 may cause the autonomous cleaner 2 to travel, while comprehending at what position in the floor plan information that the autonomous cleaner 2 currently is, based on information indicating the cleaning target areas set to the floor plan information, which is stored in the cleaning target area storage unit 274 of the autonomous cleaner 2, and sensor information obtained by the sensor unit 21 of the autonomous cleaner 2. For example, the travel control unit 262 identifies the positions of obstacles around the autonomous cleaner 2 by obstacle sensors or collision sensors included in the sensor unit 21 of the autonomous cleaner 2, and thus can identify, from the position of the identified obstacle, at what position in the floor plan information that the autonomous cleaner 2 currently is. Alternatively, in a case where the initial position of the autonomous cleaner 2, such as the position of a charging device or the like, is included in the floor plan information beforehand, the travel control unit 262 can identify at what position in the floor plan information that the autonomous cleaner 2 currently is, by comprehending how far a distance the autonomous cleaner 2 has traveled in what direction from the initial position. Which direction the autonomous cleaner 2 has traveled in can be identified by a gyro sensor. Also, how far the autonomous cleaner 2 has traveled can be identified by a traveling sensor.

As another traveling method, the cleaning instruction information transmitted from the management device 1 may include route information, and the travel control unit 262 may cause the autonomous cleaner 2 to travel based on the received route information. Upon arriving at the cleanable area, the autonomous cleaner 2 begins cleaning.

Next, at the time of the autonomous cleaner 2 starting cleaning, the communication unit 25 of the autonomous cleaner 2 notifies the management device 1 that it will start cleaning of the cleanable area (step S33).

Next, the central control unit 261 stores cleaning history of the autonomous cleaner 2 in the cleaning history storage unit 276 while cleaning (step S34). An example of cleaning history is information where the travel route that the autonomous cleaner 2 has traveled is superimposed on map information of the cleaning target area.

The communication unit 25 of the autonomous cleaner 2 then notifies the management device 1 regarding the state of progress of cleaning while cleaning, either periodically or in accordance with the degree of progress of cleaning (step S35).

Upon the cleaning of the cleanable area being completed, the communication unit 25 of the autonomous cleaner 2 then notifies the management device 1 that cleaning of the cleanable area has been completed (step S36).

Next, the communication control unit 263 judges whether or not new cleaning instruction information that instructs cleaning of a new cleanable area has been received from the management device 1 (step S37). Upon having received the notification to the effect that cleaning has been completed from the autonomous cleaner 2, the management device 1 may make a notification to the terminal device 4 to the effect that cleaning has been completed. The terminal device 4 then decides the cleanable area regarding which cleaning has been completed as being a non-cleanable area, further displays non-cleanable areas and cleanable areas using different forms, and may accept selection of a cleanable area by the user. In a case where the user has selected a new cleanable area, the management device 1 transmits cleaning instruction information instructing cleaning of a new cleanable area to the autonomous cleaner 2.

Upon receiving a notification from the autonomous cleaner 2 that cleaning has been completed, the management device 1 may transmit return instruction information to the autonomous cleaner 2, to return to home position that is the initial position.

In a case where judgment is made that new cleaning instruction information has been received (YES in step S37), the flow returns to the processing in step S32, and the travel control unit 262 of the autonomous cleaner 2 causes the autonomous cleaner 2 to travel to the new cleanable area and start cleaning.

On the other hand, in a case where judgment is made that new cleaning instruction information has not been received (NO in step S37), the travel control unit 262 of the autonomous cleaner 2 causes the autonomous cleaner 2 to return to the initial position (step S38). Note that an arrangement may be made where, in a case where a predetermined amount of time has elapsed from notifying the management device 1 that cleaning of the cleanable area has been completed, or in a case of having received return instruction information, the travel control unit 262 may judge that no new cleaning instruction information has been received. According to the above-described processing, the autonomous cleaner 2 can perform cleaning following cleaning instruction information received from the management device 1.

Note that the management device 1 according to the present embodiment transmits return instruction information to return the autonomous cleaner 2 to the initial position, but the present disclosure is not restricted to this in particular. The management device 1 may specify a temporary standby position, and transmit standby instruction information to the autonomous cleaner 2 to cause the autonomous cleaner 2 to travel to the standby position and to stand by. In a case where distance from the cleanable area where the autonomous cleaner 2 has completed cleaning to the initial position is far, returning the autonomous cleaner 2 to the initial position is inefficient. However, according to this configuration, if there is in particular a cleaning target area that is not cleanable at the present point but cleaning thereof has not been completed near the cleanable area where the autonomous cleaner 2 has completed cleaning, the autonomous cleaner 2 may stand by at a standby position near the current position. Then, when the cleaning target area regarding which cleaning has not been completed is decided to be a new cleanable area, and is selected by the user, the autonomous cleaner 2 can travel from the standby position to the cleanable area, and thereby reduce the amount of time necessary for traveling. Note that the standby position may be a standby area set beforehand, or may be one cleaning target area selected according to predetermined conditions from at least one cleaning target area where there are no people.

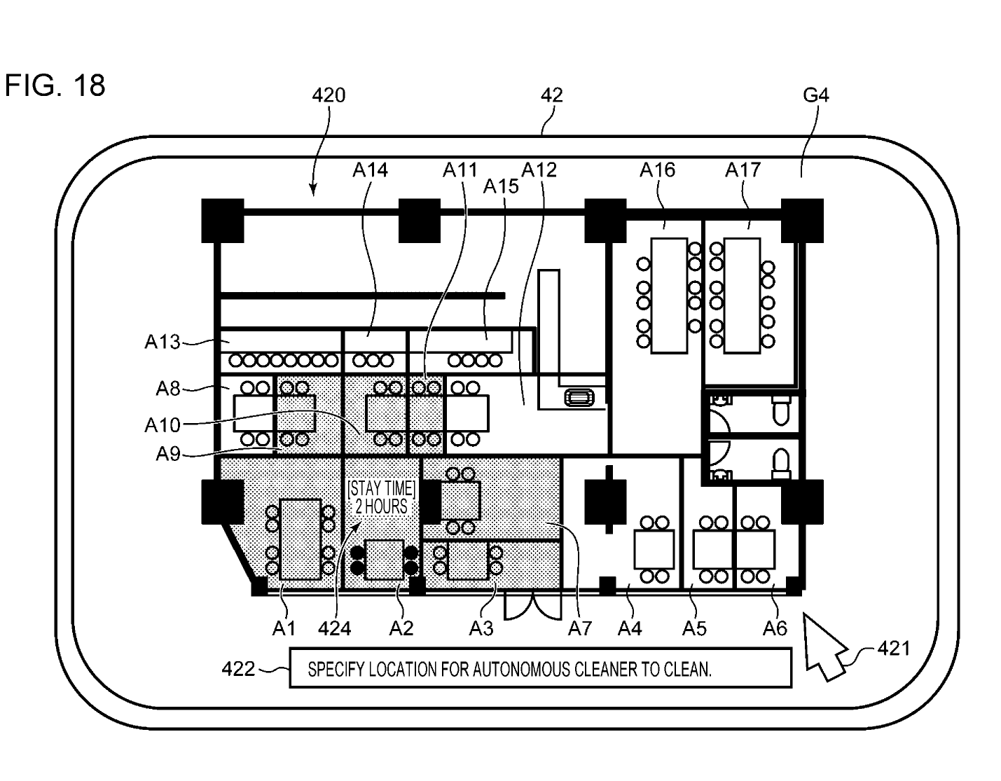

Next, various modifications of the display screen displaying non-cleanable areas and cleanable areas in the present embodiment will be described. FIG. 18 is a diagram illustrating an example of a display screen displaying non-cleanable areas and cleanable areas in a first modification of the present embodiment. Components in FIG. 18 that are the same as those in FIG. 14 are denoted with the same reference symbols, and detailed description will be omitted.

In the first modification of the present embodiment, stay time information indicating the stay time of a person in the person-present cleaning target area is obtained, and the stay time is displayed in the person-present cleaning target area. The display screen G4 illustrated in FIG. 18 illustrates stay time 424 of people in the person-present cleaning target area superimposed on the display screen G2 illustrated in FIG. 14. “2 HOURS” is displayed for the stay time 424 illustrated in FIG. 18.

In this case, the communication control unit 442 obtains stay time information indicating the stay time of people in the person-present cleaning target area. Note that the communication control unit 442 may obtain stay time information separately from the person-present position information, and may obtain person-present position information including stay time information. The stay time information is information indicating how much time has elapsed since a person has entered the cleaning target area. For example, order information includes the time of day at which an order was input. The person-presence judging unit 123 of the management device 1 references the order information corresponding to the person-present cleaning target area where a person is present, and calculates the elapsed time from the time of day at which the order was input until the current time of day. Accordingly, the stay time of people staying in the person-present cleaning target area where people are present can be identified.

The display control unit 443 displays the stay time of the person-present cleaning target area, based on the obtained stay time information. For example, the stay time 424 is displayed over the cleaning target area A2 that is a person-present cleaning target area.

According to this configuration, the user can select cleanable areas taking into consideration the stay time of people. That is to say, a cleaning target area where the stay time has been long has a high probability of the people leaving soon, so the movement distance of the autonomous cleaner 2 can be reduced by first cleaning a cleanable area near this cleaning target area, and thereafter selecting the cleaning target area after people have left as a cleanable area. Also, a cleaning target area where the stay time is short has a high probability that people will not leave soon, so the movement distance of the autonomous cleaner 2 can be reduced by cleaning in order from cleanable areas away from this cleaning target area.

Note that the person-presence judging unit 123 may decide the time elapsed from the time of day of the first order being input to the current time of day as the stay time, or may decide the time elapsed from the time of day of the last order being input to the current time of day as the stay time.

The display control unit 443 may display the person-present cleaning target area using a form corresponding to the obtained stay time information. More specifically, the display control unit 443 may display first non-cleanable areas including first person-present cleaning target areas and first surrounding cleaning target areas around the first person-present cleaning target areas, and second non-cleanable areas including second person-present cleaning target areas that differ from the person-present cleaning target areas regarding stay time and second surrounding cleaning target areas around the second person-present cleaning target areas, using different forms. For example, a first non-cleanable area of which the stay time is ten minutes may be displayed in red, and a second non-cleanable area of which the stay time is two hours may be displayed in blue. Accordingly, the display control unit 443 may display first non-cleanable areas and second non-cleanable areas by different colors from each other, or different contrast, brightness, or patterns from each other, in accordance with the length of the stay time.

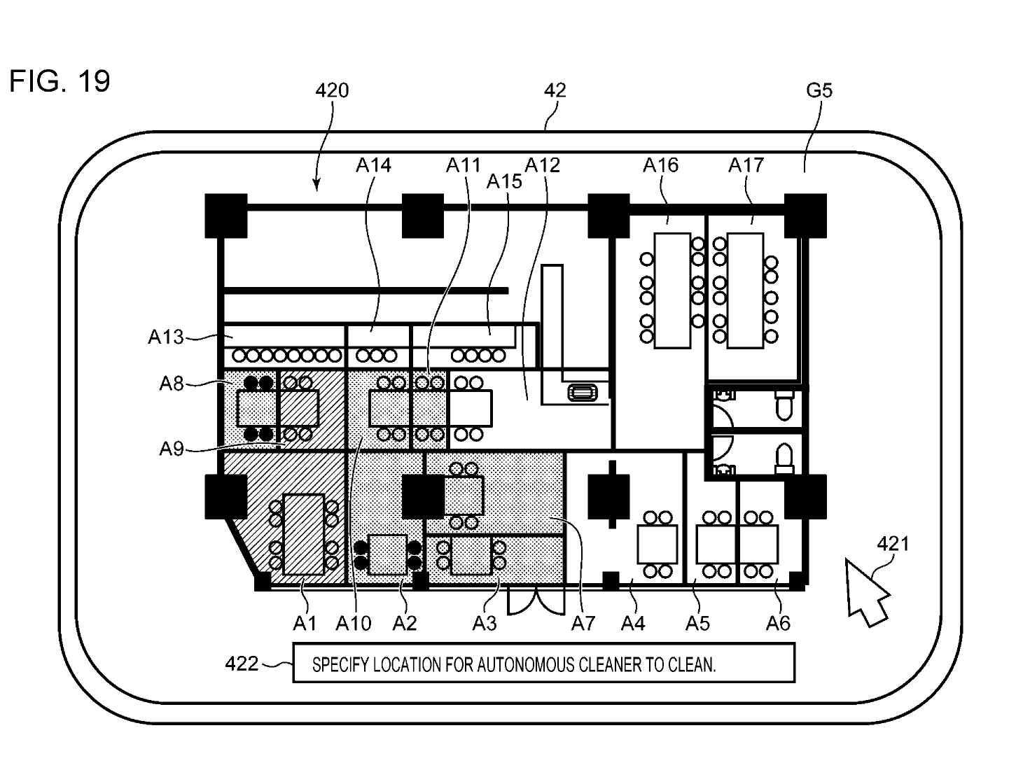

FIG. 19 is a diagram illustrating an example of a display screen displaying non-cleanable areas and cleanable areas in a second modification of the present embodiment. Components in FIG. 19 that are the same as those in FIG. 14 are denoted with the same reference symbols, and detailed description will be omitted.

In the second modification of the present embodiment, in a case where there is overlapping of first surrounding cleaning target areas around a first person-present cleaning target area and second surrounding cleaning target areas around a second person-present cleaning target area, the first surrounding cleaning target areas and second surrounding cleaning target areas that overlap, and the first surrounding cleaning target areas and second surrounding cleaning target areas that do not overlap, are displayed using different forms.

In the display screen G5 illustrated in FIG. 19, the cleaning target area A2 is a first person-present cleaning target area where first people are present, and the cleaning target area A8 is a second person-present cleaning target area where second people are present. Also, cleaning target areas A1, A3, A7, A9, A10, and A11 are first surrounding cleaning target areas around the first person-present cleaning target area. Cleaning target areas A1, A9, and A13 are second surrounding cleaning target areas around the second person-present cleaning target area.

In a case where the first surrounding cleaning target areas and second surrounding cleaning target areas overlap at this time, the display control unit 443 displays the first surrounding cleaning target areas and second surrounding cleaning target areas that do not overlap, and the first surrounding cleaning target areas and second surrounding cleaning target areas that overlap, using different forms.

The cleaning target areas A1 and A9 are first surrounding cleaning target areas and second surrounding cleaning target areas that overlap in FIG. 19, and accordingly are displayed in different colors from the cleaning target areas A3, A7, A10, A11, and A13 that do not overlap. For example, the display control unit 443 may display the first surrounding cleaning target areas and second surrounding cleaning target areas that overlap in red, and the first surrounding cleaning target areas and second surrounding cleaning target areas that do not overlap in yellow. Alternatively, the display control unit 443 may display the first surrounding cleaning target areas and second surrounding cleaning target areas that overlap and the first surrounding cleaning target areas and second surrounding cleaning target areas that do not overlap by different contrast, brightness, or patterns from each other.

The cleaning target areas where the first surrounding cleaning target areas and second surrounding cleaning target areas overlap are not selectable as cleanable areas until people are gone from both the first person-present cleaning target area and second person-present cleaning target area. On the other hand, the cleaning target areas where the first surrounding cleaning target areas and second surrounding cleaning target areas do not overlap are selectable as cleanable areas as soon as people are gone from one or the other of the first person-present cleaning target area and second person-present cleaning target area. Accordingly, the user can plan to clean the cleaning target areas where the first surrounding cleaning target areas and second surrounding cleaning target areas overlap later than the cleaning target areas where the first surrounding cleaning target areas and second surrounding cleaning target areas do not overlap.

The display control unit 443 may further, in a case where first surrounding cleaning target areas of around first person-present cleaning target area, second surrounding cleaning target areas around a second person-present cleaning target area, and third surrounding cleaning target areas around a third person-present cleaning target area, overlap, display the overlapping first surrounding cleaning target areas and second surrounding cleaning target areas and third surrounding cleaning target areas, and second surrounding cleaning target areas and third surrounding cleaning target area that overlap but do not overlap the first surrounding cleaning target areas, using different forms. In this case, the surrounding cleaning target areas can be displayed in different forms in accordance with the degree of the surrounding cleaning target areas overlapping.

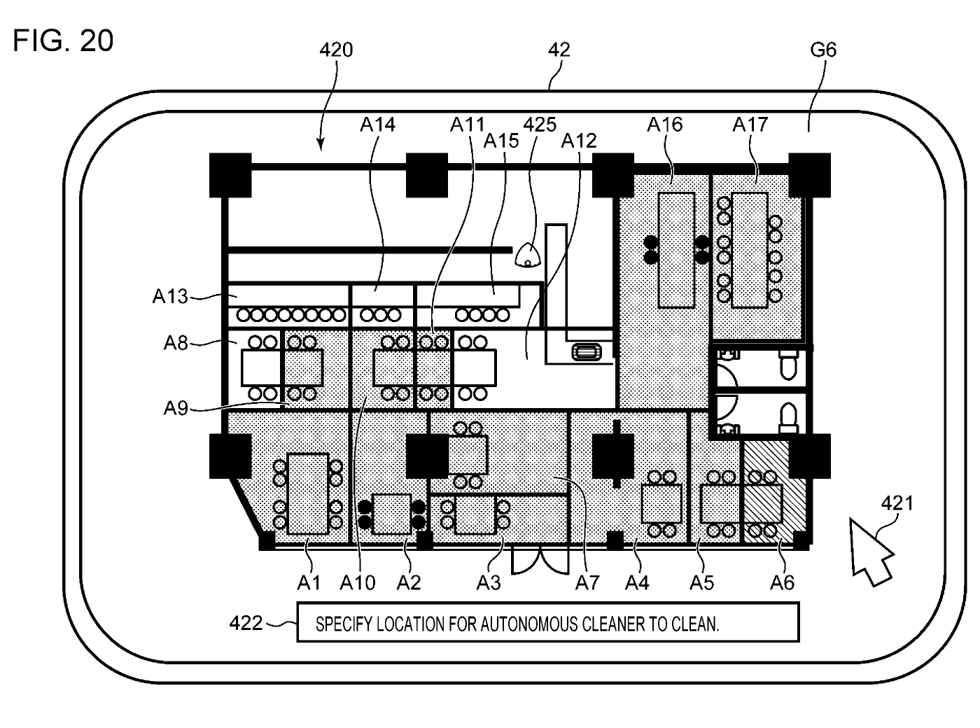

FIG. 20 is a diagram illustrating an example of a display screen displaying non-cleanable areas and cleanable areas in a third modification of the present embodiment. Components in FIG. 20 that are the same as those in FIG. 14 are denoted with the same reference symbols, and detailed description will be omitted.

In the third modification of the present embodiment, in a case where there is a person-present cleaning target area or a surrounding cleaning target area on a route from the current position of the autonomous cleaner 2 to a cleaning target area corresponding to a cleanable area, this cleanable area is changed to a non-cleanable area.

In the display screen G6 illustrated in FIG. 20, cleaning target areas A2 and A16 are person-present cleaning target areas where people are present, cleaning target areas A1, A3, A7, A9, A10, and A11 are surrounding cleaning target areas of the cleaning target area A2, and cleaning target areas A4, A5, A12, and A17 are surrounding cleaning target areas of the cleaning target area A16.

The communication control unit 442 obtains position information indicating the current position of the autonomous cleaner 2 in the predetermined space from the management device 1. The communication control unit 122 of the management device 1 obtains position information indicating the current position of the autonomous cleaner 2 from the autonomous cleaner 2, and transmits this to the terminal device 4.

The position information of the autonomous cleaner 2 can be comprehended, by the autonomous cleaner 2 identifying at what position in the floor plan information it is, based on the floor plan information that the autonomous cleaner 2 has and information obtained from the sensor unit 21. For example, the positions of obstacles around the autonomous cleaner 2 can be identified by obstacle sensors or collision sensors included in the sensor unit 21 of the autonomous cleaner 2, and thus at what position in the floor plan information that the autonomous cleaner 2 currently is can be identified, from the position of the identified obstacle. Alternatively, in a case where the initial position of the autonomous cleaner 2, such as the position of a charging device or the like, is included in the floor plan information beforehand, at what position in the floor plan information that the autonomous cleaner 2 currently is can be identified by measuring how far a distance the autonomous cleaner 2 has traveled in what direction from the initial position. Which direction the autonomous cleaner 2 has moved in can be identified by a gyro sensor. Also, how far the autonomous cleaner 2 has traveled can be identified by a traveling sensor.

The cleanable area deciding unit 445 generates routes for traveling from the current position of the autonomous cleaner 2 to each of the multiple cleaning target areas, based on the obtained position information. In a case where there is a person-present cleaning target area or a surrounding cleaning target area on a route from the current position of the autonomous cleaner 2 to a particular cleaning target area corresponding to a cleanable area, the cleanable area deciding unit 445 changes the cleanable area corresponding to the particular cleaning target area to a non-cleanable area.

The display screen G6 illustrated in FIG. 20 displays an icon 425 indicating the current position of the autonomous cleaner 2. The cleaning target area A6 is a cleanable area in FIG. 20, so the user can select the cleaning target area A6. However, in order to travel from the current position to the cleaning target area A6, the autonomous cleaner 2 has to pass through a non-cleanable area, and may be bothersome for the people present at the cleaning target areas A2 and A16. Accordingly, in a case where there is a person-present cleaning target area or surrounding cleaning target area on the route from the current position of the autonomous cleaner 2 to a cleaning target area corresponding to a cleanable area, the cleanable area deciding unit 445 changes this cleanable area to a non-cleanable area. In FIG. 20, a person-present cleaning target area or surrounding cleaning target area is on the route of the autonomous cleaner 2 traveling from the current position to the cleaning target area A6, so the cleaning target area A6 is changed from a cleanable area to a non-cleanable area.

In this way, in a case where there is a person-present cleaning target area or surrounding cleaning target area on the route from the current position of the autonomous cleaner 2 to a cleaning target area corresponding to a cleanable area, this cleanable area is changed to a non-cleanable area, so the user can select a cleanable area that will not bother people in person-present cleaning target areas.

Note that the route of the autonomous cleaner 2 preferably is generated within a range of cleanable areas. Accordingly, in a case where a route cannot be generated from the current position of the autonomous cleaner 2 to a cleaning target area corresponding to a cleanable area through only cleanable areas out of the cleaning target areas, the cleanable area deciding unit 445 may change the cleanable area to a non-cleanable area. For example, in a case of attempting to generate a route from the current position of the autonomous cleaner 2 to the cleaning target area A6 in FIG. 20, the current position of the autonomous cleaner 2 cannot be connected by cleanable areas to the cleaning target area A6, so a route cannot be generated. Accordingly, the cleanable area deciding unit 445 may change the cleaning target area A6 from a cleanable area to a non-cleanable area.

Also, the display control unit 443 may display an additionally-generated route superimposed. Accordingly, the user can select cleanable areas having comprehended what route autonomous cleaner 2 will use to travel. In a case where the route of the autonomous cleaner 2 to the cleanable area coincides with the customer traffic flow of the eatery staff, the user may keep this cleanable area from being selected, or may call attention to the staff to take care.

While one autonomous cleaner 2 is present in the predetermined space in the third modification of the present embodiment, multiple autonomous cleaners 2 may be in the predetermined space. In this case, the routes to cleanable areas change depending on the positions of the autonomous cleaners 2 in the predetermined space, so an arrangement may be made where the input unit 43 accepts selection of an autonomous cleaner 2 out of the multiple autonomous cleaners 2 to perform cleaning, the cleanable area deciding unit 445 decides non-cleanable areas and cleanable areas each time selection of the autonomous cleaner 2 is accepted, and the display control unit 443 switches display of non-cleanable areas and cleanable areas in accordance with the selected autonomous cleaner 2.

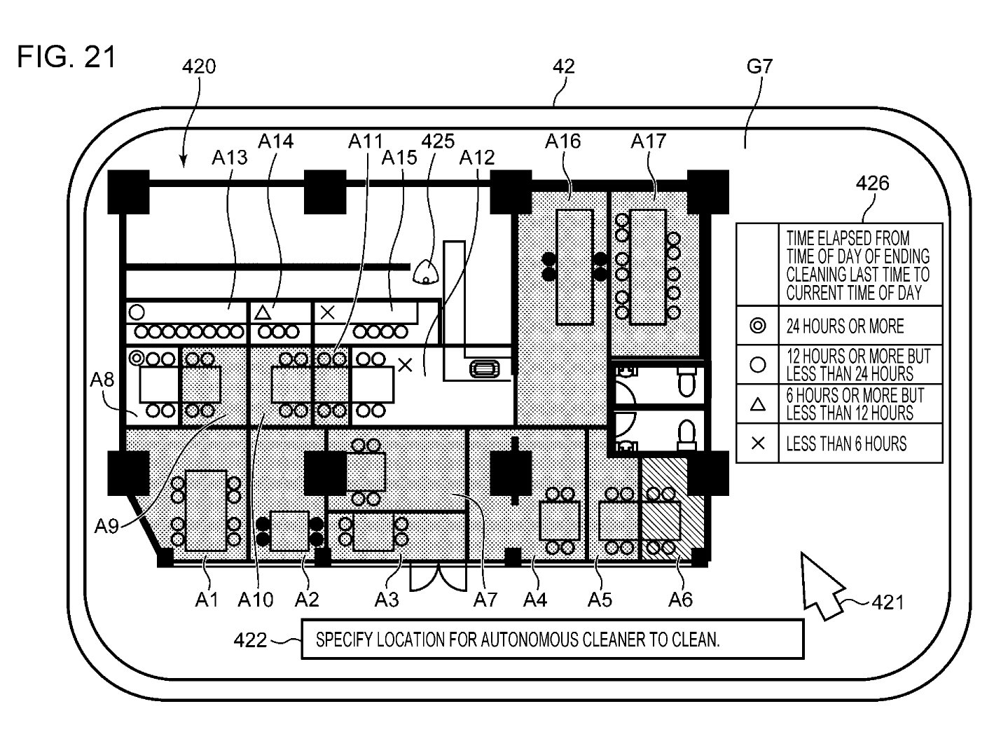

FIG. 21 is a diagram illustrating an example of a display screen displaying non-cleanable areas and cleanable areas in a fourth modification of the present embodiment. Components in FIG. 21 that are the same as those in FIGS. 14 and 20 are denoted with the same reference symbols, and detailed description will be omitted.

In the fourth modification of the present embodiment, multiple cleanable areas are displayed using different forms in accordance with elapsed time from the time of day of ending cleaning the last time to the current time of day.

The cleaning history storage unit 455 manages cleaning history of the autonomous cleaner 2 corresponding to each of the multiple cleaning target areas. In a case where multiple cleanable areas are displayed as cleaning target areas, the display control unit 443 displays multiple cleanable areas using different forms, in accordance with the time elapsed from the time of day of ending cleaning the last time to the current time of day, based on the cleaning history of the autonomous cleaner 2 corresponding to each of the multiple cleanable areas.

In a display screen G7 illustrated in FIG. 21, cleaning target areas A2 and A16 are person-present cleaning target areas where people are present, cleaning target areas A1, A3, A7, A9, A10, and A11 are surrounding cleaning target areas of the cleaning target area A2, and cleaning target areas A4, A5, A12, and A17 are surrounding cleaning target areas of the cleaning target area A16. Further, the cleaning target area A6 has been changed from a cleanable area to a non-cleanable area, since there is a person-present cleaning target area or surrounding cleaning target area on the route for the autonomous cleaner 2 to travel from the current position to the cleaning target area A6., in the same way as in the above-described third modification of the present embodiment.

The elapsed time from the time of day of ending cleaning the last time to the current time of day is 24 hours or more for the cleaning target area A8, the elapsed time from the time of day of ending cleaning the last time to the current time of day is 12 hours or more but less than 24 hours for the cleaning target area A13, the elapsed time from the time of day of ending cleaning the last time to the current time of day is 6 hours or more but less than 12 hours for the cleaning target area A14, and the elapsed time from the time of day of ending cleaning the last time to the current time of day is less than 6 hours for the cleaning target areas A12 and A15.

Cleanable areas where the elapsed time from the time of day of ending cleaning the last time to the current time of day is 24 hours or more, cleanable areas where the elapsed time from the time of day of ending cleaning the last time to the current time of day is 12 hours or more but less than 24 hours, cleanable areas where the elapsed time from the time of day of ending cleaning the last time to the current time of day is 6 hours or more but less than 12 hours, and cleanable areas where the elapsed time from the time of day of ending cleaning the last time to the current time of day is less than 6 hours, are each displayed using different forms from each other.

For example, cleanable areas where the elapsed time from the time of day of ending cleaning the last time to the current time of day is 24 hours or more are indicated by the letter A, cleanable areas where the elapsed time from the time of day of ending cleaning the last time to the current time of day is 12 hours or more but less than 24 hours are indicated by the letter B, cleanable areas where the elapsed time from the time of day of ending cleaning the last time to the current time of day is 6 hours or more but less than 12 hours are indicated by the letter C, and cleanable areas where the elapsed time from the time of day of ending cleaning the last time to the current time of day is less than 6 hours are indicated by the letter D. The display screen G7 also displays a correlation table 426 indicating what these letters mean.

Although letters are displayed in the cleanable areas to differentiate according to the elapsed time from the time of day of ending cleaning the last time to the current time of day in the fourth modification of the present embodiment, the present disclosure is not particularly restricted to this. The color, contrast, brightness, or patterns of multiple cleanable areas may be different from each other, in accordance with the elapsed time from the time of day of ending cleaning the last time to the current time of day.

For example, in a case where the amount of time elapsed from the time of day of ending cleaning the last time to the current time of day is less than 6 hours, it is conceivable that there is little accumulation of dust. Accordingly, a cleanable are regarding which the time of day of ending cleaning the last time to the current time of day is less than a predetermined amount of time may be handled as a non-cleanable area, and user selection thereof does not have to be accepted.

In the fourth modification of the present embodiment, an arrangement may be made where, instead of displaying the letter “D” in cleanable areas where the elapsed time from the time of day of ending cleaning the last time to the current time of day is less than a predetermined amount of time (e.g., less than 6 hours), the text “cleaned” is displayed.

Accordingly, multiple cleanable areas are displayed in different forms in accordance with the elapsed time from the time of day of ending cleaning the last time to the current time of day, so the user can easily recognize which areas can be expected to have more dust. Note that the elapsed time from the time of day of ending cleaning the last time to the current time of day in the fourth modification of the present embodiment is not restricted to that described above.

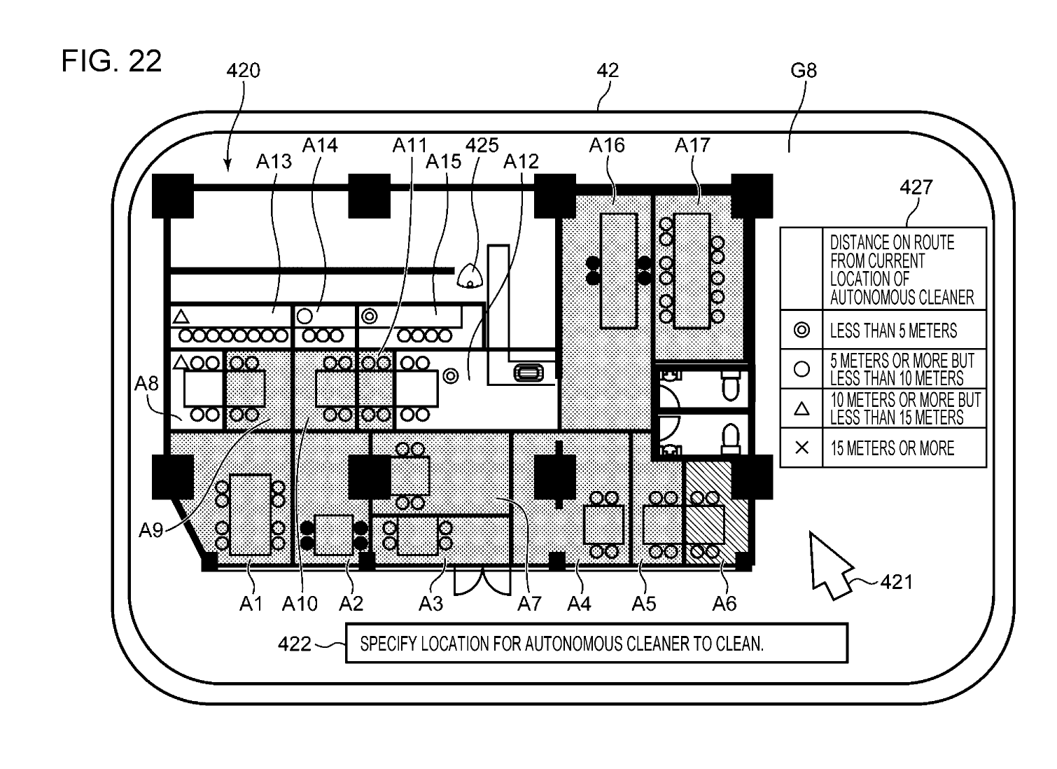

FIG. 22 is a diagram illustrating an example of a display screen displaying non-cleanable areas and cleanable areas in a fifth modification of the present embodiment. Components in FIG. 22 that are the same as those in FIGS. 14 and 20 are denoted with the same reference symbols, and detailed description will be omitted.

In the fifth modification of the present embodiment, in a case where multiple cleanable areas are displayed as cleanable areas, the multiple cleanable areas are displayed using different forms in accordance with the distance of the route from the current position of the autonomous cleaner 2 to each of the multiple cleanable areas.

The communication control unit 442 obtains position information indicating the current position of the autonomous cleaner 2 in the predetermined space from the management device 1. The communication control unit 122 of the management device 1 obtains position information indicating the current position of the autonomous cleaner 2 from the autonomous cleaner 2, and transmits this to the terminal device 4. Based on the obtained position information, the cleanable area deciding unit 445 generates routes for traveling from the current position of the autonomous cleaner 2 to each of the multiple cleaning target areas. In a case where multiple cleanable areas are displayed as cleanable areas, the display control unit 443 displays the multiple cleanable areas using different forms in accordance with the distance of the routes.

In a display screen G8 illustrated in FIG. 22, cleaning target areas A2 and A16 are person-present cleaning target areas where people are present, cleaning target areas A1, A3, A7, A9, A10, and A11 are surrounding cleaning target areas of the cleaning target area A2, and cleaning target areas A4, A5, A12, and A17 are surrounding cleaning target areas of the cleaning target area A16. Further, the cleaning target area A6 has been changed from a cleanable area to a non-cleanable area, since there is a person-present cleaning target area or surrounding cleaning target area on the route for the autonomous cleaner 2 to travel from the current position to the cleaning target area A6., in the same way as in the above-described third modification of the present embodiment.

Also, the route distance from the current position of the autonomous cleaner 2 to the cleaning target areas A12 and A15 is less than 5 meters, the route distance from the current position of the autonomous cleaner 2 to the cleaning target area A14 is 5 meter or more but less than 10 meters, and the route distance from the current position of the autonomous cleaner 2 to the cleaning target areas A8 and A13 is 10 meter or more but less than 15 meters.

Cleaning target areas where the route distance from the current position of the autonomous cleaner 2 is less than 5 meters are indicated by the letter A, cleaning target areas where the route distance from the current position of the autonomous cleaner 2 t is 5 meter or more but less than 10 meters are indicated by the letter B, cleaning target areas where the route distance from the current position of the autonomous cleaner 2 is 10meter or more but less than 15 meters are indicated by the letter C, and cleaning target areas where the route distance from the current position of the autonomous cleaner 2 is 15 meter or more are indicated by the letter D. The display screen G8 also displays a correlation table 427 indicating what these letters mean.

Although letters are displayed in the multiple cleanable areas to differentiate according to the route distance from the current position of the autonomous cleaner 2 to each of the multiple cleaning target areas in the fifth modification of the present embodiment, the present disclosure is not particularly restricted to this. The color, contrast, brightness, or patterns of multiple cleanable areas may be different from each other, in accordance with the route distance from the current position of the autonomous cleaner 2 to each of the multiple cleaning target areas.

Accordingly, multiple cleanable areas are displayed in different forms in accordance with the route distance from the current position of the autonomous cleaner 2 to each of the multiple cleanable areas, so the user can easily recognize route distance from the current position of the autonomous cleaner 2 to each of the multiple cleanable areas. In a case of hurriedly operating the autonomous cleaner 2, the user can easily select cleanable areas near to the autonomous cleaner 2. Note that the route distance from the current position of the autonomous cleaner 2 to each of the multiple cleanable areas in the fifth modification of the present embodiment is not restricted to that described above.

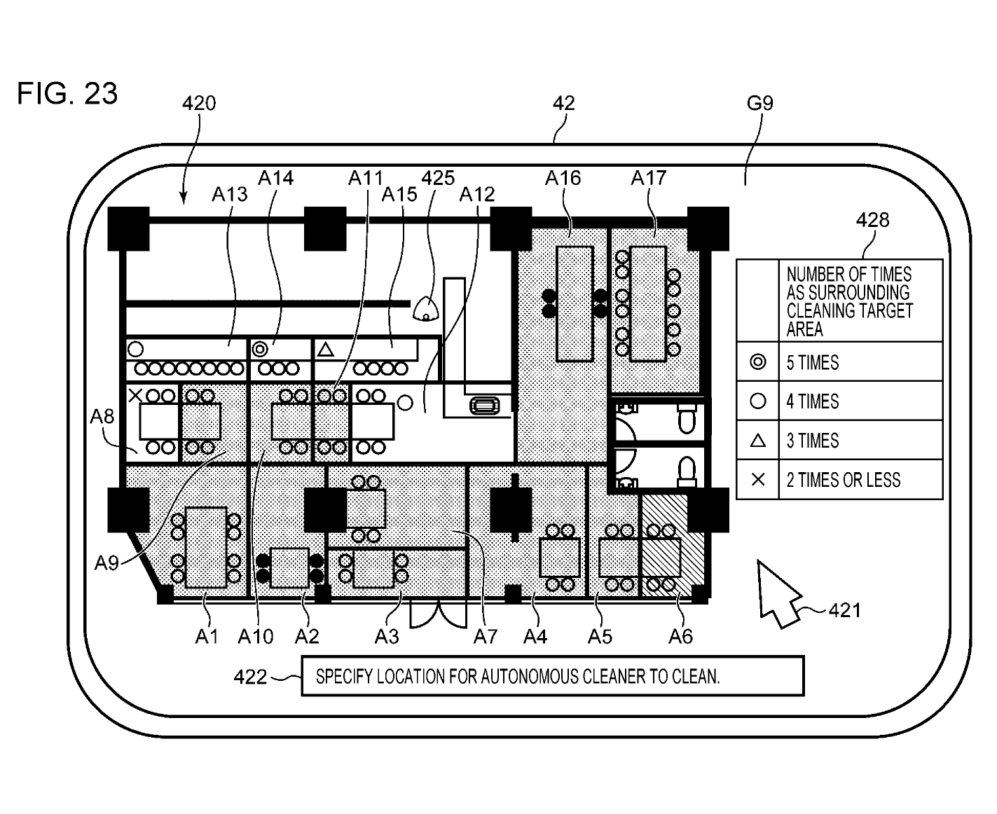

FIG. 23 is a diagram illustrating an example of a display screen displaying non-cleanable areas and cleanable areas in a sixth modification of the present embodiment. Components in FIG. 23 that are the same as those in FIGS. 14 and 20 are denoted with the same reference symbols, and detailed description will be omitted.

In the sixth modification of the present embodiment, in a case where multiple cleanable areas are displayed as cleanable areas, the multiple cleanable areas are displayed using different forms in accordance with the number of times of having been identified as a surrounding cleaning target area of another cleaning target area.

The display control unit 443 identifies surrounding areas of each of the multiple cleaning target areas and calculates the number of times that each of the multiple cleaning target areas has been identified as being a surrounding area of another cleaning target area. In a case where multiple cleanable areas are displayed, the multiple cleanable areas are displayed using forms corresponding to the calculated number of times.

In a display screen G9 illustrated in FIG. 23, cleaning target areas A2 and A16 are person-present cleaning target areas where people are present, cleaning target areas A1, A3, A7, A9, A10, and A11 are surrounding cleaning target areas of the cleaning target area A2, and cleaning target areas A4, A5, A12, and A17 are surrounding cleaning target areas of the cleaning target area A16. Further, the cleaning target area A6 has been changed from a cleanable area to a non-cleanable area, since there is a person-present cleaning target area or surrounding cleaning target area on the route for the autonomous cleaner 2 to travel from the current position to the cleaning target area A6., in the same way as in the above-described third modification of the present embodiment.

The number of times that the cleaning target area A14 has been identified as a surrounding cleaning target area from another cleaning target area is five times, the number of times that the cleaning target areas A12 and A13 have been identified as a surrounding cleaning target area from another cleaning target area is four times, number of times that the cleaning target area A15 has been identified as a surrounding cleaning target area from another cleaning target area is three times, and number of times that the cleaning target area A8 has been identified as a surrounding cleaning target area from another cleaning target area is two times.

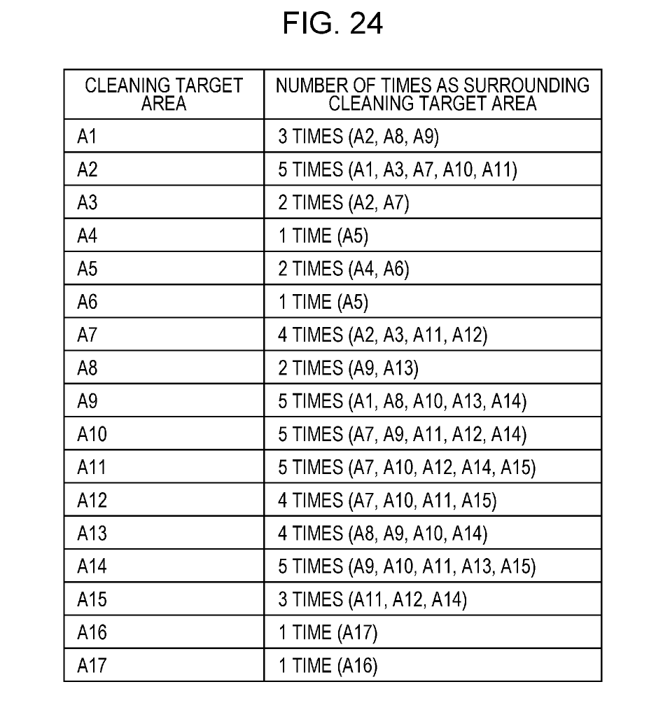

FIG. 24 is a diagram illustrating an example of surrounding area count information where the cleaning target areas, and the number of times that the cleaning target areas have been cleaning target areas of other cleaning target areas, have been correlated, in the sixth modification of the present embodiment.

The surrounding area information storage unit 454 stores the surrounding area count information, where the cleaning target areas and the number of times that the cleaning target areas have been surrounding cleaning target areas of other cleaning target areas are correlated. The surrounding area count information illustrated in FIG. 24 is created based on the surrounding area information illustrated in FIG. 6. It can be seen from FIG. 6 that, for example, the cleaning target area A1 is a surrounding cleaning target area of cleaning target areas A2, A8, and A9. Accordingly, the number of times that the cleaning target area A1 is identified as a surrounding cleaning target area of another cleaning target area is three times. In the same way, as illustrated in FIG. 6, the cleaning target area A2 is a surrounding cleaning target area of cleaning target areas A1, A3, A7, A10, and A11, so the number of times that the cleaning target area A2 is identified as a surrounding cleaning target area of another cleaning target area is five times.

In the screen G9 illustrated in FIG. 23, cleaning target areas where the number of times of becoming a surrounding cleaning target area of another cleaning target area is five times are indicated by the letter A, cleaning target areas where the number of times of becoming a surrounding cleaning target area of another cleaning target area is four times are indicated by the letter B, cleaning target areas where the number of times of becoming a surrounding cleaning target area of another cleaning target area is three times are indicated by the letter C, and cleaning target areas where the number of times of becoming a surrounding cleaning target area of another cleaning target area is two times or less are indicated by the letter D. The display screen G9 also displays a correlation table 428 indicating what these letters mean.

Although letters are displayed in the multiple [cleanable areas to differentiate according to the number of times that the multiple cleanable areas have been identified as a surrounding cleaning target area from another cleaning target area in the sixth modification of the present embodiment, the present disclosure is not particularly restricted to this. The color, contrast, brightness, or patterns of multiple cleanable areas may be different from each other, in accordance with the number of times that the cleanable areas have been identified as a surrounding cleaning target area from another cleaning target area.

Thus, each of the multiple cleanable areas are displayed using different forms in accordance with the number of times of have been identified as a surrounding cleaning target area from another cleaning target area, so the user can select cleanable areas taking into consideration the number of times of having been identified as a surrounding cleaning target area from another cleaning target area. For example, a cleaning target area that is identified as a surrounding cleaning target area from other cleaning target areas a greater number of times have a higher probability of being a non-cleanable area as the number of guests increases. Accordingly, in time zones when there are few guests, cleanable areas corresponding to cleaning target areas that are identified as surrounding cleaning target areas from other cleaning target areas a great number of times are selected with priority, while cleanable areas corresponding to cleaning target areas that are identified as surrounding cleaning target areas from other cleaning target areas a small number of times are selected with priority in time zones when there are many guests. Thus, the cleaning target areas can be efficiently cleaned by the autonomous cleaner 2.

Although a method of imparting priorities in a case where there are multiple cleanable areas has been described, which imparting method of the multiple imparting methods is to be used for imparting priority may be settable by the user. Also, there may be multiple imparting methods to select from.

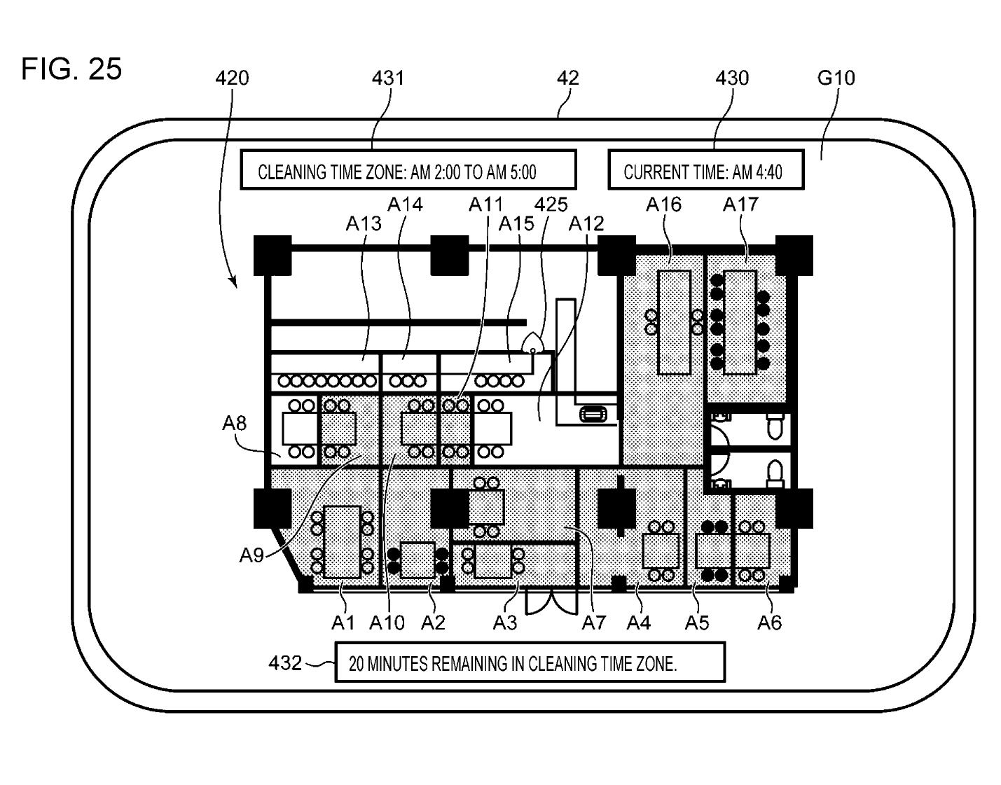

FIG. 25 is a diagram illustrating an example of a display screen displaying non-cleanable areas and cleanable areas in a seventh modification of the present embodiment. Components in FIG. 25 that are the same as those in FIGS. 14 and 20 are denoted with the same reference symbols, and detailed description will be omitted.

In the seventh modification of the present embodiment, in a case where a cleaning time zone in which the autonomous cleaner 2 can perform cleaning is set beforehand, this cleaning time zone and the remaining time in the cleaning time zone are presented to the user.

In display screen G10 illustrated in FIG. 25, the cleaning target areas A2, A5, and A17 are person-present cleaning target areas where people are present, the cleaning target areas A1, A3, A7, A9, A10, and A11 are surrounding cleaning target areas of the cleaning target area A2, the cleaning target areas A4, A6, and A16 are surrounding cleaning target areas of the cleaning target area A5, and the cleaning target area A16 is the surrounding cleaning target area of the cleaning target area A17.

Displayed in the display screen G10 are the current time of day 430, the cleaning time zone 431, and the remaining cleaning time 432. The cleaning time zone 431 represents the cleaning time zone that has been decided beforehand in which the autonomous cleaner 2 can perform cleaning. The remaining cleaning time 432 represents the remaining time in the time zone from the current time of day until the end time of the cleaning time zone. In a case of an eatery, the cleaning time zone 431 preferably is a time zone where customer traffic is light.

The cleaning time zone 431 during which the autonomous cleaner 2 can perform cleaning, and the remaining cleaning time 432, are thus displayed in this way. Accordingly, the user can confirm the time when the autonomous cleaner 2 can be used for cleaning, and judge whether or not for the autonomous cleaner 2 to perform cleaning.

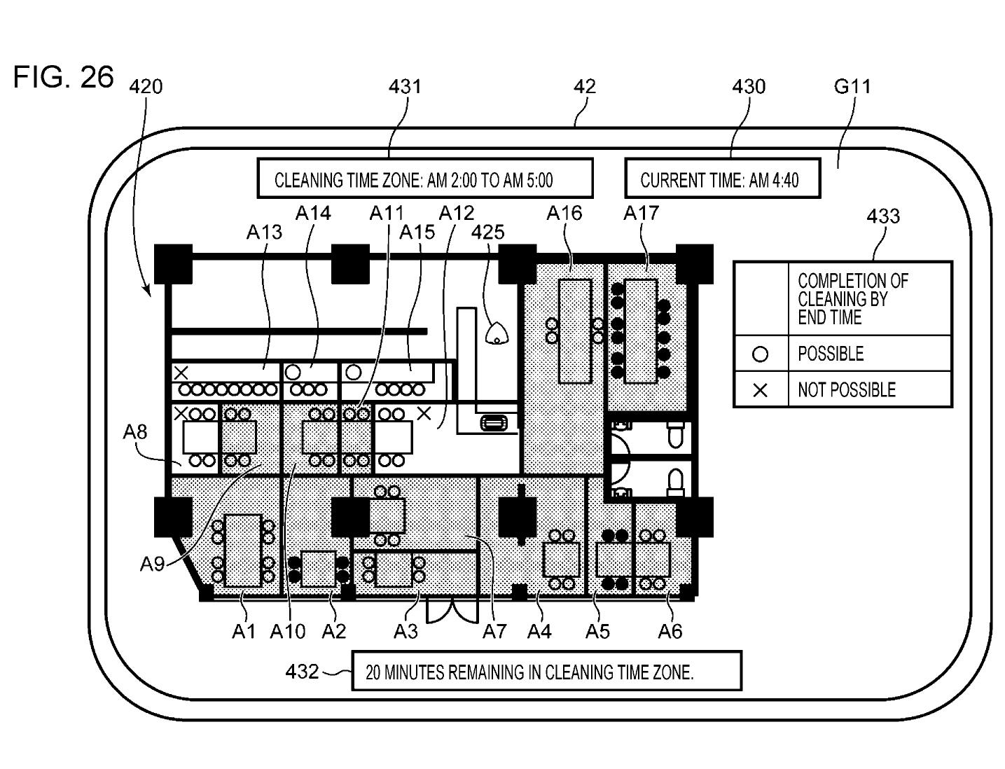

FIG. 26 is a diagram illustrating an example of a display screen displaying non-cleanable areas and cleanable areas in an eighth modification of the present embodiment. Components in FIG. 26 that are the same as those in FIGS. 14, 20, and 25 are denoted with the same reference symbols, and detailed description will be omitted.

In the eighth modification of the present embodiment, in a case where a cleaning time zone in which the autonomous cleaner 2 can perform cleaning is set beforehand, this cleaning time zone, the remaining time in the cleaning time zone, and information regarding whether or not cleaning of cleanable areas can be completed within the remaining time of the time zone, are presented to the user.

In display screen G11 illustrated in FIG. 26, the cleaning target areas A2, A5, and A17 are person-present cleaning target areas where people are present, the cleaning target areas A1, A3, A7, A9, A10, and A11 are surrounding cleaning target areas of the cleaning target area A2, the cleaning target areas A4, A6, and A16 are surrounding cleaning target areas of the cleaning target area A5, and the cleaning target area A16 is the surrounding cleaning target area of the cleaning target area A17.

Displayed in the display screen G11 are the current time of day 430, the cleaning time zone 431, and the remaining cleaning time 432. In the display screen G11 illustrated in FIG. 26, the cleaning target areas regarding which cleaning can be completed within the remaining time in the time zone are indicated by Y (for Yes), and the cleaning target areas regarding which cleaning cannot be completed within the remaining time in the time zone are indicated by N (for No). The display screen G9 also displays a correlation table 433 indicating what these letters mean.

In FIG. 26, the cleaning target areas A14 and A15 are cleanable areas regarding which cleaning can be completed within the remaining time in the time zone, and the cleaning target areas A8, A12, and A13 are cleanable area regarding which cleaning cannot be completed within the remaining time in the time zone.

The central control unit 441 calculates the distance from the current position of the autonomous cleaner 2 to the cleaning target area, and calculates the cleaning time required for the autonomous cleaner 2 to clean the cleaning target area, based on the area of the cleaning target area and the cleaning amount per unit time (m/sec) of the autonomous cleaner 2. The area of each cleaning target area is stored in the storage unit 45. The cleaning amount per unit time of the autonomous cleaner 2 may also be calculated by the average traveling speed of the autonomous cleaner 2, for example, or may be calculated from cleaning results of the actual cleaning target area, or may be obtained from performance information regarding the autonomous cleaner 2. In a case where the cleaning time of a cleaning target area corresponding to a cleanable area is within the remaining time in the cleaning time zone, the central control unit 441 judges that the cleaning will be completed within the remaining time in the cleaning time zone, and in a case where the cleaning time of a cleaning target area corresponding to a cleanable area longer than the remaining time in the cleaning time zone, judges that the cleaning will not be completed within the remaining time in the cleaning time zone.

Although letters are displayed in the multiple cleanable areas to differentiate according to whether or not the cleaning will be completed within the remaining time in the cleaning time zone on the display control unit 443 in the eighth modification of the present embodiment, the present disclosure is not particularly restricted to this. Cleanable areas regarding which cleaning can be completed within the remaining time in the time zone, and cleanable areas regarding which cleaning cannot be completed within the remaining time in the time zone may be displayed using different forms. The display control unit 443 may differentiate the color, contrast, brightness, or patterns of cleanable areas regarding which cleaning can be completed within the remaining time in the time zone, and cleanable areas regarding which cleaning cannot be completed within the remaining time in the time zone, from each other.

The autonomous cleaner 2 does not necessarily clean a cleaning target area in order from one end, so in a case where the cleaning time zone expires while cleaning and the autonomous cleaner 2 has to interrupt cleaning partway through, the user has no way of knowing how much of the cleanable area that the autonomous cleaner 2 has cleaned. Accordingly, it is difficult for the user to clean only the part of the cleanable area, regarding which cleaning was interrupted part way through, that has not been cleaned yet. On the other hand, in the eighth modification of the present embodiment, whether or not cleaning of the cleanable areas will be completed within the cleaning time zone, so the user can select a cleanable area regarding which cleaning can be completed within the remaining time in the cleaning time zone.

In a case where the remaining time in the cleaning time zone reaches a threshold value or less, or in a case where any one cleanable area of multiple cleanable areas becomes non-cleanable within the remaining time in the cleaning time zone, the display control unit 443 may display information indicating whether or not cleaning will be completed in the remaining time in the cleaning time zone.

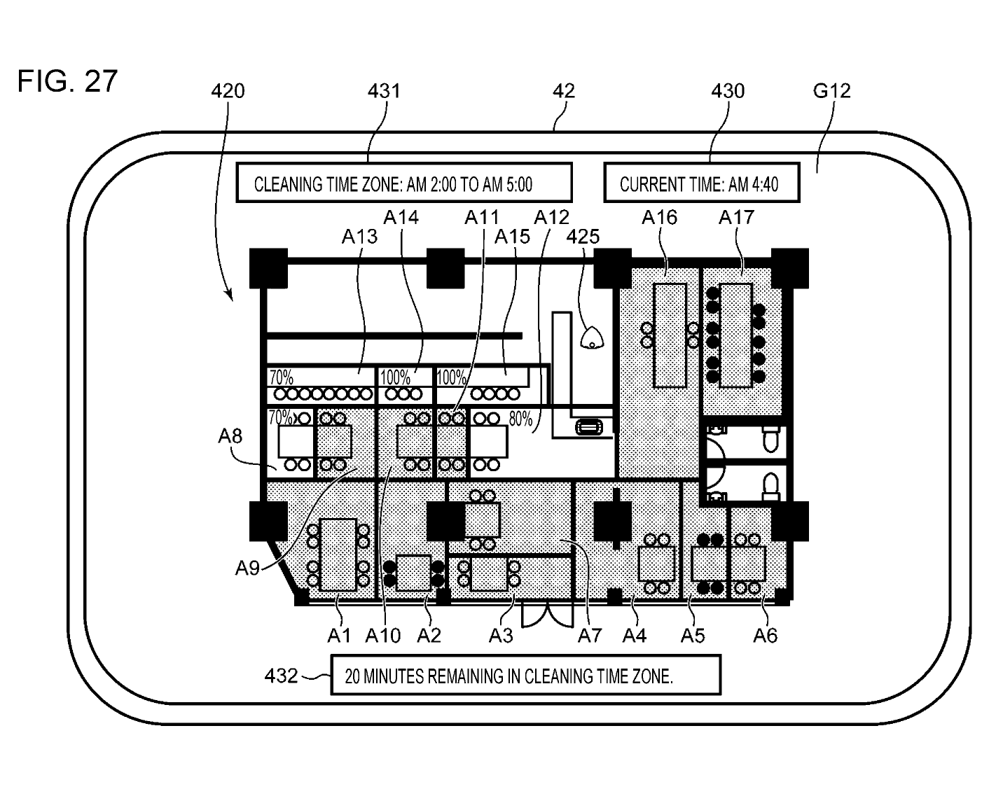

FIG. 27 is a diagram illustrating an example of a display screen displaying non-cleanable areas and cleanable areas in a ninth modification of the present embodiment. Components in FIG. 27 that are the same as those in FIGS. 14, 20, and 25 are denoted with the same reference symbols, and detailed description will be omitted.

In the ninth modification of the present embodiment, in a case where a cleaning time zone in which the autonomous cleaner 2 can perform cleaning is set beforehand, this cleaning time zone, the remaining time in the cleaning time zone, and information indicating the percentage of cleaning of the cleanable area that will be completed in the remaining time in the cleaning time zone, are presented to the user.

In display screen G12 illustrated in FIG. 27, the cleaning target areas A2, A5, and A17 are person-present cleaning target areas where people are present, the cleaning target areas A1, A3, A7, A9, A10, and A11 are surrounding cleaning target areas of the cleaning target area A2, the cleaning target areas A4, A6, and A16 are surrounding cleaning target areas of the cleaning target area A5, and the cleaning target area A16 is the surrounding cleaning target area of the cleaning target area A17.

Displayed in the display screen G12 are the current time of day 430, the cleaning time zone 431, and the remaining cleaning time 432. Also displayed in the display screen G12 in FIG. 27 are the percentages of how much cleaning will be completed in the remaining time in the cleaning time zone, regarding each of the multiple cleaning areas.

In FIG. 27, the cleaning target areas A14 and A15 are cleanable areas regarding which 100% of cleaning can be completed within the remaining time in the time zone, the cleaning target area A12 is a cleanable area regarding which 80% of cleaning can be completed within the remaining time in the time zone, and the cleaning target areas A8 and A13 are—cleanable area regarding which 70% of cleaning can be completed within the remaining time in the time zone.

The central control unit 441 calculates the cleaning time required for the autonomous cleaner 2 to clean the cleaning target area, in the same way as in the eighth modification. In a case where the cleaning time of a cleaning target area corresponding to a cleanable area is within the remaining time in the cleaning time zone, the central control unit 441 finds the percentage of cleaning that can be completed within the remaining time in the time zone to be 100%. In a case where the cleaning time of a cleaning target area corresponding to a cleanable area is longer than the remaining time in the cleaning time zone, the central control unit 441 finds calculates the proportion of remaining time in the cleaning time zone as to the amount of time required to clean the cleaning target area corresponding to the cleanable area as a percentage, and returns the percentage according to the calculated proportion that can be completed within the remaining time in the cleaning time zone.

There are some usage cases where as much cleaning as possible is desired within the cleaning time zone even if not all cleaning is completed within the cleaning time zone. In the ninth modification of the present embodiment, the percentage of completion of cleaning of the cleaning target area within the remaining time in the cleaning time zone is displayed, so the user can select cleanable area where maximal cleaning can be performed within the remaining time of the cleaning time zone.

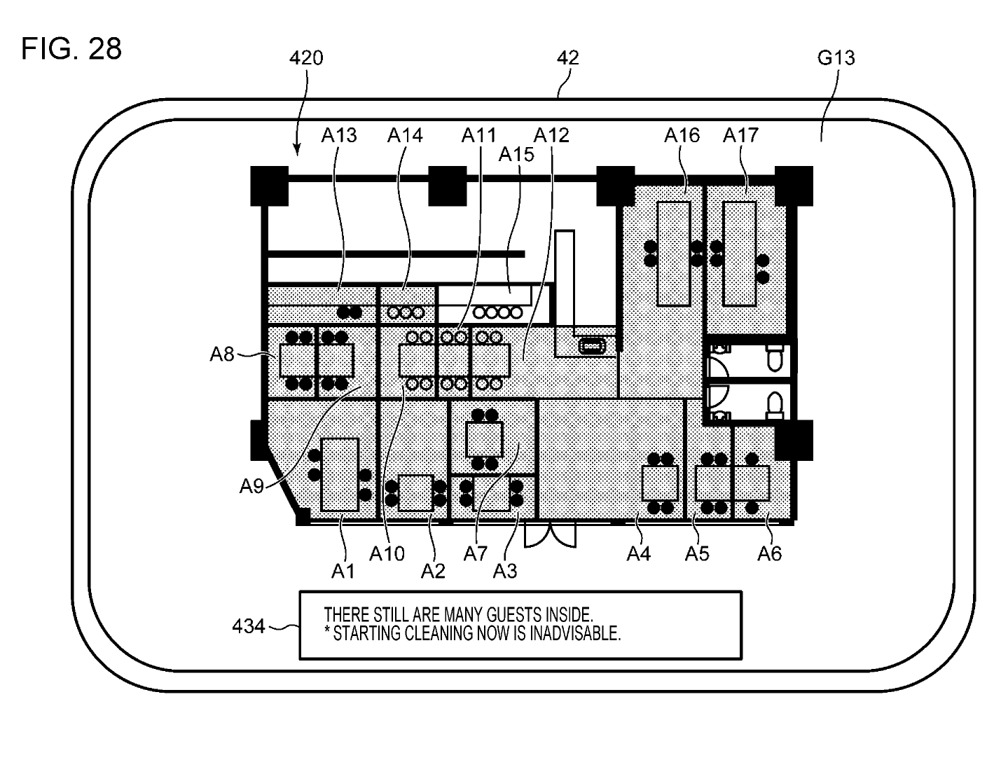

FIG. 28 is a diagram illustrating an example of a display screen displaying non-cleanable areas and cleanable areas in a tenth modification of the present embodiment. Components in FIG. 28 that are the same as those in FIGS. 14 and 20 are denoted with the same reference symbols, and detailed description will be omitted.

In an eatery, in a case of the autonomous cleaner 2 traveling to a cleaning target area and performing cleaning in a state where the percentage of person-present cleaning target areas where people are present is great, a situation may occur where guests arrive frequently and must be shown to a table in a cleanable area where the autonomous cleaner 2 is cleaning. In the tenth modification of the present embodiment, a message suggesting that cleaning should not be performed is presented to the user in a case where the percentage of person-present cleaning target areas out of all cleaning target areas is greater than a predetermined percentage.

In the display screen G13 illustrated in FIG. 28, the cleaning target areas A1 through A9, A13, A16, and A17 are person-present cleaning target areas. The cleaning target areas A10 through A12 and A14 are surrounding cleaning target areas, and cleaning target area A15 is a cleanable area. The display control unit 443 displays a message 434 suggesting that cleaning should not be performed in a case where the percentage of person-present cleaning target areas out of all cleaning target areas is greater than a predetermined percentage.

Note that the display control unit 443 may display the message 434 at the timing of having judged that the percentage of person-present cleaning target areas out of all cleaning target areas is greater than the predetermined percentage. Alternatively, the display control unit 443 may display the message 434 at the timing of having judged that the percentage of person-present cleaning target areas out of all cleaning target areas is greater than the predetermined percentage, and further the cleanable area is selected. In this case, the display control unit 443 may query the user regarding whether or not to select the cleanable area, for final confirmation regarding whether or not to select the cleanable area.

Further, the message 434 may include a reason why cleaning is inadvisable. Alternatively, in a case where the percentage of person-present cleaning target areas out of all cleaning target areas is greater than the predetermined percentage, the display control unit 443 may render the display of any cleanable area unselectable even if there are cleanable areas.

Thus, in a case where guests arrive frequently, a situation may occur where the guests must be shown to a table in a cleanable area where the autonomous cleaner 2 is cleaning. However, according to the tenth modification of the present embodiment, the user is presented with a message suggesting that cleaning should not be performed in a case where the percentage of person-present cleaning target areas out of all cleaning target areas is greater than the predetermined percentage. Accordingly, a situation where guests arrive frequently, and cleaning by the autonomous cleaner 2 is frequently interrupted can be prevented.

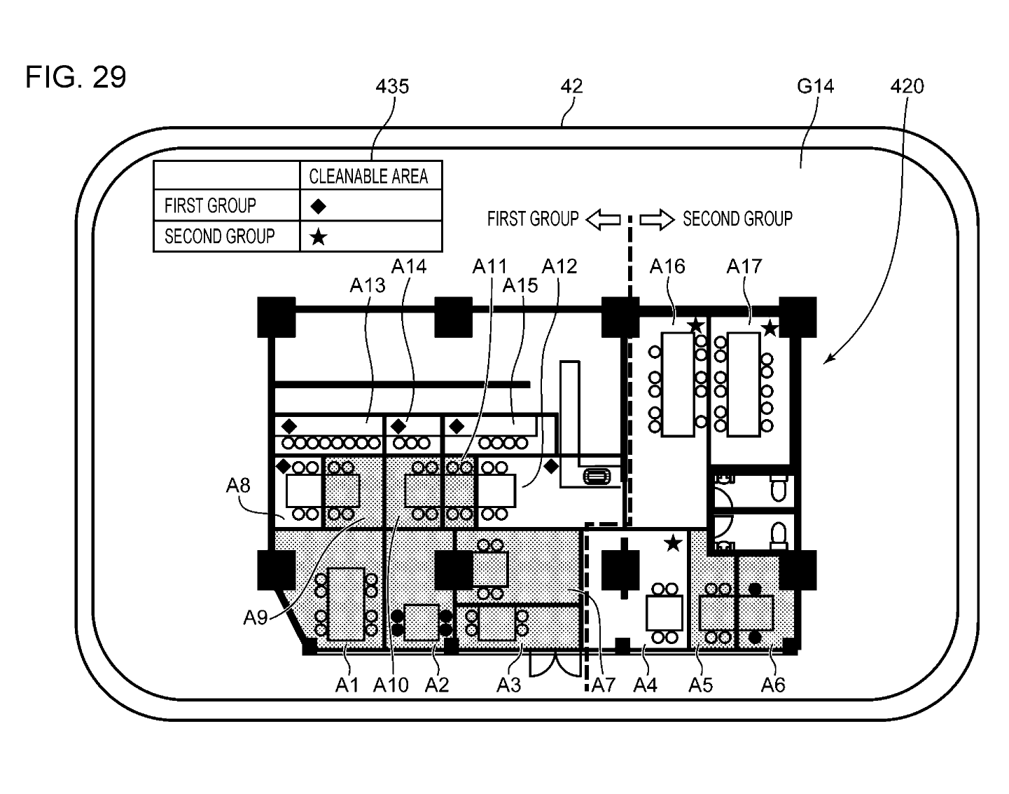

FIG. 29 is a diagram illustrating an example of a display screen displaying non-cleanable areas and cleanable areas in an eleventh modification of the present embodiment. Components in FIG. 29 that are the same as those in FIGS. 14 and 20 are denoted with the same reference symbols, and detailed description will be omitted.

Multiple cleaning target areas are grouped in the eleventh modification of the present embodiment, and cleaning target areas are displayed using different forms by group. In the display screen G14 illustrated in FIG. 29, the cleaning target areas A2 and A6 are person-present cleaning target areas. The cleaning target areas A1, A3, A7, A9, A10, and A11 are surrounding cleaning target areas of the cleaning target area A2, and cleaning target area A5 is a surrounding cleaning target area of the cleaning target area A6.

The cleaning target areas A1 through A3 and A7 through A15 belong to a first group, and cleaning target areas A4 through A6, A16, and A17 belong to the second group. Diamond shapes are displayed in cleanable areas belonging to the first group, and star shapes are displayed in cleanable areas belonging to the second group. The display screen G14 also displays a correlation table 435 indicating what these marks displayed in cleanable areas mean.

In FIG. 29, the cleaning target areas A8, A12, and A13 through 15 are cleanable areas belonging to the first group, and the cleaning target areas A4, A16, and A17 are cleanable areas belonging to the second group. The display control unit 443 divides the multiple cleaning target areas into the first group and the second group, and display cleanable areas out of the multiple cleaning target areas belonging to the first group, and cleanable areas out of the multiple cleaning target areas belonging to the second group, using different forms.

Although different marks are used for each group to be displayed in the cleaning target areas in the eleventh modification of the present embodiment, the present disclosure is not particularly restricted to this, and the cleanable areas of each group may be displayed using different forms. The color, contrast, brightness, or patterns of the cleanable areas in each group may be different from each other.

According to this configuration, in a case where cleaning is to be performed independently by section (by group) for example, displaying the cleanable areas in each section enables the user to recognize the cleanable areas in each section, and selection of cleanable areas in each section can be facilitated.

Although the terminal device 4 causes the autonomous cleaner 2 to clean all of the multiple cleaning target areas in the present embodiment, cleanable areas may be decided by the employee 51 taking into consideration manual cleaning by people. For example, the terminal device 4 that the employee 51 carries in an eatery may accept input of cleaning target areas cleaned by the employee 51 or cleaning target areas that are planned to be cleaned by the employee 51, and decide the input cleaning target areas to be non-cleanable areas for the autonomous cleaner 2. The terminal device 4 may also accept input of cleaning target areas that the employee 51 has completed cleaning of, and decide these input cleaning target areas to be non-cleanable areas for the autonomous cleaner 2. The terminal device 4 may accept input of cleaning target areas cleaned by the employee 51 or cleaning target areas that are planned to be cleaned by the employee 51, and display the accepted cleaning target areas and cleanable areas using different forms.

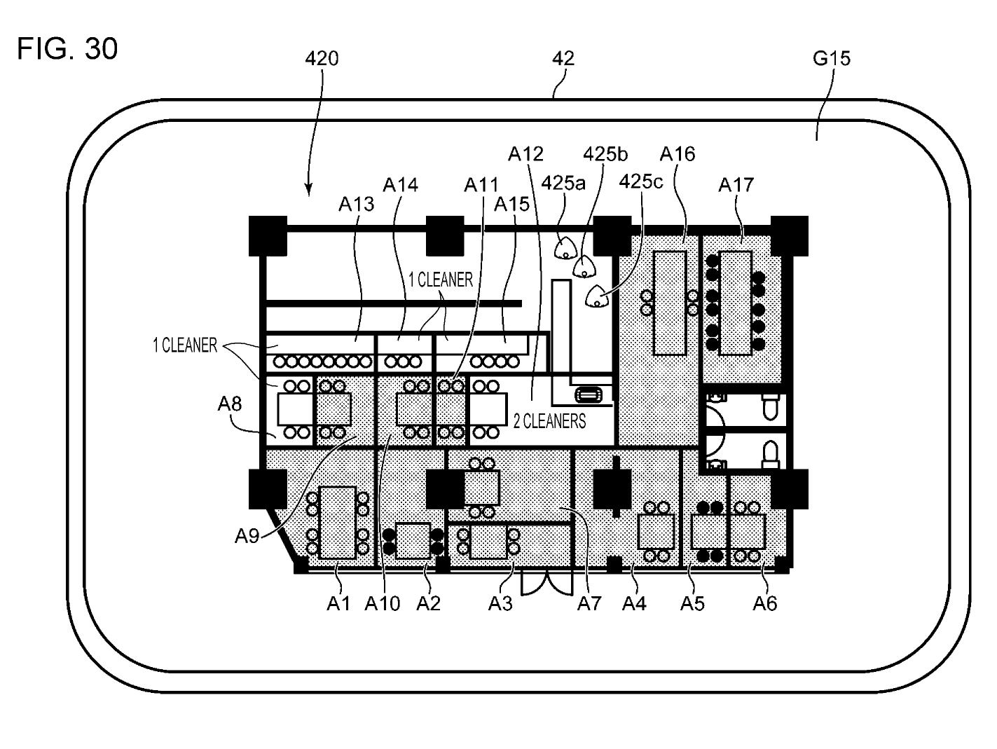

FIG. 30 is a diagram illustrating an example of a display screen displaying non-cleanable areas and cleanable areas in a twelfth modification of the present embodiment. Components in FIG. 30 that are the same as those in FIGS. 14 and 20 are denoted with the same reference symbols, and detailed description will be omitted. The number of autonomous cleaners 2 to clean each cleanable area is displayed in the cleanable areas in the twelfth modification of the present embodiment.

In display screen G15 illustrated in FIG. 30, the cleaning target areas A2, A5, and A17 are person-present cleaning target areas where people are present, the cleaning target areas A1, A3, A7, A9, A10, and A11 are surrounding cleaning target areas of the cleaning target area A2, the cleaning target areas A4, A6, and A16 are surrounding cleaning target areas of the cleaning target area A5, and the cleaning target area A16 is the surrounding cleaning target area of the cleaning target area A17.

Displayed in the display screen G15 illustrated in FIG. 30 are a first icon 425a , a second icon 425b , and a third icon 425c , that respectively indicate the positions of three autonomous cleaners 2. The display screen G15 displays the number of autonomous cleaners 2 necessary to clean each cleanable area within the cleanable area. In FIG. 30, the cleaning target areas A8 and A13 through A15 are areas that are cleanable by one autonomous cleaner 2, and the cleaning target area A12 is a cleanable area that is cleanable by two autonomous cleaners 2.

The display control unit 443 decides the number of autonomous cleaners 2 to allocate to one cleanable area, based on the area of the cleanable area and the area that the autonomous cleaner 2 can clean on one charge, for example. The area of each cleaning target area, and the area that the autonomous cleaner 2 can clean on one charge, are stored in the storage unit 45 beforehand. The display control unit 443 displays the number of autonomous cleaners 2 necessary to clean each cleanable area superimposed on the cleanable area.

In this case, the user can allocate autonomous cleaners 2 to cleanable areas upon having comprehended the minimally necessary number of autonomous cleaners 2 to clean one cleanable area.

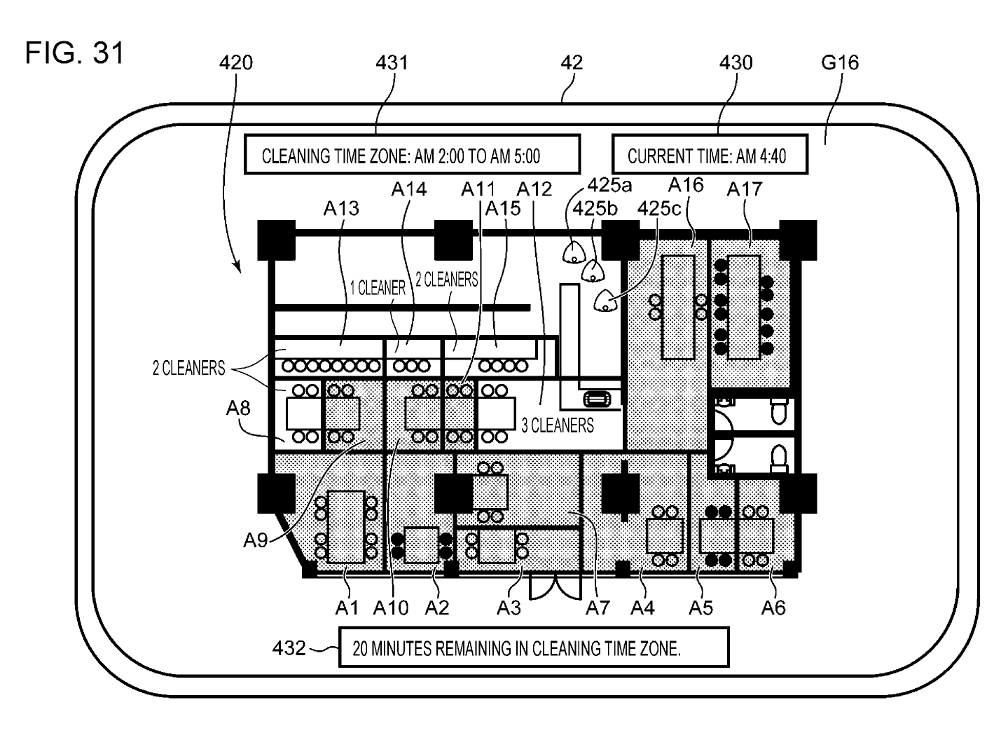

FIG. 31 is a diagram illustrating an example of a display screen displaying non-cleanable areas and cleanable areas in a thirteenth modification of the present embodiment. Components in FIG. 31 that are the same as those in FIGS. 14, 20, 25, and 30 are denoted with the same reference symbols, and detailed description will be omitted.

In the thirteenth modification of the present embodiment, in a case where a cleaning time zone in which the autonomous cleaner 2 can perform cleaning is set beforehand, the number of autonomous cleaners 2 necessary to complete cleaning of a cleanable area within the remaining time in the cleaning time zone, from the current time of day to the end time of the cleaning time zone, is displayed superimposed on the cleanable area.

In display screen G16 illustrated in FIG. 31, the cleaning target areas A2, A5, and A17 are person-present cleaning target areas where people are present, the cleaning target areas A1, A3, A7, A9, A10, and A11 are surrounding cleaning target areas of the cleaning target area A2, the cleaning target areas A4, A6, and A16 are surrounding cleaning target areas of the cleaning target area A5, and the cleaning target area A16 is the surrounding cleaning target area of the cleaning target area A17.

Displayed in the display screen G16 are the current time of day 430, the cleaning time zone 431, and the remaining cleaning time 432. In FIG. 31, the cleaning target area A14 is a cleanable area regarding which cleaning can be completed within the remaining time in the time zone by one autonomous cleaner 2, the cleaning target areas A8, A13, and A15 are cleanable areas regarding which cleaning can be completed within the remaining time in the time zone by two autonomous cleaners 2, and the cleaning target area A12 is a cleanable area regarding which cleaning can be completed within the remaining time in the time zone by three autonomous cleaners 2.

The display control unit 443 decides the number of autonomous cleaners 2 necessary to complete cleaning of a cleanable area within the remaining time in the cleaning time zone, based on for example, the area of the cleanable area, and the area that the autonomous cleaner 2 can clean on one charge, based on the distance of the current position of the autonomous cleaner 2 to the cleaning target area, and the cleaning amount per unit time (m/sec) of the autonomous cleaner 2. The display control unit 443 displays the number of autonomous cleaners 2 necessary to complete cleaning of the cleanable area within the remaining time in the cleaning time zone, superimposed on the cleanable area. Note that the terminal device 4 may accept user selection on which cleaning target area to allocate each of the multiple autonomous cleaners 2. In this case, the user can select cleanable areas taking into consideration the number of autonomous cleaners 2 necessary to complete cleaning of a cleanable area within the remaining time in the cleaning time zone.

Note that in the present embodiment, once the autonomous cleaner 2 completes cleaning of a cleanable area and does not receive new cleaning instruction information, the autonomous cleaner 2 returns to the initial position, but the present disclosure is not restricted to this in particular. If the autonomous cleaner 2 completes cleaning of a cleanable area and does not receive new cleaning instruction information, the autonomous cleaner 2 may travel to a temporary standby position that is different from the initial position, and stand by.

In a case where distance from the cleanable area where the autonomous cleaner 2 has completed cleaning to the initial position is far, returning the autonomous cleaner 2 to the initial position is inefficient. However, according to this configuration, if there is a cleaning target area that is not cleanable at the present point but cleaning thereof has not been completed, near the cleanable area where the autonomous cleaner 2 has completed cleaning in particular, the autonomous cleaner 2 may stand by at a standby position near the current position. Then, when the cleaning target area regarding which cleaning has not been completed is selected as a cleanable area, the autonomous cleaner 2 can travel from the standby position to the cleanable area, and thereby reduce the amount of time necessary for traveling.

At the timing that cleaning by the autonomous cleaner 2 has been completed, the display control unit 443 displays cleanable areas, non-cleanable areas, and the standby location of the autonomous cleaner 2 (including cleaned cleaning target areas) using different forms. In this case, the user can select whether to have the autonomous cleaner 2 to clean the next cleanable area, or whether to keep the autonomous cleaner 2 in standby.

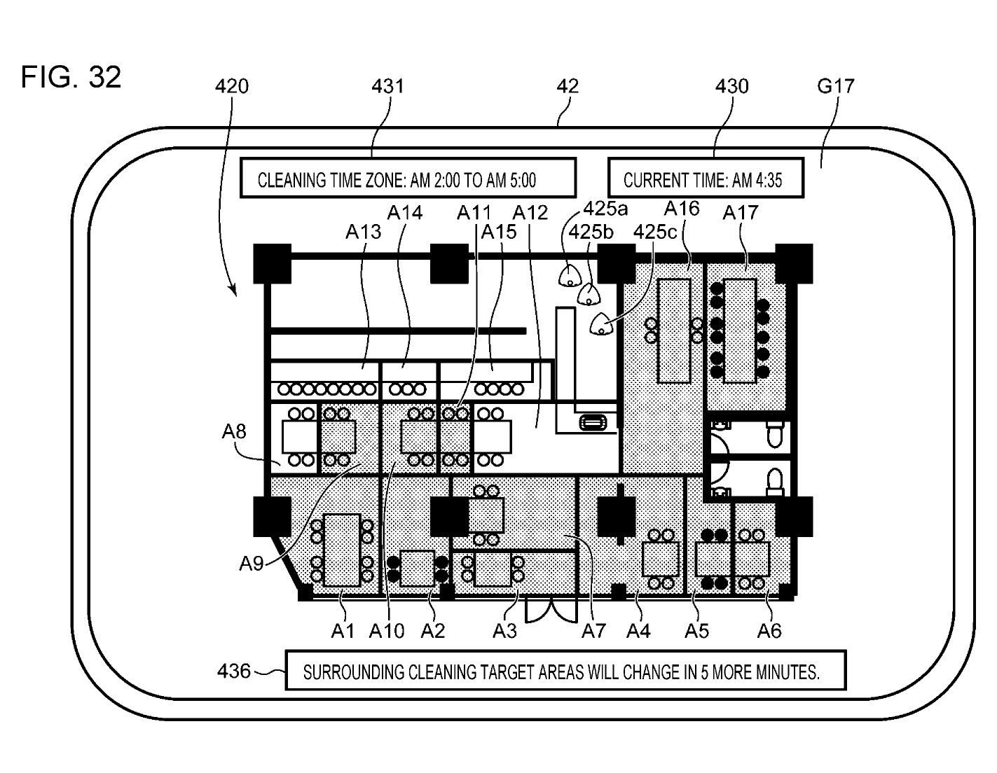

FIG. 32 is a diagram illustrating an example of a display screen displaying non-cleanable areas and cleanable areas in a fourteenth modification of the present embodiment. Components in FIG. 32 that are the same as those in FIGS. 14, 20, 25, and 30 are denoted with the same reference symbols, and detailed description will be omitted.

In a case of an eatery that is open 24 hours, for example, the autonomous cleaner 2 preferably is not used to clean in a time zone when customer traffic is heavy, but in a time zone when customer traffic is light. There is demand, regarding cases of cleaning using the autonomous cleaner 2 in a time zone specified beforehand, for being able to clean a maximally broad range within the time constraint of the time zone specified beforehand, by maximally narrowing the surrounding cleaning target areas around the person-present cleaning target areas to increase the number of cleanable areas. On the other hand, there also is demand to maximally broaden the surrounding cleaning target areas around the person-present cleaning target areas, in order to minimize the possibility of causing guests discomfort. These two are in a trade-off relationship.

In a case of cleaning using the autonomous cleaner 2 in a time zone specified beforehand, all of the multiple cleaning target areas will be in an uncleaned state, so even if the surrounding cleaning target areas around person-present cleaning target areas where people are present is set broadly, there is a high probability that a cleanable area will be found. However, as time goes on, the number of cleaning target areas that the autonomous cleaner 2 has cleaned will increase, so leaving the surrounding cleaning target areas around person-present cleaning target areas in a broad state will reduce the number of selectable cleanable areas, and eventually there may be no cleanable area left to be found. Accordingly, there is need to narrow the surrounding cleaning target areas that had been broadened as time passes, so that cleanable areas can be found and as many cleaning target areas as possible be cleaned. At this time, the surrounding cleaning target areas need to be narrowed to a degree where people do not feel uncomfortable.

Accordingly, in the fourteenth modification of the present embodiment, when there are multiple cleaning target areas and the surrounding cleaning target areas of the cleaning target areas are to be changed in accordance with the remaining time until the end time of the cleaning time zone specified beforehand, the user is notified of change of the surrounding cleaning target areas.

In display screen G17 illustrated in FIG. 32, the cleaning target areas A2, A5, and A17 are person-present cleaning target areas where people are present, the cleaning target areas A1, A3, A7, A9, A10, and A11 are surrounding cleaning target areas of the cleaning target area A2, the cleaning target areas A4, A6, and A16 are surrounding cleaning target areas of the cleaning target area A5, and the cleaning target area A16 is the surrounding cleaning target area of the cleaning target area A17.

Displayed in the display screen G17 are the current time of day 430, the cleaning time zone 431, and a message 436 making notification to the effect that the surrounding cleaning target areas are going to be changed.

The display control unit 443 displays the message 436 notifying that the surrounding cleaning target areas are going to be changed, before the conditions for changing the surrounding cleaning target areas are satisfied. Here, for example, the cleanable area deciding unit 445 judges to change the surrounding cleaning target areas in a case where the remaining time until the end time of the cleaning time zone is 20 minutes.

For example, in the case of the rule illustrated in FIG. 5 where cleaning target areas overlapping a circular area at a predetermined distance from the center point of a table in a cleaning target area are surrounding cleaning target areas, the surrounding cleaning target areas for when the remaining time from the current time of day until the end time of the time zone specified beforehand is 20 minutes or more may be selected using a first circular area, and the surrounding cleaning target areas for when the remaining time from the current time of day until the end time of the time zone specified beforehand is less than 20 minutes may be selected using a second circular area (where first circular area>second circular area). That is to say, the number of surrounding cleaning target areas is reduced as the remaining time until the end time of the time zone becomes shorter.

Thus, the user is notified that the surrounding cleaning target areas will be changed before the conditions for changing the surrounding cleaning target areas are satisfied. Accordingly, the user can select cleanable areas assuming the changed surrounding cleaning target areas.

Although an arrangement is described in the fourteenth modification of the present embodiment where the surrounding cleaning target areas are changed in accordance with the remaining time from the current time of day until the end time of the cleaning time zone, an arrangement may be made where the surrounding cleaning target areas are changed when the percentage of cleaning target areas where cleaning has been completed as to all cleaning target areas reaches a certain percentage. According to this configuration, the surrounding cleaning target areas are changed in accordance with the degree of progress of cleaning, so cleaning can be performed without concern of the current time of day.

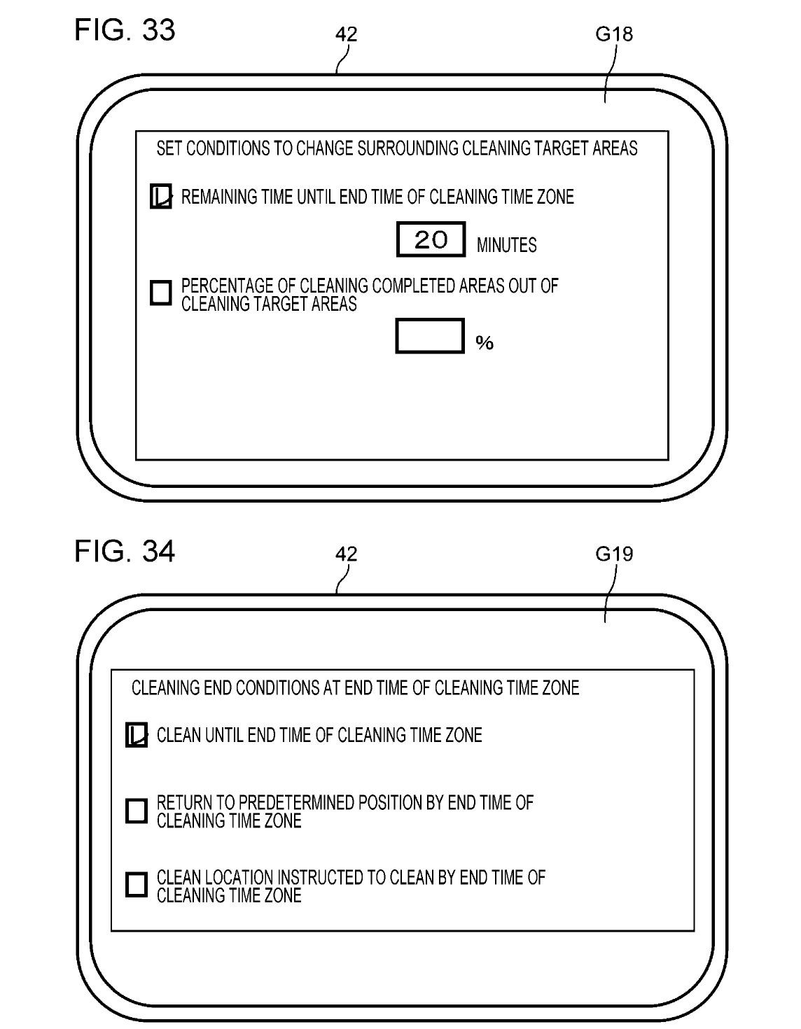

Additionally, the terminal device 4 may accept settings of conditions to change the surrounding cleaning target areas in the fourteenth modification of the present embodiment. FIG. 33 is a diagram illustrating an example of a display screen that accepts settings for conditions to change surrounding cleaning target areas in the fourteenth modification of the present embodiment.

In display screen G18 illustrated in FIG. 33, the remaining time until the end time of the cleaning time zone, and the percentage of cleaning-completed areas out of the cleaning target areas, can be set as conditions to change the surrounding cleaning target areas. The user sets the conditions to change the surrounding cleaning target areas using the input unit 43. Thus, the conditions to change the surrounding cleaning target areas can be set according to user preferences, by accepting user settings regarding the conditions to change the surrounding cleaning target areas.

FIG. 34 is a diagram illustrating an example of a display screen that accepts settings for cleaning end conditions at the end time of the cleaning time zone, in a fifteenth modification of the present embodiment. In a case where a cleaning time zone in which cleaning can be performed by the autonomous cleaner 2 has been decided beforehand, settings for cleaning end conditions at the end time of the cleaning time zone are accepted in the fifteenth modification of the present embodiment.

Settings can be made in the display screen G19 illustrated in FIG. 34 regarding whether or not to clean until the end time of the cleaning time zone, whether or not to return to a predetermined position by the end time of the cleaning time zone, and whether or not to clean an instructed location until the end time of the cleaning time zone, as cleaning end conditions at the end time of the cleaning time zone.

That is to say, in a case of cleaning until the end time of the cleaning time zone, the autonomous cleaner 2 cleans until the end time of the cleaning time zone, and then returns to the predetermined position. In a case of returning to the predetermined position by the end time of the cleaning time zone, the autonomous cleaner 2 ends cleaning and heads toward the predetermined position before the end time of the cleaning time zone, and returns to the predetermined position by the end time of the cleaning time zone. In a case of cleaning an instruction location until the end time of the cleaning time zone, the autonomous cleaner 2 cleans the instructed location by the end time of the cleaning time zone, but if cleaning is not completed at the end time of the cleaning time zone, continues to clean even after the end time of the cleaning time zone until the cleaning is completed, and finally returns to the predetermined position after the cleaning has been completed.

The autonomous cleaner 2 may interrupt cleaning and return to the predetermined position in a case where the end time of the cleaning time zone arrives. Alternatively, in a case where the process of the autonomous cleaner 2 returning to the predetermined position is to be completed within the cleaning time zone, the autonomous cleaner 2 may return to the predetermined position before the end time of the cleaning time zone, taking into consideration the amount of time it will take to return to the predetermined positon. According to this configuration, the autonomous cleaner 2 can be prevented from traveling outside of the cleaning time zone. Further, in a case where the autonomous cleaner 2 has received cleaning instruction information before the end time, the autonomous cleaner 2 may continue cleaning until the cleaning is completed, even after the end time of the cleaning time zone.

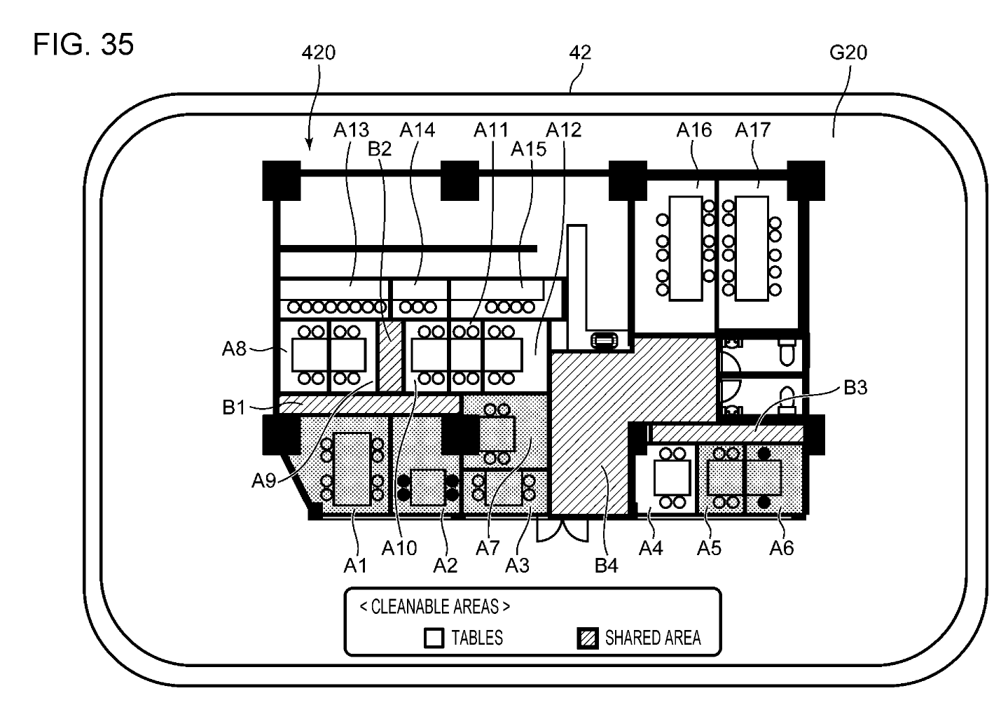

FIG. 35 is a diagram illustrating an example of a display screen displaying non-cleanable areas and cleanable areas in a sixteenth modification of the present embodiment. Components in FIG. 35 that are the same as those in FIGS. 14 and 20 are denoted with the same reference symbols, and detailed description will be omitted.

In the sixteenth modification of the present embodiment, in addition to the restriction of excluding person-present cleaning target areas where people are present and surrounding cleaning target areas around the person-present cleaning target areas from multiple cleaning target areas, and deciding the remaining cleaning target areas to be cleanable area, a further restriction is added to decide cleanable areas. This restriction is that if there are shared cleaning target areas where a related cleaning target area has been set beforehand regarding a cleanable area, shared cleaning target areas that satisfy the condition that there are no people present in a related cleaning target area associated with the shared cleaning target area, are decided to be cleanable areas. According to this configuration, in a case where there are cleaning target areas correlated with tables in an eatery for example, and further there are shared cleaning target areas correlated with shared areas such as passages, around an entrance, around restrooms, and so forth, around the tables can be cleaned without making guests uncomfortable, and also shared areas can be cleaned without getting in the way of guests.

In FIG. 35, seventeen cleaning target areas A1 through A17 are set in the floor plan of the eatery, and also four shared cleaning target areas B1 through B4 are set. The cleaning target areas A1 through A17 are cleaning target areas that have been correlated with tables, and the shared cleaning target areas B1 through B4 are cleaning target areas that have been correlated with shard areas.

In display screen G20 illustrated in FIG. 35, cleaning target areas A2 and A6 are person-present cleaning target areas where people are present, cleaning target areas A1, A3, and A7 are surrounding cleaning target areas of the cleaning target area A2, and cleaning target area A5 is a surrounding cleaning target area of cleaning target area A6.

In a case where there are cleaning target areas correlated with tables, and shared cleaning target areas correlated with shared areas such as passages, around an entrance, around restrooms, and so forth, cleanable areas (cleaning target areas A4 and A8 through A17) out of the multiple cleaning target areas, and cleanable areas (shared cleaning target area B2) out of the multiple shared cleaning target areas, are displayed using different forms.

Shared cleaning target areas conceivably become cleanable areas less readily than cleaning target areas, so it is conceivable that the user will want to clean the shared cleaning target areas with priority. Accordingly, cleanable areas of the multiple cleaning target areas and cleanable areas of the multiple shared cleaning target areas are displayed using different forms, so the user can easily select a shared cleaning target area that is a cleanable area.

Although a cleaning support method for an autonomous cleaner according to one or multiple forms of the present disclosure has been described by way of an embodiment, the present disclosure is not restricted to this embodiment. Various modifications that will be conceivable by one skilled in the art, and forms constructed by combining components of different embodiments, without departing from the essence of the present disclosure, may also be encompassed by the scope of one or multiple forms of the present disclosure.

In the above-described embodiment, the components may be configured as dedicated hardware, or may be realized by executing software programs suitable for the components. The components may be realized by a program executing unit such as a CPU or other processor reading out and executing software programs recorded in a recording medium such as a hard disk or semiconductor memory or the like.

All or part of the functions of the terminal device according to the embodiment of the present disclosure may be executed by large scale integration (LSI) that is typically an integrated circuit. These may be individually formed on signal chips, or part or all may be included on a single chip. Circuit integration is not restricted to LSI, and maybe realized by dedicated circuits or general-purpose processors. Field-programmable gate arrays (FPGA) that can be programmed after manufacturing of the LSI, and reconfigurable processors where connections and settings of circuit cells within the LSI can be reconfigured may also be used.

Also, part or all of the functions of the terminal device according to the embodiment of the present disclosure may be realized by a processor such as a CPU executing a program.

Note that the numerals used in the above description are all only exemplary to describe the present disclosure in detail, and that the present disclosure is not restricted to the numerals that have been exemplified.

The order in which the steps in FIGS. 11, 16, and 17 are executed as described above is only exemplary to describe the present disclosure in detail, and that orders other than that described above may be used, as long as the same advantages can be obtained. Also, part of the above steps may be executed at the same time (in parallel) with other steps.

Further, various modifications where embodiments of the present disclosure are modified within a scope conceivable by one skilled in the art, without departing from the essence of the present disclosure, are also included in the present disclosure.

The cleaning support method, cleaning support device, and non-transitory computer-readable recording medium storing a cleaning support program, according to the present disclosure, enables a cleanable area, which an autonomous cleaner can clean without making people in the vicinity feel uncomfortable, can be presented to a user, and are useful as a cleaning support method, cleaning support device, and non-transitory computer-readable recording medium storing a cleaning support program supporting cleaning by an autonomous cleaner within a predetermined space.

What is claimed is:

1. A cleaning support method for a cleaning support device having a processor, a display, and a memory, the cleaning support device supports cleaning by an autonomous cleaner in a predetermined space, the method comprising:
obtaining, by the processor, an electronic floor plan of the predetermined space, the predetermined space being a cleaning range of the autonomous cleaner;
obtaining, by the processor, person-present position information indicating a position of a person in the predetermined space;
dividing, by the processor, the predetermined space into a plurality of cleaning target areas to be individually cleaned by the autonomous cleaner;
determining, by the processor and based on the person-present position information, a person-present cleaning target area, among the plurality of cleaning target areas, occupied by the person;
determining, by the processor, surrounding cleaning target areas that surround the person-present cleaning target area; and
displaying, on the display, non-cleanable areas and cleanable areas among the plurality of cleaning target areas,
wherein
the non-cleanable areas include the person-present cleaning target area and the surrounding cleaning target areas,
the cleanable areas include cleaning target areas other than the non-cleanable areas, and
the non-cleanable areas are displayed differently from the cleanable areas.

2. The cleaning support method according to claim 1, further comprising:
receiving on an input, among the displayed cleanable areas and the non-cleanable areas, a selection of an area to be cleaned by the autonomous cleaner; and
when the area selected to be cleaned corresponds to the cleanable areas, outputting area selection information indicating the selected cleanable area.

3. The cleaning support method according to claim 2, further comprising:
when the area selected to be cleaned corresponds to the non-cleanable areas, outputting, notification information to notify that the autonomous cleaner cannot clean the area selected to be cleaned.

4. The cleaning support method according to claim 1, further comprising:
obtaining, by the processor, stay time information indicating stay time of the person in the person-present cleaning target area; and
displaying, by the display, the stay time in the person-present cleaning target area based on the obtained stay time information.

5. The cleaning support method according to claim 1, further comprising:
obtaining, by the processor, stay time information indicating stay time of the person in the person-present cleaning target area;
displaying, by the display, the person-present cleaning target area; and
displaying the stay time of the person corresponding to the obtained stay time information.

6. The cleaning support method according to claim 5, wherein the stay time of the person is displayed in the person-present cleaning target area.

7. The cleaning support method according to claim 1,
wherein the person-present cleaning target area includes
a first person-present cleaning target area, and
a second person-present cleaning target area that is different from the first person-present cleaning target area,
wherein the surrounding cleaning target areas include
a first surrounding cleaning target area adjacent to the first person-present cleaning target area, and
a second surrounding cleaning target area adjacent to the second person-present cleaning target area, and
wherein, when the first surrounding cleaning target area and the second surrounding cleaning target area partially overlap one another, overlapping portions including a first portion of the first surrounding cleaning target area and a first portion of the second surrounding cleaning target area that overlap one another, and non-overlapping portions including a second portion of the first surrounding cleaning target area and a second portion of the second surrounding cleaning target area that do not overlap, the overlapping portions and the non-overlapping portions are displayed differently to be distinguishable from one another.

8. The cleaning support method according to claim 1,
wherein the person-present cleaning target area includes
a first person-present cleaning target area,
a second person-present cleaning target area that is different from the first person-present cleaning target area, and
a third person-present cleaning target area that is different from the first person-present cleaning target area and the second person-present cleaning target area,
wherein the surrounding cleaning target areas include
a first surrounding cleaning target area adjacent to the first person-present cleaning target area,
a second surrounding cleaning target area adjacent to the second person-present cleaning target area, and
a third surrounding cleaning target area adjacent to the third person-present cleaning target area, and
wherein, when the first surrounding cleaning target area, the second surrounding cleaning target area and the third surrounding cleaning target area partially overlap one another, overlapping portions including the first portion of the first surrounding cleaning target area, the first portion of the second surrounding cleaning target area, and the first portion of the third surrounding cleaning target area that overlap one another, and partially overlapping portions including a second portion of the second surrounding cleaning target area, a second portion of the third surrounding cleaning target area that overlap one another but do not overlap the first surrounding cleaning target area, the overlapping portions and the partially overlapping portions are displayed differently to be distinguishable from one another.

9. The cleaning support method according to claim 1, further comprising:
obtaining, by the processor, position information indicating a current position of the autonomous cleaner in the predetermined space;
generating, by the processor, routes for the autonomous cleaner to travel from the current position to each of the plurality of cleaning target areas, based on the obtained position information; and
changing, by the processor, when the person-present cleaning target area or one of the surrounding cleaning target areas is included on a route from the current position of the autonomous cleaner to a particular cleaning target area corresponding to one of the cleanable areas, the one of the cleanable areas corresponding to the particular cleaning target area to a non-cleanable area.

10. The cleaning support method according to claim 1, further comprising:
managing, by the processor, cleaning history information of the autonomous cleaner regarding each of the plurality of cleaning target areas; and
displaying, on the display, each of the cleanable areas in accordance with elapsed time from its last cleaning time , based on the cleaning history information regarding each of the plurality of cleanable areas.

11. The cleaning support method according to claim 1, further comprising:
obtaining, by the processor, position information indicating a current position of the autonomous cleaner in the predetermined space;
generating, by the processor, routes for the autonomous cleaner to travel from the current position to each of the plurality of cleaning target areas, based on the obtained position information; and
displaying, on the display, each of the cleanable areas in accordance with distance of the routes.

12. The cleaning support method according to claim 1, further comprising:
identifying, by the processor, surrounding areas for each of the plurality of cleaning target areas;
for each of the plurality of cleaning target areas, calculating, by the processor, a number of times that a cleaning target area is identified as one of the surrounding areas for another cleaning target area; and
displaying, on the display, each of the cleanable areas in accordance with the calculated number.

13. A cleaning support device that supports cleaning by an autonomous cleaner in a predetermined space, the device comprising:
processing circuitry; and
a memory storage including at least one set of instructions that, when executed by the processing circuitry, cause the processing circuitry to perform operations including
obtaining an electronic floor plan of the predetermined space, the predetermined space being a cleaning range of the autonomous cleaner,
obtaining person-present position information indicating a position of a person in the predetermined space,
dividing the predetermined space into a plurality of cleaning target areas to be individually cleaned by the autonomous cleaner,
determining, based on the person-present position information, a person-present cleaning target area, among the plurality of cleaning target areas, occupied by the person,
determining surrounding cleaning target areas that surround the person-present cleaning target area, and
displaying, among the plurality of cleaning target areas, non-cleanable areas and cleanable areas,
wherein
the non-cleanable areas include the person-present cleaning target area and the surrounding cleaning target areas,
the cleanable areas include cleaning target areas other than the non-cleanable areas, and
the non-cleanable areas are displayed differently from the cleanable areas.

14. A non-transitory computer-readable recording medium storing a cleaning support program that supports cleaning by an autonomous cleaner in a predetermined space, the program, when executed by a computer, causing the computer to execute a method including
obtaining an electronic floor plan of the predetermined space, the predetermined space being a cleaning range of the autonomous cleaner,
obtaining person-present position information indicating a position of a person in the predetermined space,
dividing the predetermined space into a plurality of cleaning target areas to be individually cleaned by the autonomous cleaner,
determining, based on the person-present position information, a person-present cleaning target area, among the plurality of cleaning target areas, occupied by the person,
determining surrounding cleaning target areas that surround the person-present cleaning target area, and
displaying, among the plurality of cleaning target areas, non-cleanable areas and cleanable areas,
wherein
the non-cleanable areas include the person-present cleaning target area and the surrounding cleaning target areas,
the cleanable areas include cleaning target areas other than the non-cleanable areas, and
the non-cleanable areas are displayed differently from the cleanable areas.
